(19) United States
(12) Patent Application Publication
(10) Pub. No.: US 2006/0229407 A1
(43) Pub. Date: Oct. 12, 2006

(54) Light stabilising polymer dispersants in pigment dispersions

(76) Inventors: Thomas Vogel, Haltingen (DE); Sibylle Soder, Mohlin (CH); Peter Simmendinger, Basel (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/551,978

(22) PCT Filed: Mar. 29, 2004
(86) PCT No.: PCT/EP04/50386

§ 371 Date: Oct. 5, 2005

(30) Foreign Application Priority Data
Apr. 8, 2003 (EP) 03405235.7

(51) Int. Cl. C04B 35/634; C08F 263/00

(52) U.S. Cl. 524/561; 525/244; 544/351

(57) ABSTRACT

The present invention relates to a novel polymerisate, which is prepared by applying the method of atom transfer radical polymerisation. The novel polymerisate is useful for stabilising a composition of matter susceptible to degradation induced by light, heat or oxidation. The novel polymerisate is also useful as a dispersant in a pigment dispersion containing dispersible inorganic or organic pigment particles. Further embodiments of the invention relate to the process for preparing the novel polymerisate by applying the method of controlled or “living” polymerisation and to the use of the pigment dispersion for preparing inks, colour filters, coatings, images, lacquers and others.

The present invention relates to a novel polymerisate, which is useful for stabilising a composition of matter susceptible to degradation induced by light, heat or oxidation or as a dispersant in a pigment dispersion, a composition comprising the novel polymerisate, a process for preparing the composition, a pigment dispersion containing dispersible inorganic or organic pigment particles and the novel polymerisate, a process for preparing the novel polymerisate by applying the method of controlled or “living” polymerisation and to the use of the pigment dispersion for preparing coatings, images, lacquers and others.

Dispersions containing pigments and polymer additives are used in an almost unlimited number of different technical applications, e.g. as coating materials, for printing inks, colouring plastic materials, including fibres, glasses, or ceramic products, for formulations in cosmetics, or for the preparation of paint systems, in particular automotive, industrial and decorative paints.

The function of polymers in pigment dispersions is manifold. They may act as solubilisers in the given carrier liquid, e.g. water or organic solvents. Suitable polymers are also needed as stabilisers to prevent precipitation or flocculation. Polymers may also improve the gloss of the pigment dispersion or enhance its rheology. Depending on the type and polarity of the dispersing agent, e.g. water, organic solvents or mixtures thereof, or polymers of variable structure are chosen. In view of ecological requirements, the use of aqueous pigment dispersions is particularly preferred, as well as dispersions based on organic solvents with high solids content. In aqueous systems, mixtures of hydrophobic and hydrophilic polymers or block copolymers, so-called A-B block copolymers, containing hydrophilic and hydrophobic polymer blocks can be used. The hydrophobic “A″ blocks (homo- or copolymers of (meth)-acrylate monomers) associate with either pigment or emulsion polymer surfaces or both. With hydrophilic “B” blocks (neutralised acid or amine containing polymers), these copolymers are useful for preparing water based pigment dispersions, cf. H. J. Spinelli, Progress in Organic Coatings 27 (1996), 255-260.

Many different well-established methods are available for preparing the polymers used in pigment dispersions. Most methods have the disadvantage that uncontrollable recombination reactions of initiator radicals may occur Immediately after their formation with the effect that variable ratios between initiator radicals and stable free radicals are produced. Consequently, in some cases there is an inefficient control of the polymerisation process.

Group transfer polymerisation (GTP) is a well-established method for producing A-B block copolymers of defined structure from methacrylate monomers. Despite its wide applicability and usefulness the GTP method still has several drawbacks. The polymerisation initiators used in this method, such as the silyl ketene acetals disclosed in U.S. Pat. No. 4,656,226, e.g. 1-trimethyl-silyloxy-1-isobutoxy-2-methylpropene, are highly reactive and difficult to prepare in a multi-step synthesis. This necessitates the use of carefully dried and purified reactants, which limits this method in industrial applications operating on a large scale.

In view of the almost unlimited range of different technical applications, there remains a growing need for pigment dispersions of improved pigment affinity and rheology, as expressed by the viscosity of the mill base at a given shear rate and improved gloss of surface coatings.

WO 96/30421 discloses a controlled or “living” polymerisation process of ethylenically unsaturated polymers, such as styrene or (meth)acrylates, by employing the Atom Transfer Radical Polymerisation (ATRP) method. This method produces defined oligomeric homo-polymers and copolymers, including block copolymers. Initiators are employed which generate radical atoms, such as •Cl, in the presence of a redox system of transition metals of different oxidation states, e.g. Cu(I) and Cu(II), providing “living” or controlled radical polymerisabon.

WO 00/40630 discloses pigment dispersions containing block copolymers as dispersants prepared by the ATRP method. The block copolymers consist of defined hydrophobic and hydrophilic polymer blocks. The difference in polarity is obtained by copolymerising polymer blocks A and B wherein different amounts of monomer units with hydrophilic functional groups are present, such as amino or alkylated amino groups. This changes the hydrophilic/hydrophobic character of the block copolymer dispersant. In one embodiment, the individual hydrophobic “A” blocks based on uncharged homo- or copolymers of methacrylate or acrylate monomers form steric stabiliser blocks in solvent based coating formulations. The presence of more hydrophilic “B” blocks (e.g. amino functional acrylates or methacrylates) is the basis for pigment affinity to certain organic or inorganic pigments. Various additives, such as p-toluenesulphonic acid, are also disclosed.

WO 01/51534 discloses comb polymer dispersants prepared via macro-monomers made by ATRP.

It is self-explanatory fact in nature that pigments, dyes and other colorants are decomposed by the action of light and atmospheric oxygen. Therefore, it is desirable to protect the polymer dispersants and the pigments present in pigment compositions, particularly coatings, against the action of light by reducing the intensity of ultraviolet radiation in pigment composition exposed to visible light.

Light protecting agents, such as UV-absorbers are substances, which absorb radiant energy in the wavelength of UV-radiation. Suitable UV-absorbers are 2-(2′-hydroxyphenyl)-benzotriazoles, 2-hydroxybenzophenones, or 2-2-hydroxyphenyl)-1,3,5-triazines. When used as additives in pigment dispersion, they filter off the UV-components of the electromagnetic irradiation, decrease light sensitivity, resulting discoloration and degradation of the dispersion. However, their efficiency as light protecting agents in pigment dispersions, particularly in lower concentrations, remains unsatisfactory. Raising the concentration to more effective levels is unrealistic and disadvantageous. A serious problem then is the lower stability of dispersions resulting from the flocculation of the pigment particles and higher additive concentrations.

It is believed that the action of light and atmospheric oxygen initiates the decomposition of pigments by a photo-oxidative or photo-reductive process at the surface of pigment crystals. Therefore, stabilisers are desirable which specifically protect the surface of pigment crystals.

It has surprisingly been found out that the efficiency of UV-absorbers and other light protecting agents in pigment dispersions is increased in the event that UV-absorber molecules are directly linked to the structure of polymer dispersants obtained by the method of controlled or “living” polymerisation. The direct link is established by chemical bonds, such as ether or ester bonds, and the active structural moiety of UV-absorber molecules and other light protecting agents.

The present invention relates to a polymerisate of the formula: 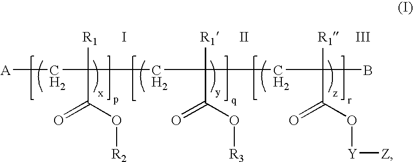
Wherein
A and B represent polymer chain terminal groups;
R₁, R₁′ and R₁″ independently of one another represent hydrogen or C₁-C₄alkyl;
R₂ represents hydrogen or an ester group of higher polarity;
R₃ represents an ester group of lower polarity;
Y represents the direct bond or a bivalent group;
Z represents the functionally effective group of an agent having light protecting properties;
The numerals I, II, III represent individual polymer blocks in any sequential order;
The Indices p, q and r represent the number of polymer blocks I, II and III in the polymerisate, wherein one of the indices p and q independently of one another represents zero, one or a numeral greater than one and the other one represents one or a numeral greater than one; and r represents one or a numeral greater than one; and wherein
The indices x, y and z define the number of monomer units present in the individual polymer blocks I, II and III.

A specific embodiment of the invention relates to a macro-monomer of the formula: 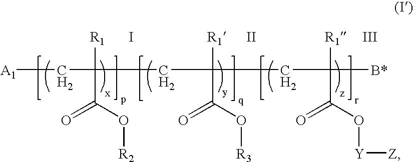
Wherein
A₁ represents the fragment of a polymerisation initiator;
B* represents a polymerisable, ethylenically unsaturated terminal group; and
R₁, R₁′, R₁″, R₂, R₃, Y, Z, the numerals I, II and III and the indices p, q, r, x, y and z are as defined above.

Furthermore, a specific embodiment relates to a comb polymer of the formula: 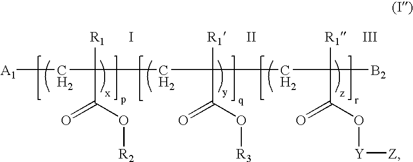
Wherein
A₁ represents the fragment of a polymerisation initiator;
R₁, R₁′, R₁″, R₂, R₃, Y, Z, the numerals I, II and III and the indices p, q, r, x, y and z are as defined above; and
B₂ represents a polymer group of the partial formula: 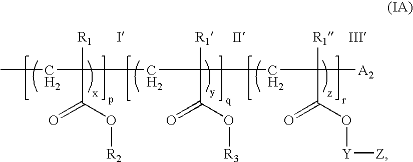
Wherein
A₂ represents a polymer chain terminal group;
R₁, R₁′, R₁″, R₂, R₃, Y and Z are as defined above;
The numerals I′, II′ and III′ represent individual polymer blocks in any sequential order;
The indices p, q and r represent the number of polymer blocks I, II and III in the polymerisate, wherein
One of the indices p, q and r independently of one another represents one or a numeral greater than one;
And the other ones represent zero, one or a numeral greater than one; and
The indices x, y and z define the number of monomer units present in the individual polymer blocks I, II and III.

The terms and definitions used in the specification of the present invention preferably have the following meanings:

The term polymerisate comprises any polymer structure composed of the individual block copolymers I, II and III in any sequential order. Each block copolymer essentially consists of random block, multi block, star or gradient copolymers. The polymer blocks I, II and III consist of at least two repeating units of ethylenically unsaturated, polymerisable monomer units: 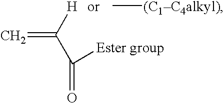
which are polymerisable in the known methods, such as conventional or controlled or “living” polymerisation. Controlled or “living” polymerisation is defined as a process wherein the polymerisation is initiated from an initiating fragment which adds monomers by radical poly-addition reactions under conditions which suppress undesirable side reactions, such as radical transfer to solvent, bimolecular termination or so-called disproportionation. The suppression of these side reactions is effected to such a degree that enables the formation of a block copolymer by subsequent addition of different monomers or the functionalisation of a terminal group to form a macro-monomer. The method of living polymerisation is described in U.S. Patent Specification No. 4,587,429.

At least three different types of polymerisates (I) are present in the compositions defined above, wherein,
1) One group of the partial formula: 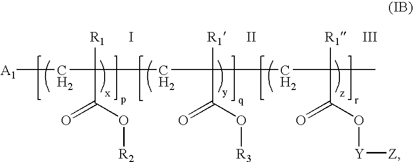
   Wherein A₁ represents the fragment of a polymerisation initiator, is attached to one polymer chain terminal group B₁: 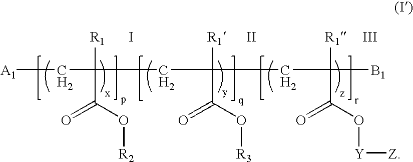
   In this case there is one radically transferable group B₁, such as chlorine or bromine, per initiator fragment A₁. Block copolymers wherein the transferable group B₁ has been replaced with a polymerisable chain terminal group B*, are known as macromonomers;
2) More than one of the groups 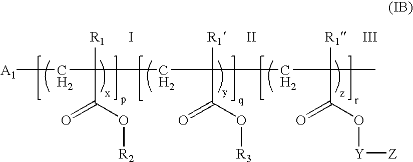
   is attached to one polymer chain terminal group B. Copolymers of this type are known as comb polymers or graft copolymers. Further polymerising or copolymerising the polymerisable chain terminal group B₁ by any known method of polymerisation produces macro-monomers of the following structure: 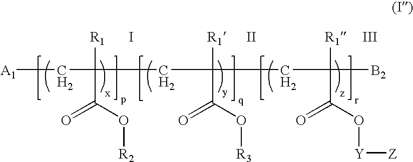
   Wherein B₂ represents a polymer group of the partial formula: 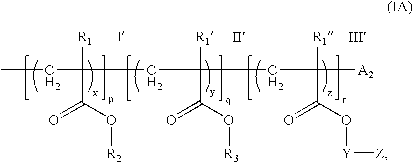
   Wherein A₂ represents the fragment of a polymerisation initiator;
3) More than one of the groups 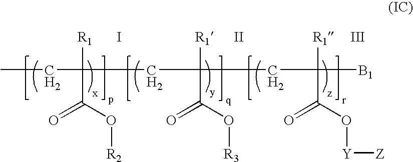
   is attached to one initiator fragment A. In this case up to six, preferably up to four, transferable groups are attached to the initiator fragment A₁. This type of copolymer comprises so-called star type or branched copolymers.

In a polymerisate (I), the numerals I, II, and III represent individual polymer blocks in any sequential order.

The indices p, q and r represent the number of polymer blocks I, II and III in the polymerisate (I). One of p and q independently of one another represents zero, one or a numeral greater than one (p or q: ≧0) and the other one represents one or a numeral greater than one (p or q: ≧1). The index r represents a numeral greater than one (r: ≧1)

According to a preferred embodiment the polymer blocks II and III are present in the polymerisate (I). In that event p represents zero and q represents one or a numeral greater than one (p: 0, q: ≧1).

The index numbers x, y and z independently of one another define the number of monomer units present in the polymer blocks I, II and III. In the event that one of p and q represents zero, x or y is also zero. In the event that one of p and q represents one, the lowest value of x or y is at least one. A range from two to 1 000 is preferred for the sum of x, y and z. The preferred molecular weight range is of the polymer blocks I, II and III is from about 1 000 to 100 000, preferably about 1 000 to 50 000. A particularly preferred molecular weight range is from about 1 000 to 15 000.

In copolymers (I) the group A or B represents the polymerisation initiator fragment of a polymerisation initiator of the formula:
A-B,

Wherein one of A and B represents the fragment of a polymerisation initiator capable of initiating the polymerisation of ethylenically unsaturated monomers by atom transfer radical polymerisation (ATRP) in the presence of a catalyst capable of activating controlled radical polymerisation by ATRP and the other one represents a radically transferable atom or group. A suitable polymerisation inhibitor is capable of initiating atom transfer radical polymerisation of the fragments A or B. The polymerisation subsequently proceeds by a reaction mechanism known under the term ATRP or related methods. A suitable polymerisation initiator, which contains the radically transferable atom or group •B (or •A), is described in WO 96/30421 and WO 98/01480. A preferred radically transferable atom or group •B is •Cl or •Br, which is cleaved as a radical from the initiator molecule and which may be subsequently replaced after polymerisation as a leaving group with a polymerisable chain terminal group. Representative initiator molecules are compounds of the formula:

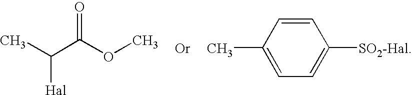

Wherein Hal represents chlorine or bromine.

In a polymerisate (I′) the group A, represents the fragment of a polymerisation initiator and B₁ represents a polymerisable, ethylenically unsaturated terminal group. A polymerisate (I′) is available by applying the ATRP method in the presence of an initiator molecule of the formula A-B and substituting the chain terminal group with a polymerisable, ethylenically unsaturated group.

In a polymerisate (I″), A, represents the fragment of a polymerisation initiator and B₂ represents a polymer group of the partial formula:

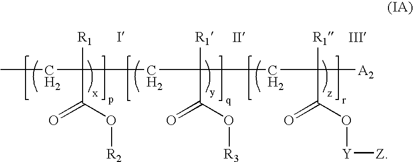

A polymerisate (I″) is available by applying the ATRP method and in the presence of a “star-shaped” or “bird type” initiator molecules of the formulae:

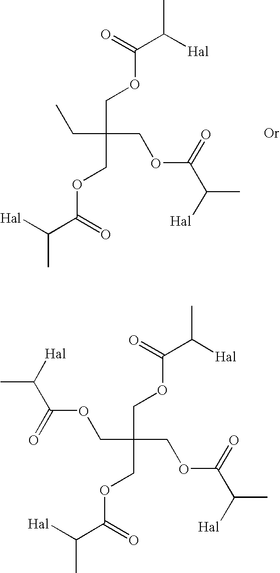

In the formulae above Hal represents chlorine or bromine. These initiator molecules are prepared by the reaction of a reactive functional derivative of α-halogen carboxylic acid of the formula: 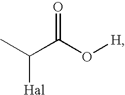
e.g. the acid chloride or bromide of this compound, with an alcohol of the formula HO—R₂, wherein R₂ together with the HO-group represents a branched trihydroxy alcohol, e.g. 1,1,1-(tris-hydroxymethyl)-propane, or represents a branched tetrahydroxy alcohol, e.g. pentaerythritol.

A preferred polymerisation initiator, which generates linear polymers, block copolymers or macro monomers, is selected from the group consisting of C₁-C₈alkyl halides, C₆-C₁₅aralkyl-halides, C₇-C₈haloalkyl esters, arene sulphonyl chlorides, α-haloalkane nitriles, α-haloacrylates and halolactones.

Specific initiators are selected from the group consisting of α,α′-dichloro- or α,α′-dibro-moxylene, p-toluenesulphonylchloride (PTS), hexakis-(α-chloro- or α-bromomethyl)-benzene, 1-phenethyl chloride or bromide, methyl or ethyl 2-chloro- or 2-bromopropionate, methyl or ethyl-2-bromo- or 2chloroisobutyrate, and the corresponding 2-chloro- or 2-bromopropionic acid, 2-chloro- or 2-bromoisobutyric acid, chloro- or bromoacetonitrile, 2-chloro- or 2-bromopropionitrile, α-bromobenzacetonitrile, α-bromo-γ-butyrolactone (=2-bromo-dihydro-2(3H)-furanone) and the initiators derived from 1,1,1-(tris-hydroxymethyl)-propane and pentaerythritol of the formulae of above.

According to an alternative embodiment, A and B in the polymerisate (I) represent chain terminal groups from fragments of a polymerisation initiator containing the groups

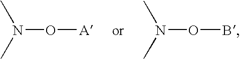

Wherein A′ or B′ is cleavable from the initiator as a free radical A• or B• and is capable of initiating the polymerisation of ethylenically unsaturated monomers. The method of polymerisation that applies is the so-called controlled polymerisation with >N—O—R compounds. According to another alternative embodiment, one of A and B represents the fragment of a free radical initiator and the other one represents the chain terminal group from the free nitroxyl radical

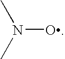

The method of polymerisation that applies is the so-called controlled polymerisation with >N—O• compounds. A suitable polymerisation initiator containing the chain terminal group (A) is represented by the formula: 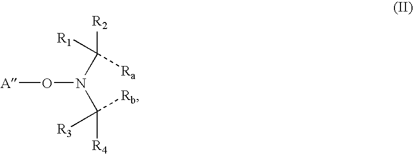
Wherein
A″ is cleavable from the compound (II) as a free radical A• and is capable of initiating the polymerisation of ethylenically unsaturated monomers;
One of R₁ and R₂ represents C₁-C₇alkyl or hydroxy-C₁-C₇alkyl and the other one represents C₁-C₄alkyl, C₁-C₄alkyl substituted by C₁-C₄alkoxycarbonyl or C₁-C₄alkoxy or hydroxy-C₁-C₄alkyl; or
R₁ and R₂ together with the adjacent C-atom both represent C₃-C₇cycloalkyl;
R₁ and R₄ independently of one another are as defined as R₁ and R₂ or represent hydrogen;
Rₐ represents hydrogen or a substituent selected from the group consisting of C₁-C₄alkyl, hydroxy-C₁-C₄alkyl, C₅-C₁₀aryl, C₅-C₁₀aryl-C₁-C₄alkyl, C₁-C₄alkyl-C₅-C₁₀aryl, cyano, C₁-C₄alkoxycarbonyl, C₁-C₄alkanoyloxy, C₁-C₄alkanoyloxy-C₁-C₄alkyl, carbamoyl, mono- or di-C₁-C₄alkylcarbamoyl, mono- or di-2-hydroxyethylcarbamoyl, amidino, 2-imidazolyl, 1-hydroxy-2-hydroxymethyl-2-propylcarbamoyl, 1,1-dihydroxymethyl-2-hydroxycarbamoyl and —P═O(O—C₁-C₄alkyl)₂; and
R_{b} is as defined as R₄ or
Rₐ and R_{b} together represent a divalent group and form a 5-, 6-, 7- or 8-membered aliphatic or aromatic heterocyclic group, which may contain 1-3 additional heteroatoms selected from the group consisting of nitrogen, oxygen and sulphur.

The free radical species cleaved from a compound (II) is illustrated by the formula:

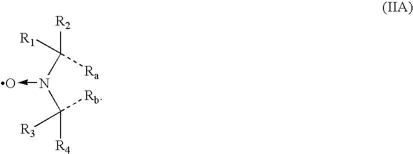

The group A″, which is cleavable from the compound (II) as the free radical A•, has at least one C-atom and is capable of initiating the polymerisation of ethylenically unsaturated monomers (>N—O—R polymerisation). In the alternative the group A″ represents the fragment of a free radical initiator (>N—O• polymerisation). A″, defined as the group which is cleavable from the compound (II) as the free radical A• (>N—O—R polymerisation) is preferably selected from the group of aliphatic and cycloaliphatic substituents consisting of aryl-CH₂—, (CH₃)CH(-aryl)-, aryl-CH₂—CH₂—, (CH₃)₂C(-aryl)-, (C₅-C₆cycloalkyl)₂C(—CN)—, (C₁-C₁₂alkyl)₂C(—CN)—, CH═CH₂CH₂—, C₁-C₁₂alkyl-C(—R)[—C(═O)—C₁-C₁₂alkyl]-, C₁-C₁₂alkyl-C(—R)[—C(═O)—C₆-C₁₀aryl]-, C₁-C₁₂alkyl-C(—R)[—C(═O)—C₁-C₁₂ alkoxy]-, C₁-C₁₂alkyl-C(—R)[—C(═O)-phenoxy]-, C₁-C₁₂alkyl-C(—R)[—C(═O)—N-di-C₁-C₁₂alkyl]-, C₁-C₁₂alkyl-C(—R)[—(C═O)—NH—C₁-C₁₂alkyl]-, C₁-C₁₂alkyl-C(—R)[—C(═O)—NH₂]—, CH₃CH═CH—CH₂—, CH₂═C(CH₃)CH₂—, phenyl-CH═CH—CH₂—, 2-propynyl, 2-tetrahydropyranyl or 2-tetrahydrofuryl, wherein R represents hydrogen or C₁-C₁₂alkyl.

The aryl groups in these groups defined for A″ may additionally be substituted with a substituent selected from the group consisting of C₁-C₁₂alkyl, halogen, C₁-C₁₂alkoxy, C₁-C₁₇alkyl-carbonyl, glycidyloxy, OH, —COOH and —COOC₁-C₁₂alkyl.

A″ is preferably selected from the group of aliphatic and cycloaliphatic substituents consisting of phenyl-CH₂—, CH₃CH(-phenyl)-, (CH₃)₂C(-phenyl)-, (C₅-C₆cycloalkyl)₂C(—CN)—, (CH₃)₂C(—CN)—, —CH₂═CH—CH₂—, CH₃CH(—CH═CH₂)—, C₁-C₈alkyl-C(—R)[—C(═O)-phenyl]-, C₁-C₈alkyl-C(—R)[—C(═O)—C₁-C₈alkoxy]-, C₁-C₈alkyl-C(—R)[—C(═O)C₁-C₈alkyl]-, C₁-C₈alkyl-C(—R)[—C(═O)—N-di-C₁-C₈alkyl]-, C₁-C₈alkyl-C(—R)[—C(═O)—NH—C₁-C₈alkyl]- and C₁-C₈alkyl-C(—R)[—C(═O)—NH₂]—, wherein R is hydrogen or C₁-C₈alkyl.

A particularly preferred group of substituents A″ is selected from the group of aliphatic and cycloaliphatic substituents consisting of phenyl-CH₂—, CH₃CH(-phenyl)-, (CH₃)₂C(-phenyl)-, (C₃-C₆cycloalkyl)₂C(—CN)—, (CH₃)₂C(—CN)—, —CH₂═CH—CH₂—, CH₃CH(—CH═CH₂)—, C₁-C₄alkyl-C(—R)[—C(═O)-phenyl-, C₁-C₄alkyl-C(—R)[—C(═O)C₁-C₄alkoxy-, C₁-C₄alkyl-C(—R)[—C(═O)—C₁-C₄alkyl-, C₁-C₄alkyl-C(—R)[—C(═O)—N-di-C₁-C₄alkyl-, C₁-C₄alkyl-C(—R)[—C(═O)—NH—C₁-C₄alkyl- and C₁-C₄alkyl-C(—R)[—C(═O)—NH₂—, wherein R is hydrogen or C₁-C₄alkyl.

A compound wherein the free nitroxyl radical is present is represented by the formula IIA. The free nitroxyl radical is generated from a compound (II), wherein A″ is the fragment of a free radical initiator.

A″ defined as the fragment of a free radical initiator (>N—O• polymerisation) is a fragment from known free radical initiators used as sources of free radicals in so-called living polymerisation reactions, e.g. a suitable bis azo compound, a peroxide or a hydroperoxide.

Suitable bis azo compounds are commercially available, e.g. 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1′-azobis(1-cyclohexanecarbonitrile), 2,2′-azobis(isobutyramide) dihydrate, 2-phenylazo-2,4-dimethyl-4-methoxyvaleronitrile, dimethyl 2,2′-azobisisobutyrate, 2-(carbamoylazo)isobutyronitrile, 2,2′-azobis(2,4,4-trimethylpentane), 2,2′-azobis(2-methyl-propane), 2,2′-azobis(N,N′-dimethyleneisobutyramidine) as free base or hydrochloride, 2,2′-azobis(2-amidinopropane) as free base or hydrochloride, 2,2′-azobis{2-methyl-N-[1,1-bis(hydroxymethyl)ethyl]propionamide} or 2,2-azobis{2-methyl-N-[1,1-bis(hydroxymethyl) 2-hydroxyethyl]propionamide}.

Suitable peroxides and hydroperoxides are commercially available, e.g. acetylcyclohexane-sulphonyl peroxide, diisopropyl peroxydicarbonate, tert-amyl perneodecanoate, tert-butylperneodecanoate, tert-butylperpivalate, tert-amylperpivalate, bis(2,4-dichlorobenzoyl) peroxide, diisononanoyl peroxide, didecanoyl peroxide, dioctanoyl peroxide, dilauroyl peroxide, bis(2-methylbenzoyl) peroxide, disuccinoyl peroxide, diacetyl peroxide, dibenzoyl peroxide, tert-butyl per-2-ethylhexanoate, bis(4-chlorobenzoyl) peroxide, tert-butyl perisobutyrate, tert-butyl permaleate, 1,1-bis(tert-butylperoxy)-3,5,5-trimethylcyclohexane, 1,1-bis(tert-butylperoxy)cyclohexane, tert-butyl peroxyisopropyl carbonate, tert-butyl perisononaoate, 2,5-dimethylhexane 2,5-dibenzoate, tert-butyl peracetate, tert-amyl perbenzoate, tert-butyl perbenzoate, 2,2-bis(tert-butylperoxy)butane, 2,2-bis(tert-butylperoxy)propane, dicumyl peroxide, 2,5-dimethylhexane 2,5-di-tert-butylperoxid, 3-tert-butylperoxy-3-phenyl phthalide, di-tert-amyl peroxide, α,α′-bis(tert-butylperoxyisopropyl)benzene, 3,5-bis(tert-butylperoxy)-3,5-dimethyl-1,2-dioxolane, di-tert-butyl peroxide, 2,5-dimethylhexyne 2,5-di-tert-butyl peroxide, 3,3,6,6,9,9-hexamethyl-1,2,4,5-tetraoxacyclononane, p-menthane hydroperoxide, pinane hydroperoxide, diisopropylbenzene mono-α-hydroperoxide, cumene hydroperoxide or tert-butyl hydroperoxide.

In a compound (II) the substituents R₁, R₂ and Rₐ and R₃, R₄ and R_{b} together with the adjacent C-atom on the nitrogen atom preferably represent groups of the partial formulae:

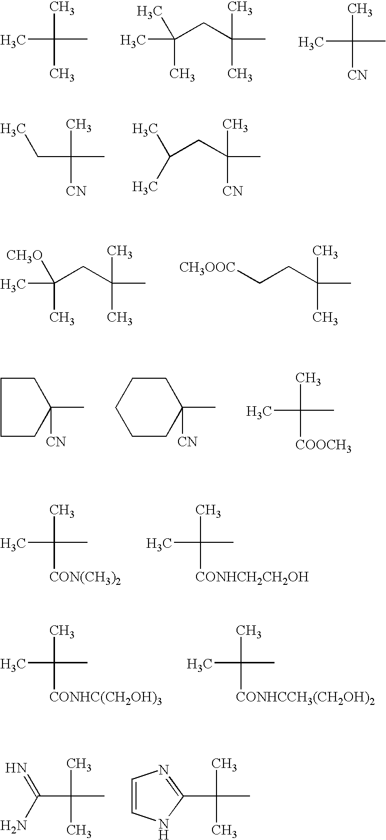

In a preferred embodiment one of R₁ and R₂ represents methyl and the other one represents methyl or ethyl and one of R₃ and R₄ represents methyl and the other one represents methyl or ethyl and R₄ and R_{b} together represent a group of the partial formula:

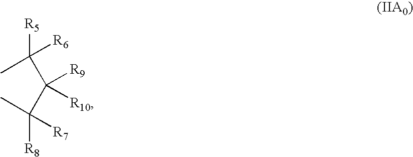

Wherein R₃, R₆, R, and R₈ independently of one another represent hydrogen, methyl or ethyl; and one of R₉ and R₁₀ independently of the other represents hydrogen or substituents or R₉ and R₁₀ both represent substituents.

In a preferred embodiment of the invention the chain terminal group from fragments of a polymerisation initiator containing the terminal groups (A) or (B), e.g. the free nitroxyl radical, represents a group of the partial formula:

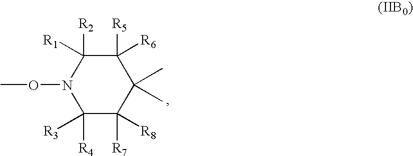

Wherein R₁-R₆ are as defined above and the 4-position is substituted by one or two substituents. Preferred groups B₀ which contain substituents in 4-position are represented by the partial formulae:

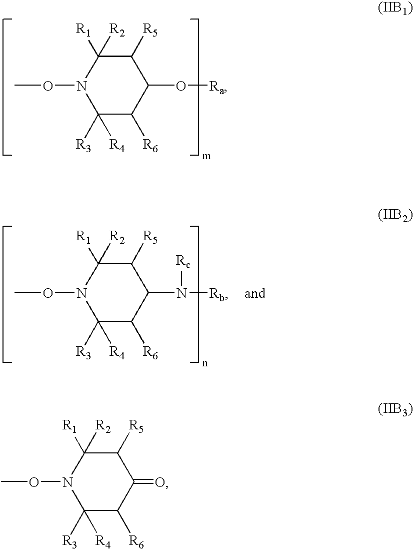

Wherein
R₁-R₆ are as defined above;
m represents a numeral from one to four;
n represents one, two or three;
If m represents one,
Rₐ represents hydrogen, C₁-C₁₈alkyl which is uninterrupted or interrupted by one or more oxygen atoms, 2-cyanoethyl, benzoyl, glycidyl, or represents a monovalent radical of an aliphatic carboxylic acid having 2 to 18 C-atoms, of a cycloaliphatic carboxylic acid having 7 to 15 C-atoms, of an a,b-unsaturated carboxylic acid having 3 to 5 C-atoms or of an aromatic carboxylic acid having 7 to 15 C-atoms, where each carboxylic acid can be substituted in the aliphatic, cycloaliphatic or aromatic moiety by 1 to 3-COOZ groups, in which Z represents H, C₁-C₂₀alkyl, C₃-C₁₂alkenyl, C₅-C₇cycloalkyl, phenyl or benzyl; or
Rₐ represents a monovalent radical of a carbamic acid or phosphorus-containing acid or a monovalent silyl radical; or
If m represents 2,
Rₐ represents C₂-C₁₂alkylene, C₄-C₁₂alkenylene, xylylene, or represents a divalent radical of an aliphatic dicarboxylic acid having 2 to 36 C-atoms, of a cycloaliphatic or aromatic dicarboxylic acid having 8 to 14 C-atoms or of an aliphatic, cycloaliphatic or aromatic dicarbamic acid having 8 to 14 C-atoms, where each dicarboxylic acid may be substituted in the aliphatic, cycloaliphatic or aromatic moiety by one or two —COOZ groups; or Rₐ is a divalent radical of a phosphorus-containing acid or a divalent silyl radical; or
If m represents 3,
Rₐ represents a trivalent radical of an aliphatic, cycloaliphatic or aromatic tricarboxylic acid, which may be substituted in the aliphatic, cycloaliphatic or aromatic moiety by —COOZ, of an aromatic tricarbamic acid or of a phosphorus-containing acid, or is a trivalent silyl radical; or
If m represents 4,
Rₐ represents a tetravalent radical of an aliphatic, cycloaliphatic or aromatic tetracarboxylic acid;
If n represents one,
R_{b} represents C₁-C₁₈alkyl, C₅-C₇cycloalkyl, C₇-C₈aralkyl, C₂-C₁₈alkanoyl, C₃-C₅alkenoyl or benzoyl;
R_{c} represents C₁-C₁₈alkyl, C₅-C₇cycloalkyl, C₂-C₇alkenyl unsubstituted or substituted by a cyano, carbonyl or carbamide group, glycidyl or represents a group of the formulae —CH₂CH(OH)-Z, —CO-Z- or —CONH-Z, wherein Z represents hydrogen, methyl or phenyl, or R_{b} and R_{c} together represent the cyclic acyl radical of an aliphatic or aromatic 1,2- or 1,3-dicarboxylic acid;
If n represents two,
R_{b} is as defined above; and
R_{c} represents C₂-C₁₂alkylene, C₆-C₁₂arylene, xylylene, a —CH₂CH(OH)CH₂—O—B—O—CH₂CH(OH)CH₂— group, wherein B represents C₂-C₁₀alkylene, C₆-C₁₅-arylene or C₆-C₁₂cycloalkylene; or, provided that R_{b} is not alkanoyl, alkenoyl or benzoyl, R_{c} represents a divalent acyl radical of an aliphatic, cycloaliphatic or aromatic dicarboxylic acid or dicarbamic acid, or represents the group —O—; or
R_{c} represents a group of the partial formula: 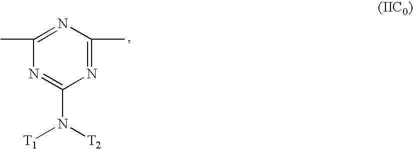
   Wherein
T₁ and T₂ independently of the other represent hydrogen, C₁-C₁₈alkyl, or T₁ and T₂ together represent C₄-C₆alkylene or 3-oxapentamethylene; or
If n represents 3,
R_{c} represents 2,4,6-triazinyl.

A highly preferred group B₀ which contains substituents in 4-position is selected from the group consisting of the partial formulae B₁ and B₂, wherein
m represents 1;
Rₐ represents hydrogen, C₁-C₁₈alkyl which is uninterrupted or interrupted by one or more oxygen atoms, 2-cyanoethyl, benzoyl, glycidyl, or represents a monovalent radical of an aliphatic carboxylic acid having 2 to 12 C-atoms, of a cycloaliphatic carboxylic acid having 7 to 15 C-atoms, of an a,b-unsaturated carboxylic acid having 3 to 5 C-atoms or of an aromatic carboxylic acid having 7 to 15 C-atoms;
m represents 2;
Rₐ represents a divalent radical of an aliphatic dicarboxylic acid having 2 to 36 C-atoms;
n represents 1;
R_{b} represents C₁-C₁₂alkyl, C₅-C₇cycloalkyl, C₇-C₈aralkyl, C₂-C₁₈alkanoyl, C₃-C₅alkenoyl or benzoyl; and
R_{c} represents C₁-C₁₈alkyl, C₅-C₇cycloalkyl, C₂-C₁₈alkenyl unsubstituted or substituted by a cyano, carbonyl or carbamide group, glycidyl, or represents a group of the partial formulae —CH₂CH(OH)-Z, —CO-Z or —CON H-Z, wherein Z represents hydrogen, methyl or phenyl.

Another highly preferred group B₀ which contains substituents in 4-position is selected from the group consisting of the partial formulae B₁ and B₂, wherein
m represents 1;
Rₐ represents hydrogen, C₁-C₁₈alkyl, 2-cyanoethyl, benzoyl, glycidyl, or a monovalent radical of an aliphatic carboxylic acid having 2 to 12 C-atoms;
m represents 2;
Rₐ represents a divalent radical of an aliphatic dicarboxylic acid having 2 to 36 C-atoms;
n represents 1;
R_{b} represents C₁-C₁₂alkyl, C₇-C₈aralkyl, C₂-C₁₈alkanoyl, C₃-C₅alkenoyl or benzoyl; and
R_{c} represents C₁-C₁₈alkyl, glycidyl, a group of the formulae —CH₂CH(OH)-Z or —CO-Z, wherein Z represents hydrogen, methyl or phenyl.

Another particularly preferred embodiment relates to the group B₀, wherein one of R₉ and R₁₀ represents hydrogen and the other one C₁-C₄alkanoylamino.

In a polymerisate (I) R₁, R₁′ and R₁″ independently of one another represent hydrogen or C₁-C₄alkyl. According to a preferred embodiment R₁, R₁′ and R₁″ independently of one another represent hydrogen or methyl. According to a particularly preferred embodiment R₁, R₁′ and R₁″ have the same meanings and represent hydrogen or methyl. In the event that R₁, R₁′ and R₁″ each represent hydrogen, the polymerisate (I) is composed of the acrylate polymer blocks I, II, or III. In the event that R₁, R₁′ and R₁″ each represent methyl, the polymerisate (I) is composed of the methacrylate polymer blocks I, II, or III.

In the polymer group I the ester group R₂ of higher polarity is, for example, an unsaturated or saturated or an aromatic hydrocarbon group substituted by hydrophilic substituents, e.g. 1-6 hydroxy groups, or 1-2 basic, e.g. 1-2 amino, or 1-2 acidic groups, e.g. carboxy, sulpho or phosphono, or 1 amino and 1 carboxy groups.

In a preferred embodiment the polymer block I, wherein R₂ represents an ester group of higher polarity, is composed of acrylate or methacrylate repeating units. Representative monomers are selected from the group consisting of acrylic acid and C₁-C₄alkylacrylic acid, particularly acrylic and methacrylic acid.

In the polymer block I R, represents an ester group of higher polarity, e.g. an ester group selected from the group consisting of mono- or dihydroxy-C₂-C₄-alkyl, e.g. 2-hydroxyethyl, 2,3-dihydroxypropyl or 4-hydroxyl-n-butyl, trihydroxy-C₃-C₅alkyl, amino-C₂-C₁₈alkyl, e.g. 2-aminoethyl or 3-amino-n-propyl, ammonio-C₂-C₁₈alkyl, e.g. 2-ammonioethyl or 3-ammonio-n-propyl, C₁-C₄alkylamino-C₂-C₁₈alkyl, e.g. 2-N-methylaminoethyl or 3-N-methylamino-n-propyl, di-C₁-C₄alkylamino-C₂-C₁₈alkyl, e.g. 2-N,N-dimethylaminoethyl or 3-N,N-dimethyl-amino-n-propyl, tri-C₁-C₄alkylammonio-C₂-C₁₈alkyl, e.g. 2-trimethylammonioethyl or 3-trimethylammonio-n-propyl, hydroxy-C₂-C₄alkylamino-C₂-C₁₈alkyl, e.g. 2-N-2-hydroxyethyl-aminoethyl, C₁-C₄alkyl-(hydroxy-C₂-C₄alkyl)amino-C₂-C₁₈alkyl, e.g. 2-[N-(2-hydroxyethyl)-N-methylamino]-ethyl, di-C₁-C₄alkyl-(hydroxy-C₂-C₄alkyl)ammonio-C₂-C₁₈alkyl, e.g. 2-[N,N-dimethyl-N-(2-hydroxyethyl)-ammonio]-ethyl, and C₁-C₄alkyl substituted by carboxy, sulpho or phosphono, e.g. 2-carboxyethyl or 2-sulphoethyl.

In a particularly preferred embodiment the polymer block I, wherein R₂ represents an ester group of higher polarity, is composed of acrylate or methacrylate repeating units. The ester group is C₂-C₄alkyl substituted by amino, ammonio, C₁-C₄alkylamino, e.g. methyl- or ethyl-amino, di-C₁-C₄alkylamino, e.g. dimethyl- or diethylamino, tri-C₁-C₄alkylammonio, e.g. trimethyl- or triethylammonio, or di-C₁-C₄alkyl-2-hydroxyethylammonio, e.g. dimethyl-2-hydroxyethylammonio.

Representative monomers are (meth)acrylates esterified by aminoalkyl groups selected from the group consisting of 2-dimethylaminoethyl acrylate (DMAEA), 2-dimethylaminoethyl methacrylate (DMAEMA), 2-diethylaminoethyl acrylate (DEAEA), 2-diethylaminoethyl methacrylate (DEAEMA), 2-t-butylaminoethyl acrylate (t-BAEA) and 2-t-butylaminoethyl methacrylate (t-BAEMA).

A suitable unsaturated or saturated or an aromatic hydrocarbon group substituted by hydrophilic substituents is selected from the group consisting of mono- or dihydroxy-C₂-C₄-alkyl, e.g. 2-hydroxyethyl or 2,3-dihydroxypropyl, trihydroxy-C₃-C₅alkyl, amino-C₂-C₁₈alkyl, e.g. 2-aminoethyl or 3-amino-n-propyl, ammonio-C₂-C₁₈alkyl, e.g. 2-ammonioethyl or 3-ammonio-n-propyl, C₁-C₄alkylamino-C₂-C₁₈alkyl, e.g. 2-N-methylaminoethyl or 3-N-methylamino-n-propyl, di-C₁-C₄alkylamino-C₂-C₁₈alkyl, e.g. 2-N,N-dimethylaminoethyl or 3-N,N-dimethyl-amino-n-propyl, tri-C₁-C₄alkylammonio-C₂-C₁₈alkyl, e.g. 2-trimethylammonioethyl or 3-trimethylammonio-n-propyl, hydroxy-C₂-C₄alkylamino-C₂-C₁₈alkyl, e.g. 2-N-2-hydroxyethyl-aminoethyl, C₁-C₄alkyl-(hydroxy-C₂-C₄alkyl)amino-C₂-C₁₈alkyl, e.g. 2-[N-(2-hydroxyethyl)N-methylamino]-ethyl, di-C₁-C₄alkyl-hydroxy-C₂-C₄alkyl)ammonio-C₂-C₁₈, alkyl, e.g. 2-[N,N-dimethyl-N-2-hydroxyethyl)-ammonio]-ethyl and C₁-C₄alkyl substituted by carboxy, sulpho or phosphono, e.g. 2-carboxyethyl or 2-sulphoethyl.

In the polymer block II the ester group R₃ of lower polarity is a saturated or aromatic hydro-carbon group selected from the group consisting of C₁-C₂₄alkyl, e.g. methyl, ethyl, isopropyl, n-butyl or 2-ethylhexyl, C₆-C₁₁aryl-C₁-C₄alkyl, e.g. benzyl, or 1- or 2-benzethyl, (C₁-C₄alkyl)₁₋₃C₆-C₁₁aryl, e.g. cumenyl, (C₁-C₄alkyl)_{1 3}C₆-C₁₁aryl-C₁-C₄alkyl, e.g. 2- or 4-methyl-benyl, C₆-C₁₁aryloxy-C₁-C₄alkyl, e.g. phenoxymethyl or 2-phenoxyethyl, C₆-C₁₁aryl-C₁₋₄alkoxy-C₁-C₄alkyl, e.g. benzyloxymethyl or 2-benzyloxyethyl, (C₁-C₄alkyl)₁₋₃silyl-C₁-C₄alkyl, e.g. 2-trimethylsilylethyl, and (C₁-C₄alkyl)₁₋₃silyloxy-C₂-C₄alkyl, e.g. 2-trimethyl-silyloxyethyl.

A polymer block II, wherein R₃ represents hydrogen or an ester group of lower polarity, is composed of acrylate or C₁-C₄alkylacrylate repeating units. Representative monomers are selected from the group consisting of acrylic and C₁-C₄alkylacrylic acid-C₁-C₂₄alkyl esters, acrylic and C₁-C₄alkylacrylic acid-C₄-C₁₁aryl-C₁-C₄alkyl esters, acrylic and C₁-C₄alkylacrylic acid-C₄-C₁₁aryloxy-C₁-C₄alkyl esters, acrylic and C₁-C₄alkylacrylic acid-(C₁-C₄alkyl)₃silyl-oxy-C₂-C₄alkyl esters and acrylic and C₁-C₄alkylacrylic acid-(C₁-C₄alkyl)₃silyl-C₁-C₄alkyl esters.

In a preferred embodiment the polymer block II, wherein R₃ represents hydrogen or an ester group of lower polarity, is composed of acrylate or methacrylate repeating units. Representative monomers are selected from the group consisting of acrylic and methacrylic acid-C₁-C₁-C₂₄alkyl esters, acrylic and methacrylic acid-C₆-C₁₁aryl-C₁-C₄alkyl esters, acrylic and methacrylic acid-C₆-C₁₁aryloxy-C₁-C₄alkyl esters, acrylic and methacrylic acid-trimethylsilyloxy-C₂-C₄alkyl esters and acrylic and methacrylic acid-trimethylsilyl-C₁-C₄alkyl esters.

Suitable acrylic acid or methacrylic acid-C₁-C₂₄alkyl esters are acrylic acid or methacrylic acid esters esterified by methyl, ethyl, n-butyl, isobutyl, tert-butyl, neopentyl, 2-ethylhexyl, Isobornyl, isodecyl, n-dodecyl, n-tetradecyl, n-hexadecyl or n-octadecyl.

Representative acrylic and C₁-C₄alkylacrylic acid-C₆-C₁₁aryl-C₁-C₄alkyl esters are acrylic acid or methacrylic acid esters esterified by benzyl, 2-phenylethyl, 1- or 2-naphthylmethyl or 2-(1- or 2-naphthyl)-ethyl. The phenyl or naphthyl groups may be additionally substituted with one to three additional substituents selected from the group consisting of hydroxy, C₁-C₄alkoxy, e.g. methoxy or ethoxy, halogen, e.g. chloro, and C₁-C₄alkyl, e.g. methyl or methyl.

Representative acrylic and C₁-C₄alkylacrylic acid-C₆-C₁₁aryloxy-C₁-C₄alkyl esters are acrylic acid or methacrylic acid esters esterified by 2-phenoxyethyl or 2-benzyloxyethyl.

Representative acrylic acid and C₁-C₄alkylacrylic acid-hydroxy-C₂-C₄alkyl esters are acrylic acid- or methacrylic acid-2-hydroxyethyl esters (HEA, HEMA), acrylic acid- or methacrylic acid-2-hydroxypropyl ester, acrylic acid- or methacrylic acid-3-hydroxypropyl ester (HPA, HPMA) or acrylic acid- or methacrylic acid-4-hydroxy-n-butyl ester.

Representative acrylic acid- and C₁-C₄alkylacrylic acid-silyloxy-C₂-C₄alkyl esters are acrylic acid- or methacrylic acid-2-trimethylsilyloxyethyl esters (TMS-HEA, TMS-HEMA).

Representative acrylic acid- or C₁-C₄alkylacrylic acid-(C₁-C₄alkyl)₃silyl-C₂-C₄alkyl esters are acrylic acid- or methacrylic acid-2-trimethylsilylethyl esters or acrylic acid- or methacrylic acid-3-trimethylsilyl-n-propyl esters.

In a polymerisate (I) Y represents the direct bond or a bivalent group, e.g. C₁-C₈alkylene, C₃-C₈alkylene substituted by hydroxy, e.g. 2-hydroxy-1,3-propylene, 2(3)-hydroxy-1,4-butylene or 2-hydroxy-1,3-propylene, C₄-C₈alkylene substituted by dihydroxy, e.g. 2,3-dihydroxy-1,4-butylene, or phenylene, e.g. 1,4- or 1,2-phenylene, poly-C₂-C₃alkoxy-C₂-C₃alkyl, e.g. a bivalent substituent derived from polyethylene glycol or polypropylene glycol (=polyethylene oxide or polypropylene oxide) or mixed polymerisates thereof as represented by the following partial formula:
—(CH₂)_{2 3}—O—[(CH₂)_{2 3}—O] —(CH₂)₂₋₃—
wherein a is a numeral from 1 to about 10, e.g. poly-C₂-C₃alkoxy-C₂-C₃alkyl derived from polyethylene glycol as represented by the following partial formula:
—(CH₂)₂O—[(CH₂)₂—O] —(CH₂)₂—
or poly-C₂-C₃alkoxy-C₂-C₃alkyl derived from polypropylene glycol as represented by the following partial formula:
—(CH₂)₃O—[(CH₂)₃—O] —(CH₂) —,
C₃-C₈alkylene interrupted by —O—, —NH—, or —N(C₁-C₄alkyl)-, e.g. —C₂H₄—O—C₂H₄— or —C₂H₄—NH—C₂H₄—, or C₃-C₈alkylene substituted by hydroxy and interrupted by —O—, —NH—, or —N(C₁-C₄alkyl)-, e.g. —(CH₂)_{1 2}—CH(—OH)—(CH₂)_{1 2}—NH—C₂H₄—. Such group is illustrated by the partial formula:

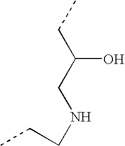

According to an alternative embodiment Y represents a substituent that contains a functional group, which forms a salt with a salt forming group present in the group Z by acid-base reaction, acid addition or quaternisation reaction. A suitable substituent Y that forms such salt “bridge” is C₂-C₈alkyl substituted by ammonio, C₁-C₄alkylammonio, e.g. methyl- or ethylammonio, di-C₁-C₄alkylammonio, e.g. dimethyl- or diethylammonio, tri-C₁-C₄alkylammonio, e.g. trimethyl- or triethylammonio, or di-C₁-C₄alkyl-2-hydroxyethylammonio, e.g. dimethyl-2-hydroxyethylammonio. In that event an acidic group, e.g. carboxy, sulpho or phosphono, is present in the group Z in the dissociated form of its carboxylate, sulphonate or phosphonate anion.

According to a further embodiment Y represents the bivalent group:
—Y₁-Y₂—

Wherein Y₁ and Y₂ represent fragments of the bivalent group Y or one of Y₁ and Y₂ represents a substituent that contains a functional group, which forms a salt with a salt forming group present in the other group by acid-base reaction, acid addition or quaternisation reaction.

A suitable substituent Y₁ or Y₂ that forms such salt “bridge” is C₂-C₈alkyl substituted by ammonio, C₁-C₄alkylammonio, e.g. methyl- or ethylammonio, di-C₁-C₄alkylammonio, e.g. dimethyl- or diethylammonio, tri-C₁-C₄alkylammonio, e.g. trimethyl- or triethylammonio, or di-C₁-C₄alkyl-2-hydroxyethylammonio, e.g. dimethyl-2-hydroxyethylammonio. In that event an acidic group, e.g. carboxy, sulpho or phosphono, is present in the other group Y₂ or Y₁ in the dissociated form of its carboxylate, sulphonate or phosphonate anion and one of Y₂ or Y₁ represents C₁-C₈alkyl substituted by a carboxylate, sulphonate or phosphonate group. This is illustrated by the partial formula:

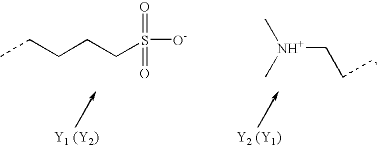

Which illustrates the partial formula —Y₁—Y₂— or the partial formula, which illustrates the fraction of the polymer block III:

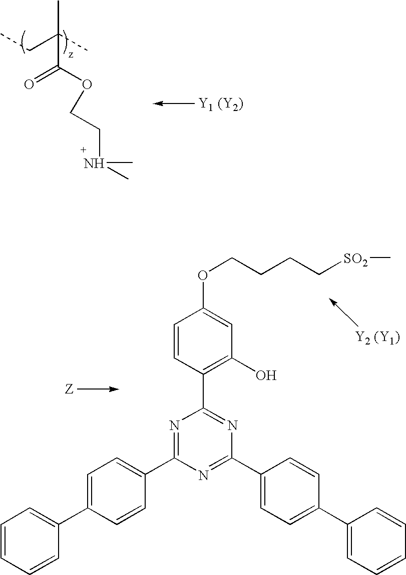

According to a further embodiment Y represents C₁-C₈alkyl substituted by an acidic group, e.g. carboxy, sulpho or phosphono, e.g. carboxymethyl or 1- or 2-carboxyethyl. In that event, a basic group, e.g. amino, C₁-C₄alkylamino, e.g. methyl- or ethylamino, di-C₁-C₄alkyl-amino, e.g. dimethyl- or diethylamino, is present in the group Z in its cationic form as the ammonio or alkylated ammonio group, e.g. C₁-C₄alkylammonio, e.g. methyl- or ethylammonio, di-C₁-C₄alkylammonio, e.g. dimethyl- or diethylammonio or tri-C₁-C₄alkylammonio, e.g. trimethyl- or triethylammonio.

According to a particularly preferred embodiment of the invention Y represents the direct bond or a bivalent group, e.g. C₁-C₈alkylene, C₃-C₆alkylene substituted by hydroxy, e.g. 2-hydroxy-1,3-propylene, C₂-C₈alkyl substituted by ammonio or di-C₁-C₄alkylammonio, e.g. dimethyl- or diethylammonio, provided that an acidic group, e.g. carboxy, sulpho or phosphono, is present in the group Z in the dissociated form of its carboxylate, sulphonate or phosphonate anion, or Y represents the partial formula —Y₁—Y₂—, wherein one of Y₁ and Y₂ represents C₂-C₈alkyl substituted by ammonio or di-C₁-C₄alkylammonio, e.g. dimethyl- or diethylammonio, and the other one represents C₁-C₈alkyl substituted by carboxy, sulpho or phosphono.

In the polymerisate (I) the group Z, which is defined as the functionally effective group of an agent having light protecting properties, is a structural moiety derived from so-called light protecting agents selected from the group consisting of UV-light absorbers, radical scavengers, singlet oxygen quenchers, triplett quenchers, photo-stabilisers and superoxide-anion quenchers.

According to a specific embodiment, the functionally effective group Z of an agent having light protecting properties is a structural moiety derived from a UV-light absorber molecule. The term UV-light absorber comprises any structural moiety, which is effective as a photo-stable UV-filter and is derived from UV-light absorber compounds that protect polymers or coatings from UV-radiation, particularly in the range from 290-450 nm, especially 300-400 nm. Examples of suitable UV-light absorbers moieties are substituents derived from UV-light absorber moieties selected from the group consisting of 2-2-hydroxy-phenyl)-1,3,5-triazines (HPT), 2-2′-hydroxyphenyl)benzotriazoles (HBZ), 2-hydroxybenzo-phenones (HBP) and oxanilides (OA).

Substituents derived from UV-light absorber moieties from the group consisting of 2-hydroxyphenyl-4,6-diaryltriazines radicals are represented by the formulae:

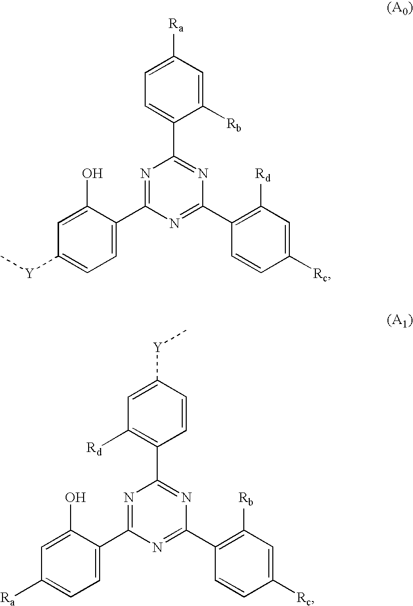

Wherein

Rₐ and R_{c} independently of one another represent hydrogen or a substituent selected from the group consisting of hydroxy, chloro, cyano, phenyl, C₁-C₆alkyl, C₁-C₁₈alkoxy, C₄-C₂₂alkoxy which is interrupted by —O— and substituted by hydroxy, C₄-C₂₂alkoxy which is substituted by hydroxy and C₂-C₁₄phenylalkoxy; and

R_{b}and R_{d} independently of one another represent hydrogen or a substituent selected from the group consisting of hydroxy, chloro, C₁-C₄alkyl and C₁-C₁₈alkoxy.

Representative groups are illustrated by the formulae:

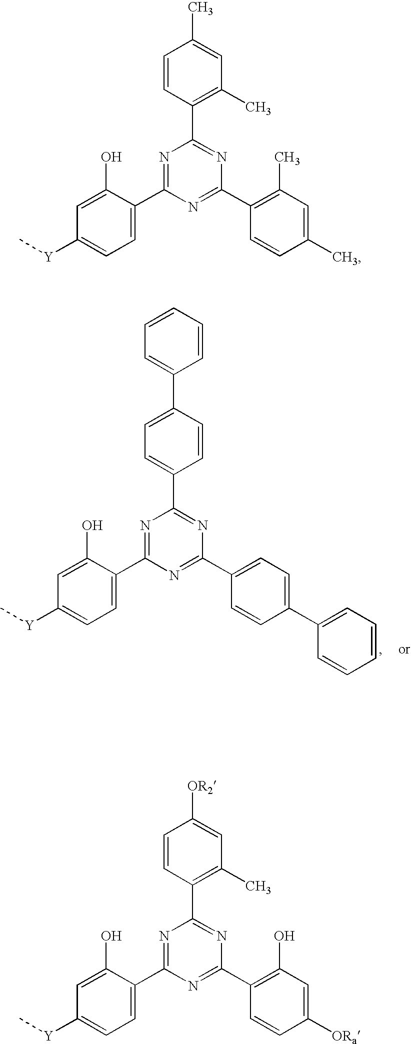

Wherein R represents, for example C₁-C₁₈alkyl.

Substituents derived from UV-light absorber moieties from the group consisting of 2-hydroxyphenylbenzotriazoles are represented by the formulae:

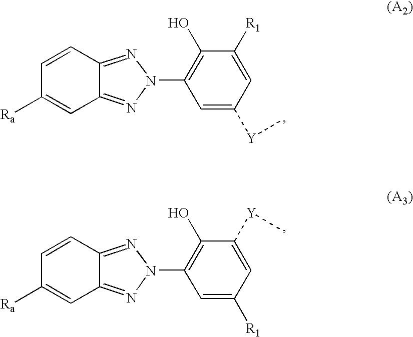

Wherein

R represents hydrogen or a substituent selected from the group consisting of chlorine, C₁-C₄alkyl and C₁-C₄alkoxy; and

R₁ represents C₁-C₁₂alkyl.

Substituents derived from UV-light absorber moieties from the group consisting of 2-hydroxyphenylbenzophenones are represented by the formulae:

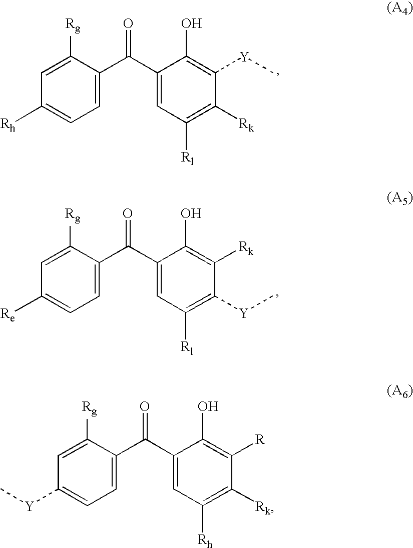

Wherein

R_{g} represents hydrogen or hydroxy;

Rₕ represents hydrogen or a substituent selected from the group consisting of chlorine, hydroxy and C₁-C₄alkoxy;

Rᵢ represents hydrogen or a substituent selected from the group consisting of chlorine, hydroxy and C₁-C₄alkoxy; and

Rₖ represents hydrogen or a substituent selected from the group consisting of chlorine, hydroxy and C₁-C₄alkyl;

Substituents derived from UV-light absorber moieties from the group consisting of oxalanilides are represented by the formulae:

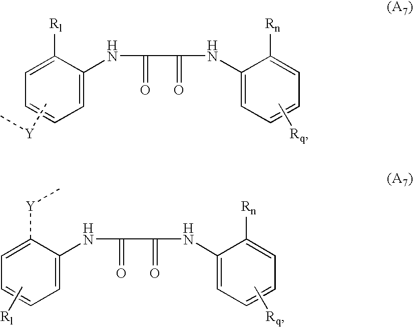

Wherein Rₗ, Rₘ and Rₙ independently of one another represent hydrogen or a substituent selected from the group consisting of C₁-C₄alkyl and C₁-C₄alkoxy.

Various specific points of attachment of the bivalent group —Y— to the group Z are shown in the formulae above. According to alternative embodiments the points of attachment of the bivalent group —Y— to the group Z may differ with regard to any suitable position of the aromatic groups shown.

Specific 2-2-hydroxyphenyl)-1,3,5-triazines are, for example, 2,4-bis(biphenyl-4-yl)-6-(2,6-dihydroxy)-1,3,5-triazine, 2-(2,4-dihydroxyphenyl)-4,6-diphenyl1,3,5-triazine, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-2,4-dimethylphenyl)-1,3,5-triazine, 2-2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropyloxy)-phenyl]4,6-bis(2,4-dimethylphenyl)-1,3,5-triazine, 2-[2-hydroxy-4-(2-hydroxy-3-octyloxy-propyloxy)-phenyl]-4,6-bis(2,4-dimethylphenyl-1,3,5-triazine, 2-[4-dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxy-phenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4methylphenyl)-1,3,5-triazine.

Specific 2-(2′-hydroxyphenyl)benzotriazoles are 2-(2′-hydroxy-5′-methylphenyl)-benzotriazole, 2-(2′,4′-dihydroxyphenyl)-benzotriazole, 2-[3′-tert-butyl-2′-hydroxy-5-(1-hydroxycarbonyl-2-ethyl)-phenyl]-benzotriazole, 2-[3′-tert-butyl-2′-hydroxy-5-(1-hydroxycarbonyl-2-ethyl)phenyl]-5-chlorobenzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-1,1,3,3-tetramethylbutyl)-phenyl)-benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α, α-dimethylbenzyl)-2′-hydroxyphenyl) benzotriazole, 2-(3′-tert-butyl-2′-hydroxy-5-(2-octyloxycarbonylethyl)phenyl)-5-chlorobenzo-triazole, 2-(3′-tert-butyl-5-[2-(2-ethylhexyloxy)carbonylethyl]-2′-hydroxyphenyl)-5-chloro-benzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5-(2-methoxycarbonylethyl)phenyl)-benzotriazole, 2-(3′-tert-butyl-2′-hydroxy-5′-(2-octyloxycarbonylethyl)phenyl)benzotriazole, 2431-tert-butyl-5′-[2-(2-ethylhexyloxy)carbonylethyl]-2′-hydroxyphenyl)benzotriazole, 2-(3′-dodecyl-2-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazol-2-ylphenol]; the transesterification product of 2-[3′-tert-butyl-5′-(2-methoxy-carbonylethyl) 2′-hydroxyphenyl]benzotriazole with polyethylene glycol 300;

[R—CH₂CH₂—COO—CH₂CH₂ [symbol] ₂; wherein R represents 3′-tert-butyl-4′-hydroxy-5′-2H-benzotriazol-2-yl-phenyl; 2-[2′-hydroxy-3′-(α,α-dimethylbenzyl)-5′-(1,1,3,3-tetramethylbutyl)phenyl]benzotriazole and 2-(2′-hydroxy-3′-1,1,3,3-tetramethylbutyl)-5′-(α,α-dimethylbenzyl)phenyl]benzotriazole.

Specific 2-hydroxybenzophenones are, for example, the 4-hydroxy, 4-methoxy, 4-octyloxy, 4-decyloxy, 4-dodecyloxy, 4-benzyloxy, 2,4-dihydroxy, 4,2′,4′-trihydroxy and 2′-hydroxy-4,4′-dimethoxy derivatives.

Specific oxanilides are, for example, 2-ethyl-2′-hydroxyoxanilide, 4,4′-dioctyloxyoxanilide, 2,2′-diethoxyoxanilide, 2,2′-dioctyloxy-5,5′-di-tert-butyloxanilide, 2,2′-didodecyloxy-5,5′-di-tert-butyloxanilide, 2-ethoxy-2′-ethyloxanilide, N,N′-bis(3-dimethylaminopropyl)oxalamide, 2-ethoxy-5-tert-butyl-2′-ethyloxanilide and its mixture with 2-ethoxy-2′-ethyl-5,4′-di-tert-butyloxanilide and mixtures of o- and p-methoxy- and of o- and p-ethoxy-disubstituted oxanilides.

In an alternative embodiment the group Z in the polymerisate (I), which is defined as the functionally effective group of an agent having light protecting properties, is a structural moiety derived from a molecule that has the property of a radical scavenger.

A structural moiety that is useful as a radical scavenger, is derived from the group of antioxidant molecules represented by the partial formula of alkylated monophenols:

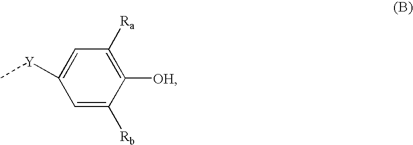

Wherein

one of Rₐ and R_{b} represents hydrogen or a substituent selected from the group consisting of phenyl, hydroxyphenyl, (C₁-C₄alkyl)₁₋₂phenyl, e.g. 3-methyl-5-tert-butylphenyl or 3,5-di-tert-butylphenyl, (C₁-C₄alkyl)_{1 2}hydroxyphenyl, e.g. 3,5-di-tert-butyl-hydroxy-phenyl and C₁-C₂-alkyl, e.g. methyl, tert-butyl, neopentyl or 2-ethylhexyl;

and the other one represents C₁-C₉alkyl, e.g. tert.-butyl.

In a preferred embodiment one of Rₐ and R_{b} represents C₃-C₄alkyl, e.g. tert-butyl, and the other one represents hydrogen or C₁-C₄alkyl, e.g. methyl or tert-butyl.

According to an alternative embodiment a structural moiety that is useful as a radical scavenger is derived from the group of so-called hindered amino light stabiliser molecules (HALS) as represented by the partial formula:

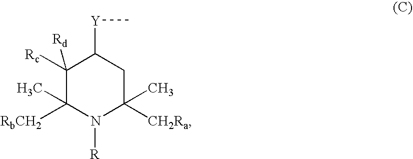

Wherein

Rₐ und R_{b} independently of one another represent hydrogen or methyl;

R_{c} und R_{d} independently of one another represent hydrogen, C₁₋₄alkyl or C₆₋₁₀aryl; or

R_{c} and R_{d} together represent oxygen; and

R represents hydrogen, C₁₋₁₈alkyl, C_{1 18}alkoxy, C₂-C₇alkyl or C₂-C₇alkoxy substituted by hydroxy, C₂₋₁₈alkenyl, C₂₋₁₈alkenyloxy, C₃₋₁₈alkinyl, C₃₋₁₈alkinyloxy, C₃₋₁₂cycloalkyl, C₃₋₁₂cycloalkoxy, C₆₋₁₀bicycloalkyl, C₆₋₁₀bicycloalkoxy, C₃₋₈cycloalkenyl, C₃₋₈cycloalkenyloxy phenyl, phenoxy, naphthyl, naphthyloxy, or phenyl, phenoxy, naphthyl and naphthyloxy mono-substituted or disubstituted by suitable substituents, e.g. C₁-C₄alkyl, e.g. methyl, ethyl or tert-butyl, C₁-C₄alkoxy, e.g. methoxy or ethoxy, or halogen, e.g. chlorine, or represents acyl or acyloxy.

The acyl radical R is, for example, derived from a monobasic organic acid comprising C-radicals and an acid function, e.g. one acyl radicals of the partial formulae —C(═O)—H, —C(═O)—C₁-C₁₉alkyl, —C(═O)—C₂-C₁₉alkenyl, —C(═O)—C₂-C₄alkenyl-C₆-C₁₀aryl, —C(═O)-C₆-C₁₀aryl, —C(═O)—O—C₁-C₆alkyl, —C(═O)—O—C₆-C₁₀aryl, —C(═O)—NH—C₁-C₆alkyl, —C(═O)—NH—C₆-C₁₀aryl and —C(═O)—N(C₁-C₆alkyl)₂. Preferred acyl groups are formyl, acetyl, trifluoroacetyl, pivaloyl, acryloyl, methacryloyl, oleoyl, cinnamoyl, benzoyl, 2,6-xyloyl, tert-butoxycarbonyl, ethylcarbamoyl or phenylcarbamoyl. Preference is given to C₂-C₁₈alkanoyl or C₃-C₆alkenoyl.

In an acyloxy radical R the acyl group is as defined above, particularly an acyl group of the partial formulae of above, e.g. —O—C(═O)—C₁-C₁₉alkyl, —O—C(═O)—C₂-C₁₉alkenyl, —O—C(═O)—C₆-C₁₀aryl. Preferred acyloxy groups are acetoxy, trifluoroacetoxy, pivaloyloxy, acryloyloxy, methacryloyloxy or benzoyloxy.

In an alternative embodiment the group Z in the polymerisate (I), which is defined as the functionally effective group of an agent having light protecting properties, is a structural moiety derived from a molecule that has the property of a singlet oxygen quencher.

A singlet oxygen quencher molecule deactivates singlet oxygen by energy transfer. A suitable singlet oxygen quencher is selected from the group consisting of DABCO (2,2,2-bicyclooctanediamine) and its derivatives, NO-HALS compounds, furfuryl alcohols and 1,4-DBPF derivatives.

The functionally effective group Z derived from DABCO and its derivatives is represented by the partial formula:

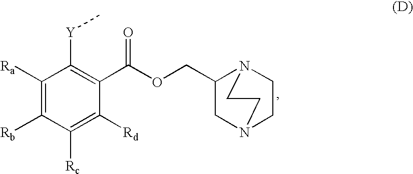

Wherein Rₐ, R_{b}, R_{c} and R_{d} independently of one another represent hydrogen, halogen, e.g. chloro or bromo, C₁-C₄alkyl, e.g. methyl, or C₄alkoxy, e.g. methoxy.

The bridge group Y is attached directly to the phenyl moiety in the partial formula of above or, in the alternative, forms a salt with a salt forming group present in the group Z by acid-base reaction, acid addition or quaternisation reaction. A suitable substituent Y that forms such salt “bridge” is C₂-C₈alkyl substituted by ammonio or di-C₁-C₄alkylammonio, e.g. di-methyl- or diethylammonio. An acidic group, e.g. carboxy, sulpho or phosphono, is present in the group Z in the dissociated form of its carboxylate, sulphonate or phosphonate anion. This is illustrated by the partial formula:

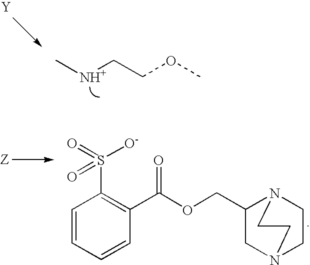

A starting material of the formula:

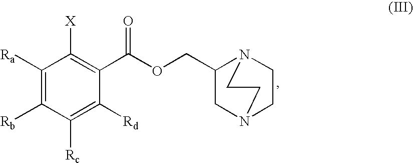

Wherein

X represents carboxy, sulpho or phosphono; and

Rₐ, R_{b}, R_{c} and R_{d} independently of one another represent hydrogen, halogen, e.g. chloro or bromo, C₁-C₄alkyl, e.g. methyl, or C₁-C₄alkoxy, e.g. methoxy;

is novel and also subject matter of the present invention.

According to a preferred embodiment the invention also relates to a starting material of the formula: 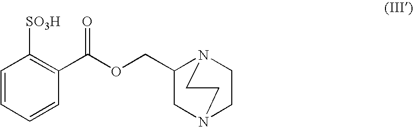 (Rₐ, R_{b}, R_{c} and R_{d}═H)

According to an alternative embodiment the functionally effective group Z derived from DABCO and its derivatives is represented by the partial formula:

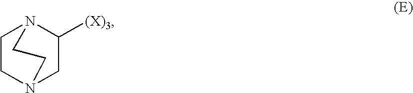

Wherein the index a represents one or zero (=direct bond) and X represents a bivalent functional group, e.g. —C(═O)—O—, —C(═O)—NH—, —CH₂—O—, —O—, —NH— or —N(C₁-C₄alkyl)-, which is attached to Y.

A starting material of the formula:

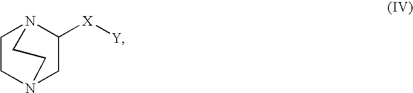

Wherein

X represents a bivalent functional group selected from the group consisting of —C(═O)—NH—, —CH, —O—, —O—, —NH— and —N(C₁-C₄alkyl)-; and

Y represents C₁-C₄alkyl, hydroxy-C₂-C₄alkyl, amino-C₂-C₄alkyl, acryloyl or methacryloyl; is novel and also subject matter of the present invention.

According to a preferred embodiment the invention also relates to the following starting materials of the formulae:

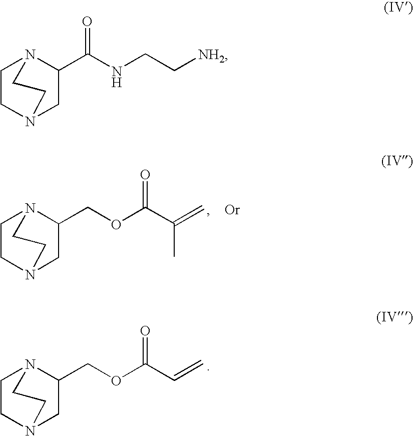

According to an alternative embodiment the functionally effective group Z derived from NO-HALS compounds is represented by the partial formula:

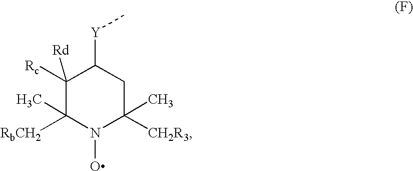

Wherein

Rₐ und R_{b} independently of one another represent hydrogen or methyl;

R_{c} und R_{d} independently of one another represent hydrogen, C₁-C₄alkyl, e.g. methyl, or C₆-C₁₀aryl, e.g. phenyl; or

R_{c} and R_{d} together represent oxygen.

The functionally effective group Z derived from furfuryl alcohols is represented by the partial formula:

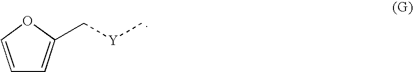

The functionally effective group Z derived from 1,4-DBPF-derivatives is represented by the partial formula:

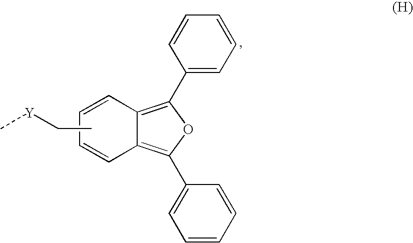

Wherein the aromatic moieties may additionally be substituted with halogen, e.g. chloro or bromo, C₁-C₄alkyl, e.g. methyl, or C₁-C₄alkoxy, e.g. methoxy.

In an alternative embodiment the group Z in the polymerisate (I), which is defined as the functionally effective group of an agent having light protecting properties, is a structural moiety derived from a molecule that has the property of a triplett quencher, e.g. stilbene and its derivatives.

A triplett quencher molecule possesses on energetically lower lying T₁ niveau than that of the excited chromophore (Ch*). For that reason an exothermal radiationless energy transfer from the energetically higher lying T₁ niveau of the quenching molecule is very close to the excited molecule or is even molecularly linked to it by a short linking unit such as a methylene group. Common triplett quencher molecules are stilbene derivatives, cyclooctotetraene or heavy metal ions (e.g. nickel complexes). Definition from: Light Stabilisers, D. Leppard et al., Chimia 56 (2002), 216-224, v. 3.3.2.

The functionally effective group Z derived from stilbene is represented by the partial formula:

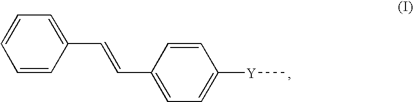

Wherein the aromatic moieties may additionally be substituted with halogen, e.g. chloro or bromo, C₁-C₄alkyl, e.g. methyl, or C₁-C₄alkoxy, e.g. methoxy.

In a preferred embodiment Rₐ represents methyl and R_{b} represents C₃-C₈alkyl, e.g. n-butyl.

In an alternative embodiment the group Z in the polymerisate (I), which is defined as the functionally effective group of an agent having light protecting properties, is a structural moiety derived from a molecule that has the property of a photo stabiliser.

The functionally effective group Z derived from a photo stabiliser molecule is represented by the partial formula:

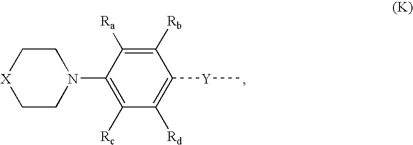

Wherein

—X— represents the heteroatoms —O— or —S— or the groups —S(═O)—, —S(═O)₂— or >N—Rₐ,

Wherein

R represents hydrogen, C₁-C₁₈alkyl, —CH₂CH(OH)CH₂O(C₁-C₁₈alkyl) or C₁-C₁₈alkyl-C(═O)—;

R₁, R₂, R₃ and R₄ independently of one another represent hydrogen, C₁-C₁₂alkyl, e.g. methyl or ethyl, C₁-C₈alkoxy, e.g. methoxy or ethoxy, C₃-C₇cyclolalkyl, e.g. cyclopentyl or cyclohexyl, phenyl, phenyl-C₁-C₄alkyl, e.g. benyl, or halogen, e.g. chloro or bromo.

According to an alternative embodiment, the functionally effective group Z derived from a photo stabiliser molecule is represented by the partial formula:

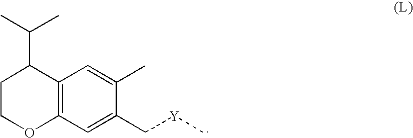

In an alternative embodiment the functionally effective group Z in the polymerisate (I), which is defined as the functionally effective group of an agent having light protecting properties, is a structural moiety derived from a molecule that has the property of superoxide-anion-quenchers.

The functionally effective group Z derived from a superoxide-anion-quencher is represented by the partial formula:

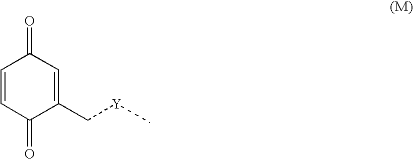

In an alternative embodiment the group Z in the polymerisate (I), which is defined as the functionally effective group of an agent having light protecting properties, is a structural moiety derived from a molecule that has the property of a nickel quencher.

A particularly preferred embodiment of the invention relates to a polymerisate (I), wherein
A and B represent polymer chain terminal groups;
R₁, R₁′ and R₁″ independently of one another represent hydrogen or methyl;
R₂ represents an ester group selected from the group consisting of mono- or dihydroxy-C₂-C₄-alkyl, e.g. 2-hydroxyethyl, 2,3-dihydroxypropyl or 4-hydroxyl-n-butyl, trihydroxy-C₃-C₅alkyl, amino-C₂-C₁₈alkyl, e.g. 2-aminoethyl or 3-amino-n-propyl, ammonio-C₂-C₁₈alkyl, e.g. 2-ammonioethyl or 3-ammonio-n-propyl, C₁-C₄alkylamino-C₂-C₁₈alkyl, e.g. 2-N-methylaminoethyl or 3-N-methylamino-n-propyl, di-C₁-C₄alkylamino-C₂-C₁₈alkyl, e.g. 2-N,N-dimethylaminoethyl or 3-N,N-dimethylamino-n-propyl, tri-C₁-C₄alkylammonio-C₂-C₁₈alkyl, e.g. 2-trimethylammonioethyl or 3-trimethylammonio-n-propyl, hydroxy-C₂-C₄alkylamino-C₂-C₁₈alkyl, e.g. 2-N-2-hydroxyethylaminoethyl, C₁-C₄alkyl-(hydroxy-C₂-C₄alkyl)amino-C₂-C₁₈alkyl, e.g. 2-(N-(2-hydroxyethyl)-N-methyl-amino]-ethyl, di-C₁-C₄alkyl(hydroxy-C₂-C₄alkyammonio-C₂-C₁₈alkyl, e.g. 2-[N,N-di-methyl-N-2-hydroxyethyl)-ammonio]-ethyl, and C₁-C₄alkyl substituted by carboxy, sulpho or phosphono, e.g. 2-carboxyethyl or 2-sulphoethyl.
R₃ represents C₁-C₈alkyl, e.g. methyl, ethyl, isopropyl, n-butyl or 2-ethylhexyl;
Y represents the direct bond or a bivalent group;
Z represents the functionally effective group of an agent having light protecting properties;
The indices p and x represent zero;
And the numerals II and III and the indices q, r, y and z are as defined above.

A highly preferred embodiment of the invention relates to a polymerisate (I), wherein
A and B represent polymer chain terminal groups;
R₁, R₁′ and R₁″ independently of one another represent hydrogen or methyl;
R₂ represents an ester group selected from the group consisting of C₂-C₄alkyl substituted by amino, ammonio, C₁-C₄alkylamino, e.g. methyl- or ethylamino, di-C₁-C₄alkylamino, e.g. dimethyl- or diethylamino, tri-C₁-C₄alkylammonio, e.g. trimethyl- or triethylammonio, or di-C₁-C₄alkyl-2-hydroxyethylammonio, e.g. dimethyl-2-hydroxyethylammonio;
R₃ represents C₁-C₈alkyl;
Y represents the direct bond or a bivalent group;
Z represents the functionally effective group of an agent having light protecting properties;
The indices p and x represent zero;
The indices q and r represent one;
The indices y and z represent numerals greater than one;
And the numerals II and III are as defined above.

A further embodiment of the present invention relates to a process for preparing the polymerisate (I), which comprises
a) Esterification of a polymerisate of the formula: 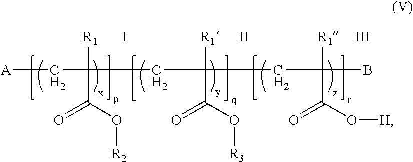
Wherein
A, B, R₁, R₁′, R₁″, the numerals I, II and III and the indices p, q, r, x, y and z are as defined above, or a reactive functional derivative thereof, with
   H—Y-Z (VI);
b) Polymerisation of the individual polymer blocks I, II and III or any multiples thereof by the method of controlled polymerisation; and
Optional replacement of the polymer chain terminal group B with a different chain terminal group.

According to a specific embodiment of process a) a polymerisate (I) is prepared, wherein Y represents a bivalent group, by reacting a polymerisate of the formula:

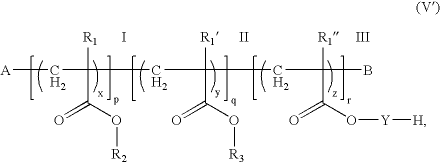

Wherein

A, B, R₁, R₁′, R₁″, the numerals I, II and III and the indices p, q, r, x, y and z are as defined above, and Y represents a bivalent group, with
H-Z (VI′).

This process is illustrated by the following reaction sequence:

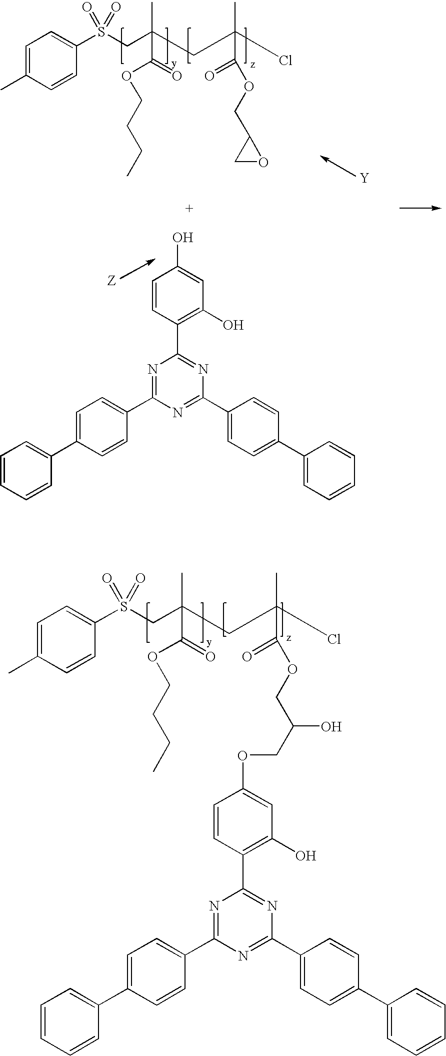

The polymerisate (IV′) is obtained by polymerising the polymer blocks I and II by the method of controlled or “living” polymerisation the monomer units in the presence of a suitable polymerisation initiators described above:

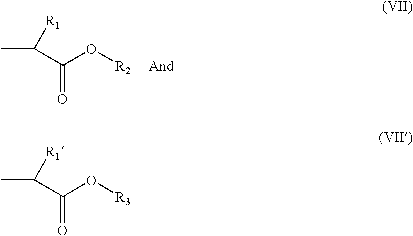

The polymerisate

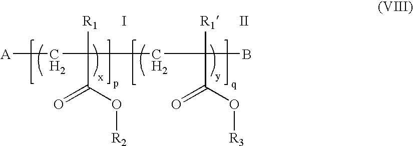

Is then polymerised by the same method of controlled or “living” polymerisation with the monomer units

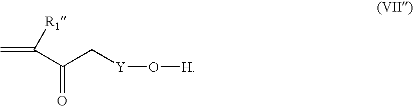

Or polymer blocks thereof. This is illustrated by the preparation of the representative compound, wherein p=0:

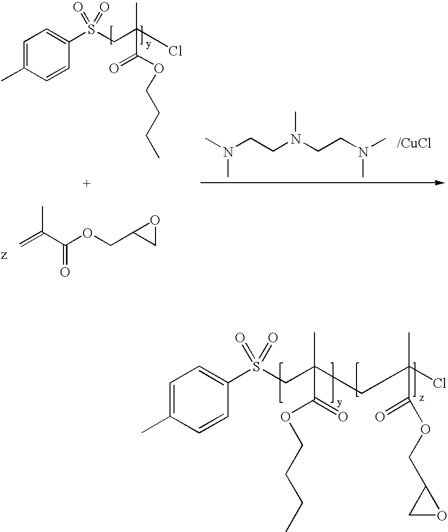

According to the alternative process variant b) the polymer blocks I and II are prepared by applying the method of controlled or “living” polymerisation and polymerising the monomer units (VII) and (VII′) in the presence of a suitable polymerisation initiators described above. The polymerisate (VIII) is then polymerised further by the same method of controlled or “living” polymerisation with the monomer unit (VII″) or polymer blocks thereof. This is illustrated by the preparation of the representative compound (I), wherein p=0 and Y is the direct bond:

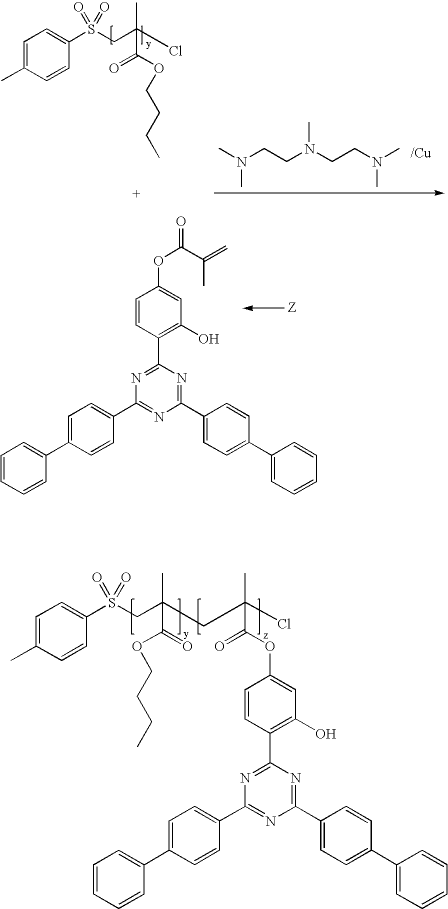

The polymerisation process according to the method of controlled, particularly “living” polymerisation, such as atomic transfer radical polymerisation (ATRP), may be carried out in the presence of water or an organic solvent or mixtures thereof. Additional co-solvents or surfactants, such as glycols or ammonium salts of fatty acids, may be added to the reaction mixture. The amount of solvent should be kept as low as possible. The reaction mixture may contain the above-mentioned monomer units or polymer blocks in an amount of 1.0 to 99.9% by weight, preferably 5.0 to 99.9% by weight, and especially preferably 50.0 to 99.9% by weight, based on the monomers present in the polymerisate.

If organic solvents are used, suitable solvents or mixtures of solvents are typically pure alkanes (hexane, heptane, octane, isooctane), hydrocarbons (benzene, toluene, xylene), alkanols (methanol, ethanol, ethylene glycol, ethylene glycol monomethyl ether), esters (ethyl, n-propyl, n-butyl or n-hexyl acetate) and ethers (diethyl or dibutyl ether, ethylene glycol dimethyl ether, tetrahydrofuran), or mixtures thereof.

If water is used as a solvent the reaction mixture can be supplemented with a water-miscible or hydrophilic co-solvent. The reaction mixture will then remain in a homogeneous single phase throughout the monomer conversion. Any water-soluble or water-miscible co-solvent may be used, as long as the aqueous solvent medium is effective in providing a solvent system, which prevents precipitation or phase separation of the reactants or polymer products until full completion of the polymerisation. Exemplary co-solvents useful in the process may be selected from the group consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organosulphides, sulphoxides, sulphones, alcohol derivatives, hydroxyether derivatives such as butyl carbitol or cellosolve, amino alcohols, ketones, and the like, as well as derivatives and mixtures thereof. Specific examples include methanol, ethanol, propanol, dioxan, ethylene, diethylene, propylene or dipropylene glycol, glycerol, tetrahydrofuran, and other water-soluble or water-miscible materials, and mixtures thereof. When mixtures of water and water-soluble or water-miscible organic solvents are selected for the process, the water to co-solvent weight ratio is typically in the range of about 99:1 to about 10:90.

When monomer mixtures or monomer/polymer mixtures are used, the calculation of mol % is based on an average molecular weight of the mixture.

The polymerisation temperature may range from about 50° C. to about 180° C., preferably from about 80° C. to about 150° C. At temperatures above about 180° C., the controlled conversion of the monomers into polymers may decrease, and undesirable by-products like thermally initiated polymers are formed or decomposition of the components may occur.

The polymerisation process by the method of controlled, particularly “living” polymerisation, is carried in the presence of a suitable catalyst capable of activating ATRP. Such catalyst is a transition metal complex catalyst salt present as an oxidisable complex ion in the lower oxidation state of a redox system. Preferred examples of such redox systems are selected from the group consisting of Group V(B), VI(B), VII(B), VIII, IB and IIB elements, such as Cu⁺/Cu²⁻, Cu⁰/Cu⁻, Fe⁰/Fe²⁻, Fe²⁺/Fe³⁺, Cr²⁺/Cr³⁺, Co¹/Co²⁺, Co²⁺/Co³⁺, Ni⁰/Ni⁻, Ni⁺/Ni²⁺, Ni²⁺/Ni³⁺, Mn⁰/Mn²⁺, Mn²⁺/Mn³⁺, Mn³⁻/Mn⁴⁻ or Zn⁻/Zn²⁻.

The ionic charges are counterbalanced by anionic ligands commonly known in complex chemistry of transition metals, such hydride ions (H⁻) or anions derived from inorganic or organic acids, examples being halides, e.g. F⁻, Cl⁻, Br⁻ or I⁻, halogen complexes with transition metals, such as Cu⁻Br₂⁻; halogen complex ions of the type BF₄⁻, PF₄⁻, SbF₄⁻ or AsF₄⁻, anions of oxygen acids, alcoholates or acetylides or the anion of cyclopentadiene.

Anions of oxygen acids are, for example, sulphate, phosphate, perchlorate, perbromate, periodate, antimonate, arsenate, nitrate, carbonate, the anion of a C₁-C₈carboxylic acid, such as formate, acetate, propionate, butyrate, benzoate, phenylacetate, mono-, di- or trichloro- or -fluoroacetate, sulphonates, for example methane-, ethane-, n-propane- or n-butanesulphonate, trifluoromethanesulphonate (triflate), unsubstituted or C₁-C₄alkane-, C₁-C₄alkoxy- or halo-, especially fluoro-, chloro- or bromo-substituted benzenesulphonate or phenylmethanesulphonate, for example tosylate, mesylate, brosylate, p-methoxy- or p-ethoxybenzene-sulphonate or 2,4,6-triisopropanesulphonate, phosphonates, for example methyl, ethyl, n-propyl, n-butyl, phenyl, p-methylphenyl or benzylphosphonate, and also C₁-C₁₇alcoholates, such as straight chain or branched C₁-C₁₂alcoholates, e.g. methanolate or ethanolate.

Anionic and neutral ligand forming agents may also be present up to the preferred coordination number of the complex cation, especially four, five or six. Additional negative charges are counterbalanced by cations, especially monovalent cations such as Na⁺, K⁺, NH₄⁺ or (C₁-C₄alkyl)₄N′.

Suitable neutral ligand forming agents generate inorganic or organic neutral ligands commonly known in complex chemistry of transition metals. They coordinate to the metal ion through a σ-, π-, μ- or η-type bonding or any combinations thereof up to the preferred coordination number of the complex cation. Suitable inorganic ligands are selected from the group consisting of aquo (H₂O), amino, nitrogen, carbon monoxide and nitrosyl. Suitable organic ligands are derived from ligand forming agents selected from the group consisting of phosphines, e.g. (C₆H₉)₃P, (i-C₃H₂)₃P, (C₅H₉)₃P or (C₆H₁₁)₃P, di-, tri-, tetra- and hydroxyamines, such as ethylenediamine, ethylenediaminetetraacetate (EDTA), N,N-dimethyl-N′,N′-bis(2-dimethylaminoethyl)-ethylenediamine (Me₆TREN), catechol, N,N′-dimethyl-1,2-benzene-diamine, 2-(methylamino)phenol, 3-(methylamino)-2-butanol or N,N′-bis(1,1-dimethyl-ethyl)-1,2-ethanediamine, N,N,N′,N″,N″-pentamethyldiethylenetriamine (PMDETA), C₁-C₈-glycols or glycerides, e.g. ethylene or propylene glycol or derivatives thereof, e.g. di-, tri- or tetraglyme, and mono- or bidentate heterocyclic e⁻-donor ligands.

Heterocyclic e⁻ donor ligands are derived, for example, from unsubstituted or substituted heteroarenes from the group consisting of furan, thiophene, pyrrole, pyridine, bis-pyridine, picolylimine, γ-pyran, γ-thiopyran, phenanthroline, pyrimidine, bis-pyrimidine, pyrazine, indole, coumarone, thionaphthene, carbazole, dibenzofuran, dibenzothiophene, pyrazole, imidazole, benzimidazole, oxazole, thiazole, bis-thiazole, isoxazole, isothiazole, quinoline, bis-quinoline, isoquinoline, bis-isoquinoline, acridine, chromene, phenazine, phenoxazine, phenothiazine, triazine, thianthrene, purine, bis-imidazole and bis-oxazole.

The oxidisable transition metal complex catalyst can be formed in a separate preliminary reaction step from its ligands or is preferably formed in-situ from its transition metal salt, e.g. Cu(I)Cl, which is then converted to the complex compound by addition of compounds corresponding to the ligands present in the complex catalyst, e.g. by addition of ethyl-enediamine, EDTA, Me₄TREN or PMDETA.

The transition metal in the oxidisable transition metal complex catalyst salt is converted from its lower oxidation state in the above-mentioned redox systems to its higher oxidation state. In a preferred embodiment of the process a Cu(I) complex catalyst salt is converted to the corresponding Cu(II) oxidation state.

Because the present polymerisation by ATRP is a “living” polymerisation, it can be started and terminated practically at will. The copolymers (I) as obtained by the process have a low polydispersity. Preferably the polydispersity is from 1.01 to 2.20, more preferably from 1.01 to 1.90, and most preferably from 1.01 to 1.50.

The various advantages of the process of this type that allow a large range of polymerisation reactions are described by K. Matyjaszewski in ACS Symp. Ser. Vol. 685 (1998), pg. 2-30.

According to an alternative polymerisation method, the polymerisation is carried out by applying the method of the so-called controlled polymerisation with >N—O—R compounds in the presence of a suitable initiator molecule as described above.

According to another alternative polymerisation method, the polymerisation is carried out by applying the method of the so-called controlled polymerisation with >N—O• compounds in the presence of a suitable initiator molecule as described above.

The process conditions are known from the literature and are similar to the ones mentioned above with regard to ATRP.

In a polymerisate (I) one of A and B represents a polymer chain terminal group. A suitable chain terminal group is a radically transferable group, hydrogen, a polymerisable chain terminal group or a saturated polymer chain terminal group, which is formed by polymerisation or copolymerisation of a polymerisable chain terminal group.

A radically transferable group is a group that results from ATRP with suitable initiators as described above, such as chlorine or bromine.

An alternative embodiment relates to compositions comprising a polymerisate (I), particularly a copolymer, e.g. a macro-monomer, wherein one of A and B is a polymerisable chain terminal group. Such group contains at least one polymerisable, ethylenically unsaturated monomer unit.

A preferred polymerisable chain terminal group is an ethylenically unsaturated group corresponding to monomers selected from the group consisting of styrenes, acrylic acid, C₁-C₄alkylacrylic acid, amides, anhydrides and salts of acrylic acid or C₁-C₄alkylacrylic acid, acrylic acid-C₁-C₂₄alkyl esters and C₁-C₄alkylacrylic acid-C₁-C₂₄alkyl esters, acrylonitrile, methacrylonitrile, vinyl substituted heterocycles, styrene sulphonic acid and salts, vinyl benzoic acid and salts, vinyl formamide and amidosulphonic acid derivatives.

The macro-monomers are prepared by known methods such as the ones described WO 01/51534, e.g. by reacting a polymerisate (I), particularly a copolymerisate, obtainable by ATRP, wherein one of A and B is a radically transferable atom or group, e.g. halogen, with ethylenically unsaturated monomers as defined above.

The elimination of the radically transferable group, e.g. halogen, with a polymerisable chain terminal group is advantageously performed in such a way that the polymerisate is dissolved in a solvent and the monomeric compound corresponding to A or B is added at higher temperatures in the presence of a strong but non-nucleophilic base, such as diazabicycloundecene (DBU), or similar bases. The reaction takes place within a temperature range from room temperature to the boiling temperature of the reaction mixture, preferably from room temperature to 100° C.

A polymerisate (I), particularly a copolymer wherein one of A or B is a saturated polymer chain terminal group, e.g. a comb polymer, is obtained by further polymerising a macromonomer of above with ethylenically unsaturated monomers by any known method of polymerisation, such as radical polymerisation with initiators of the nitrile type, e.g. AIBN, or peroxides, e.g. benzoyl peroxide or di-tert-butyl peroxide. In the alternative the copolymerisation of the macro-monomer with co-monomers can also be conducted by ATRP or any other method of controlled radical polymerisation, such as nitroxyl mediated controlled free radical polymerisation.

Depending on the structure and amount of the monomers used, the polymerisates (I) of the invention may have different properties. The polymerisates (I) show a longer persistency, due to their excellent compatibility with any polymeric substrate and their appropriate molecular weight that avoids any additive loss caused by thermal effects.

Another embodiment of the invention relates to a composition comprising
a) A composition of matter susceptible to degradation induced by light, heat or oxidation; and
b) The polymerisate (I), wherein A, B, R₁, R₁′, R₁″, R₂, R₃, Y, Z, the numerals I, II and III and the indices p, q, r, x, y and z are as defined above.

A particularly preferred embodiment of the invention relates to a composition comprising
a) A composition of matter susceptible to degradation induced by light, heat or oxidation selected from the group consisting of LDPE (=low density polyethylene), LLDPE (=linear low density polyethylene), EVA (=ethylene vinyl acetate), PP (=polypropylene) and PET (=polyethyleneterephthalate); and
b) The polymerisate (I), wherein A, B, R₁, R₁′, R₁″, R₂, R₃, Y, Z, the numerals I, II and III and the indices p, q, r, x, y and z are as defined above.

The additives or auxiliaries listed above selected from the group consisting of antioxidants, UV-absorbers, light stabilisers, metal deactivators, phosphites, phosphines, phosphonites, hydroxylamines, nitrones, thiosynergists, peroxide scavengers, polyamide stabilisers, basic co-stabilisers, nucleating agents, fillers, reinforcing agents, benzofuranones, indolinones and other additives are present as optional components in the composition.

The polymers and compositions obtainable in accordance with the invention are particularly suitable for producing structural polymers, wherein protection against UV-radiation is desirable, such as protective foils for greenhouses, packaging foils, mouldings for cars, boats, leisure articles, pallets, pipes, sheets, etc.

The present invention, therefore, also relates to a method for stabilising a composition of matter against degradation Induced by light, heat or oxidation, which comprises incorporating within the composition of matter the polymerisate (I), wherein A, B, R₁, R₁′, R₁″, R₂, R₃, Y, Z, the numerals I, II and III and the indices p, q, r, x, y and z are as defined above.

A particularly preferred embodiment of the present invention relates to a pigment composition comprising
a′) 0.1-99.9% by weight dispersible organic or inorganic pigment particles; and
b′) 0.1-99.9% by weight of a polymerisate (I), wherein A, B, R₁, R₁′, R₂″, R₂, R₃, Y, Z, the numerals I, II and III and the indices p, q, r, x, y and z are as defined above.

Suitable dispersible organic pigments are pigments or pearlescent flakes selected from the group consisting of azo, disazo, naphthol, benzimidazolone, azo-condensation, metal complex, isoindolinone, and isoindoline pigments, the chinophthalon pigment, dioxazine pigment and the polycyclic pigment group consisting of indigo, thioindigo, quinacridones, phthalocyanines, perylenes, perionones, anthraquinones, such as aminoanthraquinones or hydroxyanthraquinones, anthrapyrimidines, indanthrones, flavanthrones, pyranthrones, anthantrones, isoviolanthrones, diketopyrrolopyrrole, and carbazoles, e.g. carbazole violet, and the like. Further examples of organic pigments can be found in the monograph: W. Herbst K. Hunger “Industrielle Organische Pigmente” 2^{nd} Edition, 1995, VCH Verlagsgesellschaft, ISBN: 3-527-28744-2.

Suitable dispersible inorganic pigments are selected from the group consisting of metallic flakes, such aluminium, aluminium oxide, calcium carbonate, silicon oxide and silicates, iron(III)oxide, chromium(III)oxide, titanium(IV)oxide, zirconium(IV)oxide, zinc oxide, zinc sulphide, zinc phosphate, mixed metal oxide phosphates, molybdenum sulphide, cadmium sulphide, carbon black or graphite, vanadates, such as bismuth vanadate, chromates, such as lead(IV)chromate, and molybdates, such as lead(IV)molybdate, and mixtures, crystal forms or modifications thereof, such as rutil, anatas, mica, talcum or kaolin.

The composition may contain in addition to component a′)—pigments— and component b′)—the polymerisate (I)— additional dispersing agents, conventional binder materials for preparing coating compositions, e.g. paints, fillers, and other conventional additives, in particular conventional additives selected from the group consisting of surfactants, light stabilisers, UV-absorbers, anti-foaming agents, dispersion stabilisers, dyes, plasticisers, thixotropic agents, drying catalysts, anti-skinning agents and levelling agents. The composition may also contain conventional additives, such as antioxidants, flow control agents, rheology control agents such as fumed silica, micro gets, screeners, quenchers or absorbers. These additives can be added individually or in mixtures, with or without so-called sterically hindered amines (HALS).

The composition may contain the above-mentioned pigment component a′) in an amount of 0.1 to 99.9% by weight, preferably 0.1 to 50.0% by weight, and particularly preferably 1.0 to 30.0% by weight.

The present invention also relates to a pigment dispersion comprising
a″) Dispersed organic or inorganic pigment particles; and
b″) A dispersing agent consisting of at least one polymerisate (I), wherein A, B, R₁, R₁′, R₁″, R₂, R₃, Y, Z, the numerals I, II and III and the indices p, q, r, x, y and z are as defined above; And a carrier liquid comprising water, organic solvents and mixtures thereof.

The term dispersing agent is defined within the limits of a so-called solid/liquid dispersion, as opposed to other types of dispersions, such as liquid/liquid (e.g. emulsions) or solid/gas (e.g. fumes) dispersions. Solid/liquid dispersions that apply here consist of a two-phase system containing insoluble solid particles or solid particles of low solubility within a liquid. The dispersing agent, in the present case the polymerisate (I), as defined above, enables solid particles, in the instant case pigment particles, to be distributed homogeneously within a liquid phase, e.g. water or organic solvent, or mixtures of both, or a polymer melt. Homogeneous distribution means that the concentration of the solid particles within the liquid phase in any volume fraction of the liquid phase is identical or approximately identical (even distribution of the solid particles).

According to a further embodiment of the invention the component b″) of the pigment dispersion defined above additional contains a dispersing agent that forms a salt with the polymerisate (I) by acid-base reaction, acid addition or quaternisation reaction.

In particular, the additional dispersing agent contains an acidic group, such as the sulpho, carboxy or phosphono group, which forms a salt by reaction with a basic group, such as the free amino group or a primary, secondary or tertiary amino group, which is present in one of the polymer blocks I, II, or III or the chain terminal group A or B of the polymer component (I). In an alternative embodiment an acidic group, such as the sulpho, carboxy or phosphono group, is present in one of the polymer blocks I, II or III or the chain terminal group A or B of the polymer component (I). The additional dispersing agent then contains the free amino group or a primary, secondary or tertiary amino group.

A suitable additional dispersing agent that contains an acidic group, such as the sulpho, carboxy or phosphono group, an organic acid selected from the group consisting polycyclic sulphonic, mono- or polycyclic carboxylic or phosphonic acids, aliphatic sulphonic, carboxylic or phosphonic acids substituted with mono- or polycyclic groups, C₁-C₈alkyl halides substituted with mono- or polycyclic groups and C₁-C₄alkyl esters of mono- or polycyclic sulphonic acids, e.g. p-toluene sulphonic acid or any other sulphonic acid or carboxylic acids selected from the group listed below:

Some sulphonic acids are listed below as non-limiting examples:

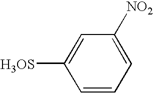

3-nitrobenzene sulphonic acid

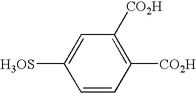

4-sulphophthalic acid

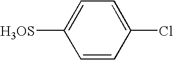

4-chlorobenzene sulphonic acid

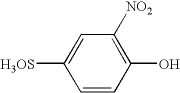

4-hydroxy-3-nitrobenzene sulphonic acid

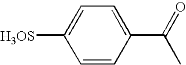

4-acetylsulphonic acid

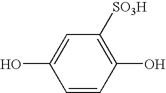

2,5-dihydroxybenzene sulphonic acid

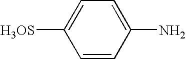

sulphanilic acid

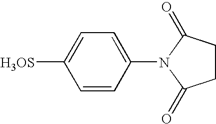

4-succinimidobenzenesulphonic acid

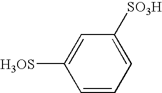

benzene-1,3-disulphonic acid

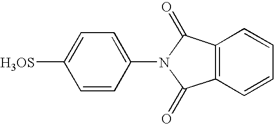

4-phthalimidobenzenesulphonic acid

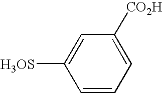

3-sulphobenzoic acid

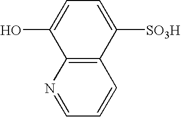

8-hydroxyquinoline sulphonic acid

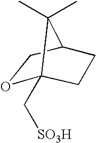

(+−)camphor-10-sulphonic acid

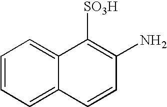

2-naphthylamine-1-sulphonic acid and isomers

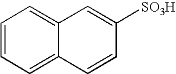

naphthalene-2-sulphonic acid

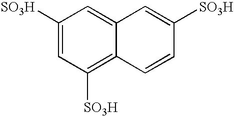

naphthalene-trisulphonic acid, isomer mixture
e.g. naphthalene 1,3,6-trisulphonic acid

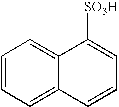

naphthalene-1-sulphonic acid

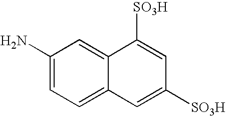

2-naphthylamine-6,8-disulphonic acid and isomers

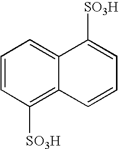

Naphthalene-1,5-disulphonlc acid and isomers

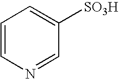

pyridine-3-sulphonic acid

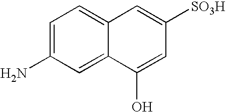

7-amino-1-naphthol-3-sulphonic acid

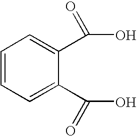 phthalic acid

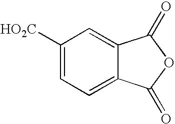

trimellitic acid anhydride

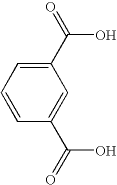

isophthalic acid

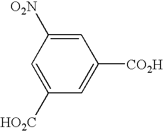

5-nitro-isophthalic acid

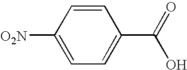

4-nitrobenzoic acid and isomers

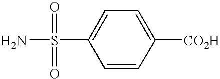

benzoic acid-4-sulphamide

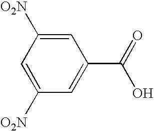

3,5-dinitrobenzoic acid and isomers

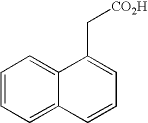

1-naphthylacetic acid

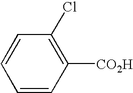

2-chlorobenzoic acid and isomers

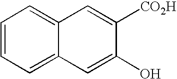

3-hydroxynaphthoic acid

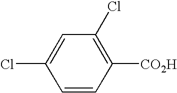

2,4-dichlorobenzoic acid and isomers

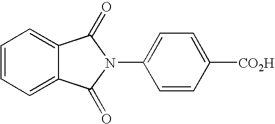

N-(4-carboxyphenyl)phthalimide

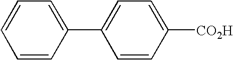

4-phenylbenzoic acid

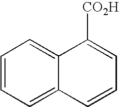

1-naphthoic acid

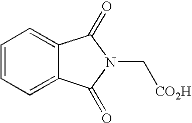

phthaloyl glycine

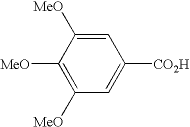

3,4,5-trimethoxybenzoic acid

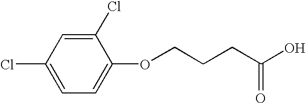

3-(2,4-dichlorophenoxy)butyric acid

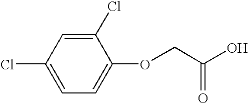

2,4-dichlorophenoxyacetic acid

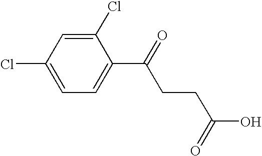

3-oxo-3-(2,4-dichlorophenyl)butyric acid

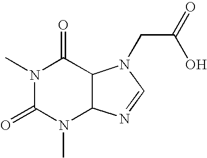

theophylline-7-acetic acid

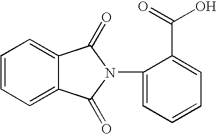

2-phthalimidobenzoic acid

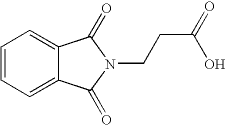

2-phthalimidopropanoic acid

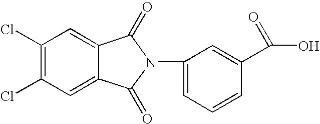

3-(4,5-dichlorophthaloylimido)benzoic acid

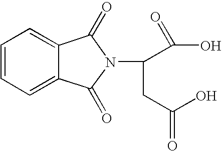

2-phthaloylimidosuccinic acid

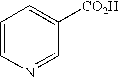

nicotinic acid

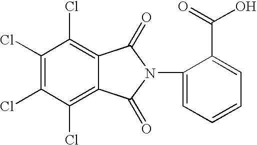

2-(3,4,5,6-tetrachlorophthaloylimido)benzoic acid

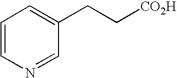

3-pyridinepropionic acid

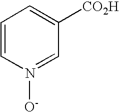

nicotinic acid N-oxide

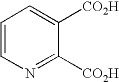

quinolinic acid

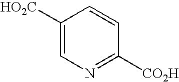

pyridine-2,5-dicarboxylic acid

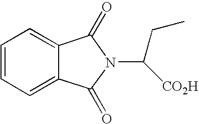

2-phthalimidobutyric acid

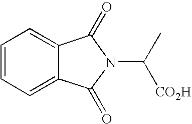

2-phthalimidopropionic acid

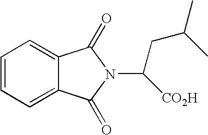

4-methyl-2-phthalimidovaleric acid

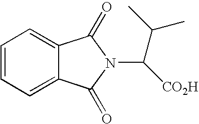

2-phthalimidoisovaleric acid

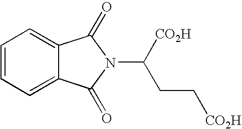

2-phthalimldoglutaric acid

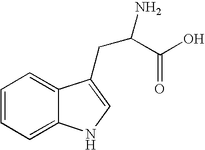

Tryptophane

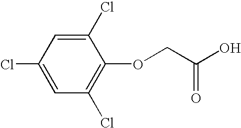

2,4,6-trichlorophenoxyacetic acid

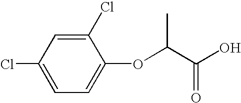

2-(2,4-dichlorophenoxy)-propionic acid

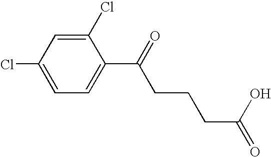

3-(2,4-dichlorobenzoyl)-butyric acid

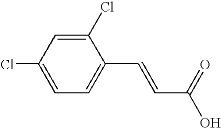

2,4-dichlorophenylacrylic acid

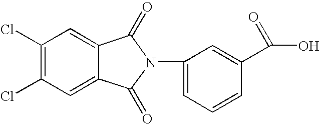

3-(4,5-dichlorophthalimido)-benzoic acid

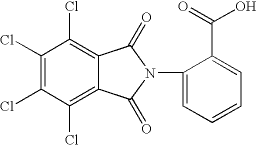

2-tetrachlorophthalimidobenzoic acid

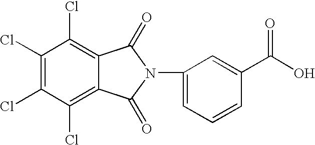

3-tetrachlorophthalimidobenzoic acid

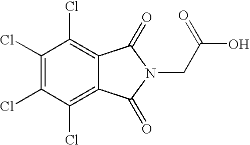

tetrachlorophthaloylglycine

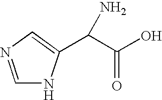

histidine

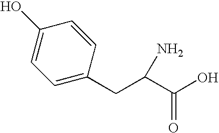

Tyrosine

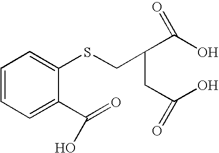

2-(2-carboxyphenylthiomethyl)succinic acid

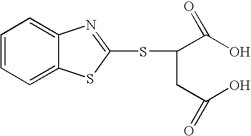

2-(2-benzothiazolylthio)succinic acid

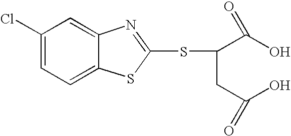

2-[2-(5-chlorobenzothiazolylthio)]succinic acid

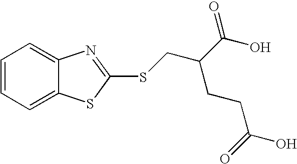

2-(2-benzothiazolylthio)succinic acid

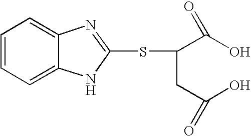

2-(2-benzimidazolylthio)succinic acid

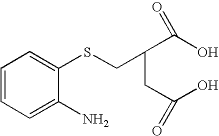

2-(2-aminophenylthiomethyl)succinic acid

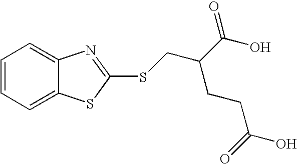

2-(2-benzimidazolylthio)valeric acid

The pigment dispersions are useful for a large variety of technical applications, e.g. for the preparation of inks or printing inks in printing processes, such as flexographics, screen, packaging, security ink, intaglio or offset printing, for pre-press stages and textile printing, for office, home or graphic applications, for paper goods, pens, felt tips, fibres tips, card, wood, (wood) stains, metal, inking pads, or inks for impact printing, (with impact-pressure ink ribbons), or for the preparation of colorants, for coatings, e.g. paints, for textile decoration and industrial marking, for roller coatings or powder coatings or for automotive finishes for high-solids, for low-solvent, water containing or metallic coating materials or for water-containing formulations, water-containing paints, or for the preparation of pigmented plastics, fibres, platters or mold carriers, or for pigmented radiation curable coatings, or for pigmented gel coats, laminates, composites, adhesives and casting resins, or for non-impact printing material, for digital printing, thermal wax transfer printing, ink-jet printing or thermal transfer printing, or for the preparation of colour filters, especially for visible light in the range from 400 to 700 nm, which can be used for the production of liquid crystal displays (LCD) or charge combined devices (CCD), for the preparation of cosmetics, toners, or polymeric ink particles for the preparation of toners, such as dry or liquid copy toners or electro photographic toners. The toners can be prepared in master batches and be used in turn in master batches for the preparation of coloured plastics.

According to an alternative embodiment of the invention the pigment dispersions are useful in colour filter systems, which are useful in electro-optical systems such as TV screens, liquid crystal displays, charge coupled devices, plasma displays or electro luminescent displays and the like.

There are several ways to manufacture these colour filters, which follow two mainstreams:
Direct patterning during applying;
Patterning after applying the pigment.

Direct patterning can be obtained by several printing techniques, such as impact (off-set, flexography, stamping, letterpress etc.) as well as non-impact (ink jet techniques).

Other direct patterning techniques are based on lamination processes, electronic discharging processes like electro-deposition and some special colour proofing methods, like the so-called Chromalin® process (DuPont).

The colour filters of the invention contain the pigment compositions of the invention judiciously in a concentration of from 1.0 to 75.0% by weight, preferably from 5.0 to 50.0% by weight, with particular preference from 25.0 to 40.0% by weight, based on the overall weight of the pigmented layer.

The invention therefore likewise provides a colour filter comprising a transparent substrate and a layer comprising from 1.0 to 75.0% by weight, preferably from 5.0 to 50.0% by weight, with particular preference from 25.0 to 40.0% by weight, based on the overall weight of the layer, of a pigment composition of the invention or the individual components of said composition dispersed in a high molecular mass organic material. The substrate is preferably essentially colourless (T≧95% all over the visible range from 400 to 700 nm).

The instant printing inks or photo resists for making colour filters contain the pigment compositions of the invention judiciously in a concentration of from 0.01 to 40.0% by weight, preferably from 1.0 to 25.0% by weight, with particular preference from 5.0 to 10.0% by weight, based on the overall weight of the printing ink or photo resist.

The invention therefore likewise provides a pigment dispersion for producing colour filters comprising from 0.01 to 40.0% by weight, preferably from 1.0 to 25.0% by weight, with particular preference from 5.0 to 10.0% by weight, based on the overall weight of the pigment dispersion.

Another embodiment of the invention relates to the use of the pigment dispersion defined above for preparing ink compositions or colour filters by applying the methods described above.

Another embodiment of the invention relates to the process for preparing the above-mentioned pigment dispersion, which comprises preparing the polymerisate (I) by copolymerising the polymer fragments I, II and III by the method of controlled or “living” polymerisation and optionally replacing or polymerising further one of the chain terminal groups A or B; and adding the polymerisate (I) to dispersible pigment particles and optionally binder materials, fillers or other conventional additives.

According to a preferred embodiment the process comprises the additional step of isolating the pigment and the polymerisate (I) and optionally additional conventional additives in a solid product form essentially free from liquid carrier medium.

According to the process mentioned above, the polymerisate (I) is added in pure form, optionally in combination with suitable additives, e.g. the acids mentioned above, as a solution or dispersion to dispersible pigment particles and optionally binder materials, fillers or other conventional additives.

In an alternative embodiment of the process the polymerisate (I) can be further processed and used in most cases without any further purification step. This is an important advantage when industrial scale-up is intended. The pigments are dispersed in the presence of the polymerisate (I) dispersant by using conventional techniques, such as high speed mixing, ball milling, sand grinding, attritor grinding or two or three roll milling. The resulting pigment dispersion may have a pigment to dispersant binder weight ratio of about 0.1:100 to 1500:100.

The organic solvents present in the dispersion are mentioned above, cf. process, and preferably are commonly used solvents in coatings technology. For water based coatings applications, aside from water, preferably polar, water-miscible solvents, such as C₁-C₄alkohols, e.g. methanol, ethanol, or isopropanol, glycol ethers like butyl glycol, or methoxypropylene glycol, polyols, e.g. glycerol, or ethylene, diethylene, triethylene, triethylene or propylene glycol are used. For solvent based coating systems, preferably less polar solvents like aliphatic hydrocarbons, esters like butyl acetate, or glycol ethers like methoxypropylene glycol or glycol ether esters like methoxypropylene glycol acetate are used.

In another preferred embodiment of the process fine pigment dispersions are prepared by mixing the pigments with a solution of the polymerisate (I) or an aqueous emulsion of the polymerisate (I), concentrating the resulting mixture by distilling off the solvents and/or water, preferably to dryness, and optionally further subjecting the resulting concentrate to thermal and/or mechanical treatment to prepare a mixture comprising pigments and the polymerisate (I), which may then be subsequently dispersed in aqueous and/or organic solvents. According to this process, the solid composition of pigment and the polymerisate (I) is easy to disperse and does not require any time and energy intensive grinding to be incorporated into e.g. a paint formulation.

The above-mentioned methods for preparing the composition, such as high speed mixing, ball milling, sand grinding, attritor grinding or two or three roll milling may in the alternative be employed when preparing the dispersion.

The present invention also relates to the use of the pigment dispersion described above for preparing coating compositions, prints, images, inks, lacquers, pigmented plastics, adhesives, casting resins, filled composites, glass fibre reinforced composites, laminates, cement based construction materials like plaster and tile adhesives.

Likewise of particular interest is a specific embodiment of the above-mentioned process for preparing the dispersion, wherein coating compositions, for example paints, are prepared. The invention therefore also relates to compositions, wherein film-forming binders for coatings are added to the composition comprising components a) and b) described above.

The novel coating composition preferably comprises 0.01-100.0 parts by weight of the combined components a) and b) in the composition, in particular 0.05-50.0 parts, especially 0.1-20.0 parts, per 100 parts by weight of solid binder.

Suitable binders are the ones customarily used, for example the ones described in Ullmann's Encyclopedia of Industrial Chemistry, 5th Edition, Vol. A18, pp. 368-426, VCH, Weinheim 1991, Germany. In general, the film-forming binder is based on a thermoplastic or thermosetting resin, predominantly on a thermosetting resin. Examples thereof are alkyd, acrylic, polyester, phenolic, melamine, epoxy and polyurethane resins and mixtures thereof. Also resins curable by radiation or air-drying resins can be used.

Binders that may be used are any cold- or hot-curable binders. The addition of a curing catalyst may be advantageous. Suitable catalysts that accelerate the curing of binders are described, for example, in Ullmann's, Vol. A18, loc. cit., p. 469.

Preference is given to coating compositions comprising a functional acrylate resin and a cross linking agent. Examples of coating compositions containing specific binders are:
Paints based on cold- or hot-cross linkable alkyd, acrylate, polyester, epoxy or melamine resins or mixtures of such resins, if desired with addition of a curing catalyst;
Two-component polyurethane paints based on hydroxyl-containing acrylate, polyester or polyether resins and aliphatic or aromatic isocyanates, isocyanurates or polyisocyanates;
One-component polyurethane paints based on blocked isocyanates, isocyanurates or polyisocyanates which are de-blocked during baking, if desired with addition of a melamine resin;
One-component polyurethane paints based on a trisalkoxycarbonyl triazine cross linker and a hydroxyl group containing resin, such as acrylate, polyester or polyether resins;
One-component polyurethane paints based on aliphatic or aromatic urethane acrylates or polyurethane acrylates having free amino groups within the urethane structure and melamine resins or polyether resins, if necessary with curing catalyst;
Two-component paints based on (poly)ketimines and aliphatic or aromatic isocyanates, isocyanurates or polyisocyanates;
Two-component paints based on (poly)ketimines and an unsaturated acrylate resin or a polyacetoacetate resin or a methacrylamidoglycolate methyl ester;
Two-component paints based on carboxyl- or amino-containing polyacrylates and polyepoxides;
Two-component paints based on acrylate resins containing anhydride groups and on a polyhydroxy or polyamino component;
Two-component paints based on acrylate-containing anhydrides and polyepoxides;
Two-component paints based on (poly) oxazolines and acrylate resins containing anhydride groups, or unsaturated acrylate resins, or aliphatic or aromatic isocyanates, isocyanurates or polyisocyanates;
Two-component paints based on unsaturated polyacrylates and polymalonates;
Thermoplastic polyacrylate paints based on thermoplastic acrylate resins or externally cross linking acrylate resins in combination with etherified melamine resins; and
Paint systems based on siloxane-modified or fluorine-modified acrylate resins.

In addition to the components mentioned above, the coating composition according to the invention comprises an additional light stabiliser of the sterically hindered amine type, the 2-(2-hydroxyphenyl)-1,3,5-triazine and/or the 2-hydroxyphenyl-2H-benzotriazole types. Further examples for light stabilisers of the 2-(2-hydroxyphenyl)-1,3,5-triazine type advantageously to be added can be found e.g. in the published patent literature, e.g. U.S. Pat. No. 4,679,956, EP-A434 608, U.S. Pat. No. 5,198,498, U.S. Pat. No. 5,322,868, U.S. Pat. No. 5,369,140, U.S. Pat. No. 5,298,067, WO-94/18278, EP-A-704 437, GB-A-2 297 091, WO-96/28437.

Apart from the components mentioned above, the coating composition can also comprise further components, examples being solvents, pigments, dyes, plasticisers, stabilisers, thixotropic agents, drying catalysts and/or levelling agents. Examples of possible components are those described in Ullmann's, Vol. A18, pp. 429-471.

Possible drying catalysts or curing catalysts are, for example, organometallic compounds, amines, amino-containing resins and/or phosphines. Examples of organometallic compounds are metal carboxylates, especially those of the metals Pb, Mn, Co, Zn, Zr or Cu, or metal chelates, especially those of the metals Al, Ti or Zr, or organometallic compounds, such as organotin compounds.

Examples of metal carboxylates are stearates of Pb, Mn or Zn, octanoates of Co, Zn or Cu, naphthenoates of Mn and Co or the corresponding linoleates, resinates or tallates.

Examples of metal chelates are aluminium, titanium or zirconium chelates of acetylacetone, ethyl acetylacetate, salicylaldehyde, salicylaldoxime, o-hydroxyacetophenone or ethyl tri-fluoroacetylacetate, and the alkoxides of these metals.

Examples of organotin compounds are dibutyltin oxide, dibutyltin dilaurate or dibutyltin dioctanoate.

Examples of amines are, in particular, tertiary amines, for example tri-n-butylamine, triethanolamine, N-methyldiethanolamine, N-dimethylethanolamine, N-ethylmorpholine, N-methylmorpholine or diazabicyclooctane (triethylenediamine) and salts thereof. Further examples are quaternary ammonium salts, for example trimethylbenzyl ammonium chloride.

Amino-containing resins function simultaneously as binder and curing catalyst. Examples thereof are amino-containing acrylate copolymers.

The curing catalyst used can also be a phosphine, for example triphenylphosphine.

The novel coating compositions include radiation-curable coating compositions. In this case, the binder essentially comprises monomeric or oligomeric compounds containing ethylenically unsaturated bonds, which after application are cured by actinic radiation, i.e. converted into a crosslinked, high molecular weight form. Where the system is UV-curing, it generally contains a photoinitiator as well. Corresponding systems are described in the above-mentioned publication Ullmann's, Vol. A18, pp. 451-453. In radiation-curable coating compositions, the novel stabilisers can also be employed without the addition of sterically hindered amines.

The coating compositions according to the invention can be applied to any desired substrates, for example to metal, wood, plastic or ceramic materials. They are preferably used as base coats in the finishing of automobiles. If the topcoat comprises two layers, of which the lower layer is pigmented and the upper layer is not pigmented, the novel compositions can be used preferably for the lower layer.

The novel coating compositions can be applied to the substrates by the customary methods, for example by brushing, spraying, pouring, dipping or electrophoresis; see also Ullmann's, Vol. A18, pp. 491-500.

Depending on the binder system, the coatings can be cured at room temperature or by heating. The coatings are preferably cured at 50-150° C., and in the case of powder coatings or coil coatings even at higher temperatures.

The coating compositions can comprise an organic solvent or solvent mixture in which the binder is soluble. The coating composition can otherwise be an aqueous solution or dispersion. The vehicle can also be a mixture of organic solvent and water. The coating composition may be high-solids paint or can be solvent-free (e.g. a powder coating material). Powder coatings are, for example, those described in Ullmann's, A18, pp. 438-444. The powder coating material may also have the form of a powder-slurry (dispersion of the powder preferably in water).

The above-mentioned coating compositions or disperse systems may additionally contain further additives, such as calcium carbonate, clays, bentonites, silicates, glass fibres, glass beads, talc, kaolin, mica, barium sulphate, metal oxides and hydroxides, carbon black, graphite, wood powders, powders and fibres of other natural products, synthetic fibres, plasticisers, lubricants, emulsifiers, pigments, rheology additives, catalysts, flow auxiliaries, optical brighteners, flame retardants, or antistatic or blowing agents.

The following examples illustrate the invention:

¹H-NMR spectra: 400 MHz in CDCl₃; DOWANOL: Dowanol®

Abbreviations

¹H-NMR spectra: 400 MHz in CDCl₃,

DOWANOL: Dowanol®-PM=1-Methoxy-2-propanol

Amberlist: Amberlist® 15 cationic ion ex-change resin (CAS: 9037-24-5)

Abbreviations

GPC: Gel Permeation Chromatography; Columns: Polymer Laboratories: PL-Gel 5 u (300×75 mm), THF (solvent), Polystyrene-Standard, Refractive Index-Detector

Mn=Number Average Molecular Weight: Mn=(nᵢ·mᵢ)/nᵢ; Definition see also J. M. G. Cowie “Chemie und Physik der Polymeren” pg 7-9 (Verlag Chemie Weinheim—New York 1976; ISBN 3-527-25666-0)

D=P_{D}: Polydispersity index=Mw/Mn; Mw=(nᵢ·mᵢ²)(nᵢ·mᵢ) Definition see also J. M. G. Cowie “Chemie und Physik der Polymeren” loc. cit.

Dₚ=degree of polymerisation: Dₚ=Pₙ=Mₙ/M number of monomer units incorporated into polymer chain. Definition see also J. M. G. Cowie “Chemie und Physik der Polymeren” loc. cit.

PMDETA: Pentamethyldiethylenetriamine

RT: room temperature

BMA: methacrylic acid n-butyl ester

BA: n-butyl acrylate

DMAEA: 2-dimethylaminoethylacrylate

mp: melting point

U.S.: U.S. Patent Specification

### EXAMPLE 1

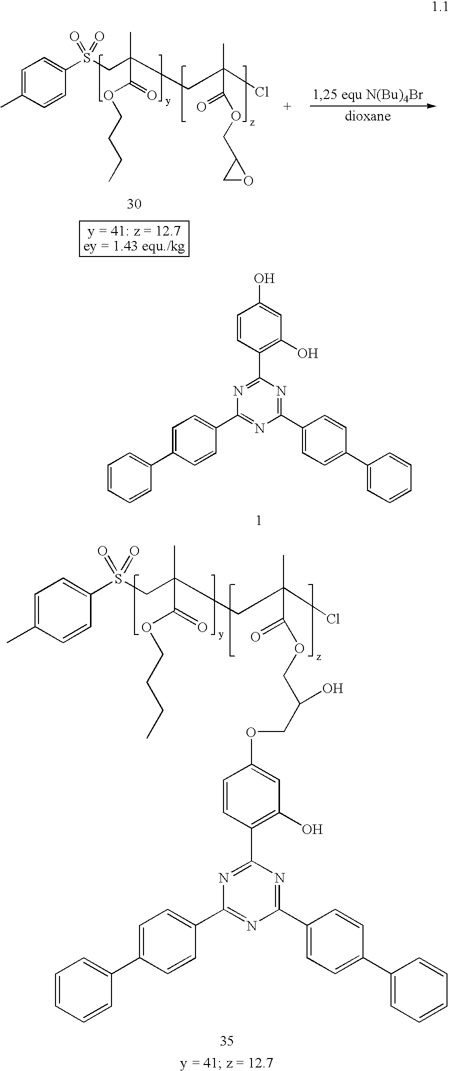

10.08 g (14.3 mmol) 30 and 7.06 g (14.3 mmol) 1 are dissolved in 50 ml dioxane. 0.5 g N(Bu)₄Br is added to this solution, and the reaction mixture is heated up to a reaction temperature of 100° C. until the epoxy value of the reaction mixture approaches zero. Toluene is added and the organic phase is washed with water (content of 1% EDTA). The organic phase is dried over MgSO₄, and the solvent is distilled off. The functionalised pigment dispersant 35 is obtained as a slightly yellow resin.

GPC: Mn: 10 800 g/mol, D: 1.36; ¹H-NMR: Dp(BA): 41, Dp (BBT): 12.7;

λₘₐₓ(CHCl₃): 317 nm, ε: 56 000 l mol²cm¹.
1.2 Preparation of Starting Materials

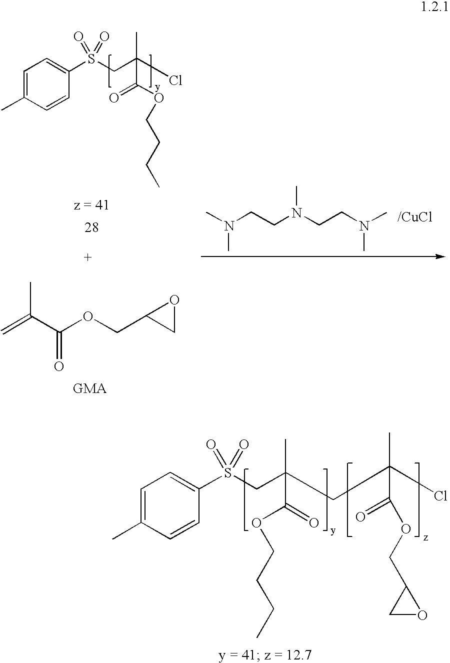

5.93 g (0.06 mol) CuCl are suspended in 600.0 g (0.1 mol) 28 dissolved in 400 ml dioxane. A solution of 170.6 g (1.2 mol) glycidyl methacrylic acid ester (GMA) is slowly added. The temperature is maintained at 20-25° C. by cooling with of an ice bath. After adding 10.4 g (0.06 mol) PMDETA the green coloured suspension turns immediately in a slightly exothermic reaction to a dark green solution. By avoiding an exothermic reaction the reaction mixture is slowly heated up to a reaction temperature of 80-90° C. After 40 min. reaction time the highly viscous mixture is cooled to RT and additional 1.0 kg dioxane is added. 200.0 g Al₂O₃ is added to the green coloured solution, and the product mixture is stirred for 1 h at RT. The blue coloured Al₂O₃ is filtered off, and the product solution becomes colourless. The procedure is repeated to eliminate all Cu-II-traces left in the reaction mixture. After distilling off the dioxane and the unreacted GMA, the AB-diblock-copolymer 30 is obtained.

GPC: Mn: 9000 g/mol, D: 1.23; ¹H-NMR: Dp(BA): 41, Dp (GMA): 12.7.

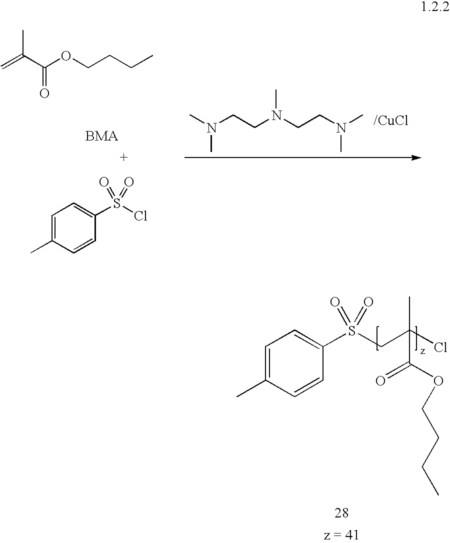

8.9 g (0.09 mol) CuCl are suspended in 700.0 g (4.9 mol) BMA. After adding 15.6 g (0.09 mol) PMDETA the green coloured suspension turns immediately into a dark green solution. A solution of 28.6 g (0.15 mol) toluene sulphonic acid chloride, dissolved in 100.0 g BMA, is slowly added, while the temperature is maintained at 20-25° C. by cooling with an ice bath. By avoiding an exothermic reaction the reaction mixture is slowly heated to a reaction temperature of 70-80° C. After 50 min. reaction time the highly viscous mixture is cooled to RT and additional 1 kg dioxane is added. 200.0 g Al₂O₃ is added to the green coloured solution, and the product mixture is stirred for 1 h at RT. The blue coloured Al₂O₃ is filtered off, and the product solution becomes colourless. The procedure is repeated to eliminate all Cu-II-traces left in the reaction mixture. After distilling off the dioxane and the unreacted BMA monomer, the A-block poly butyl methacrylate 28 is obtained.

GPC: Mn: 5700 g/mol, D: 1.23; ¹H-NMR: Dp: 41.

1.2.3 The starting material 1 is prepared according to the method as described in U.S. Pat. No. 6,255,483.

### EXAMPLE 2

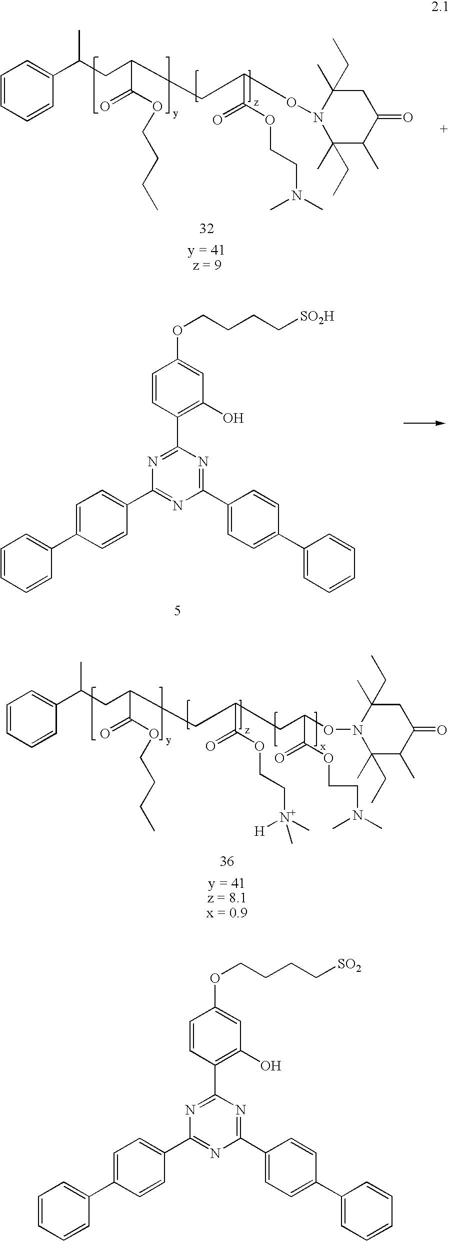

7.08 g (11.25 mmol) 5 are dissolved in 26 ml DOWANOL and heated up to reflux temperature until a clear solution of the sulphonic acid is obtained. 10.0 g (1.39 mmol) 32, dissolved in 14 ml DOWANOL is added slowly to the sulphonic acid solution. The reaction mixture is maintained at a reaction temperature of 100° C. until all of 5 have reacted with polymer 32. After 3 h reaction time the clear solution is filtered and by cooling down the solution containing product 36 is transformed to a stable, pale yellow coloured dispersion.

GPC: Mn: 5900 g/mol, D: 1.38; ¹H-NMR: Dp(BA): 41, Dp (DMAEA-LS): 8.1; λₘₐₓ(CHCl₃): 316 nm, ε: 48 300 l mol⁻¹ cm⁻¹.
2.2 Preparation of Starting Materials

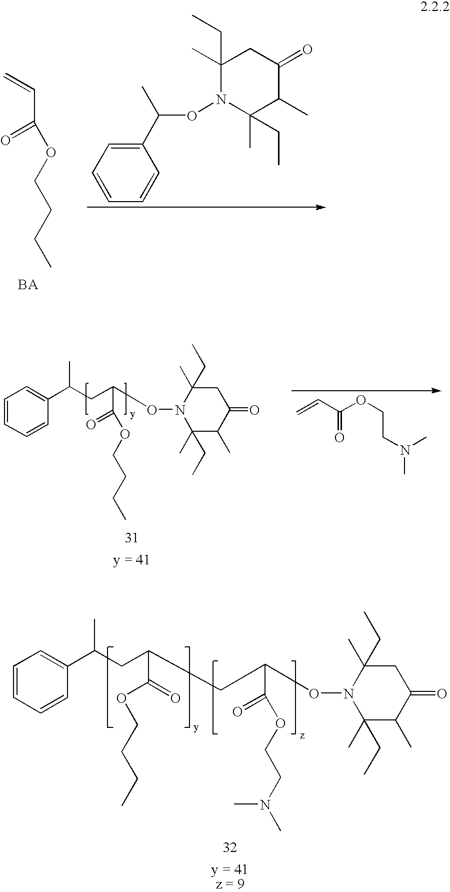

150.0 g (1.17 mol) BA and 70.6 g 2,6-diethyl-2,6-dimethyl-4-oxo-1-(1-phenethoxy)-piperidine and 150 g DOWANOL are stirred for 60 min at a reaction temperature of 145° C. 1.35 kg (10.53 mol) BA are added slowly to the reaction mixture for a time period of 25 h. The temperature of the reaction mixture is then maintained for a time period of 5 h. The excess of BA is distilled off and 687.0 g poly-n-butylacrylate 31 is obtained as a slightly yellow coloured viscous liquid.

GPC: Mn: 5600 g/mol, D: 1.19; ¹H-NMR: Dp n(BA): 41.

2.2.3

678.0 g (0.12 mol) Poly-n-butylacrylate and 678.0 g (4.76 mol) DMAEA are heated together for a time period of 2 h at a reaction temperature of 145° C. The reaction mixture is cooled to RT and the excess of unreacted dimethylaminoethylacrylate is removed by distillation at a reaction temperature of 60-95° C. After cooling 838.0 g pigment dispersant 32 is obtained as a viscous slightly orange coloured oil.

GPC: Mn: 5800 g/mol, D: 1.38; ¹H-NMR: Dp n(BA): 41, Dp m(DMAEA): 9.

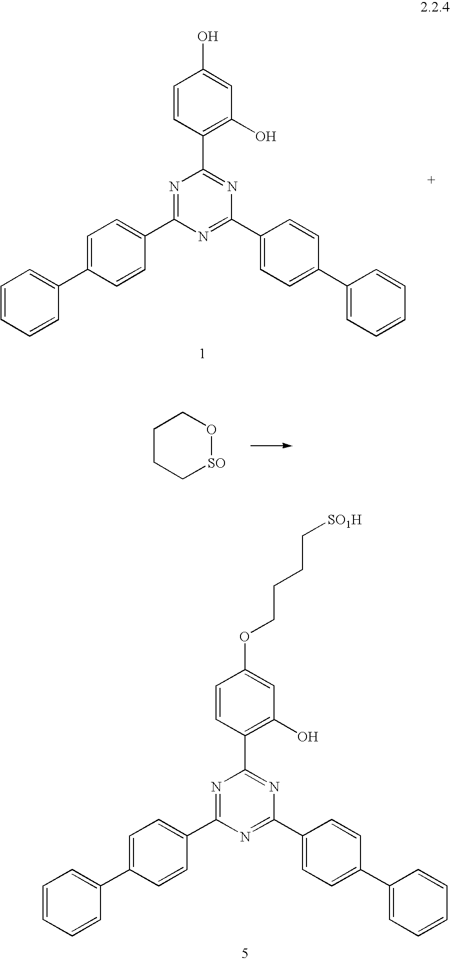

A mixture of 40.0 g (0.081 mol) 1 and 12.3 g (0.09 mol) K₂CO₃ are suspended in 300 ml DMF and heated up to a reaction temperature of 100° C. 12.14 g (0.09 mol)butane sultone dissolved in 50 ml DMF are added slowly over a time period of 1 h to the red solution. After stirring for 2 h the orange coloured suspension is cooled to a temperature of 50° C., and the precipitated potassium salt is filtered from the mother liquor. The solid product is recrystallised from ethanol/water (10:1). The potassium salt is converted into the free add 5 by filtering the potassium salt dissolved in 500 ml THF/H₂O (1:1) through an Amberlist® 15 ion ex-change resin; mp: 165-170° C.

### EXAMPLE 3

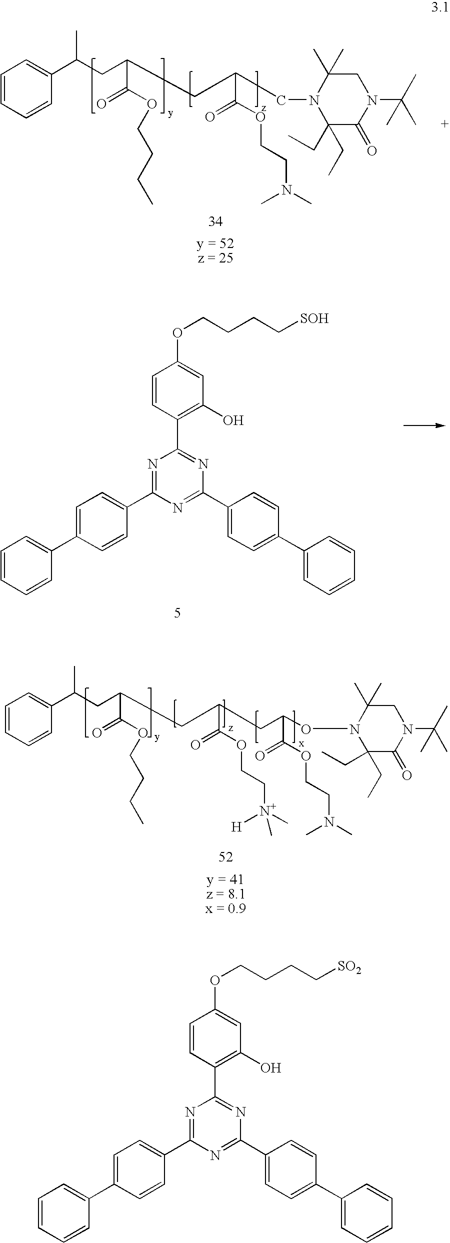

11.66 g (18.52 mmol) 5 are dissolved in 34 ml DOWANOL and heated up to reflux temperature until a clear solution of the sulphonic acid is obtained. 10.0 g (0.92 mmol) 34, dissolved in 17 ml DOWANOL are added slowly to the sulphonic acid solution. The reaction mixture is maintained at a reaction temperature of 117° C. until all of 5 have reacted with polymer 34. After 3 h reaction time the clear solution is filtered and by cooling down the solution containing product 52 is transformed to a stable, pale yellow coloured dispersion.

GPC: Mn: 7730 g/mol, D: 1.3; ¹H-NMR: Dp(BA): 52, Dp (DMAEA-LS): 20; λₘₐₓ(CHCl₃): 317 nm, ε: δ 750 l mol⁻¹ cm⁻¹.

3.2 Preparation of Starting Material

3.2.1

The synthesis of polymer dispersant 34 is described below in example 14.

### EXAMPLE 4

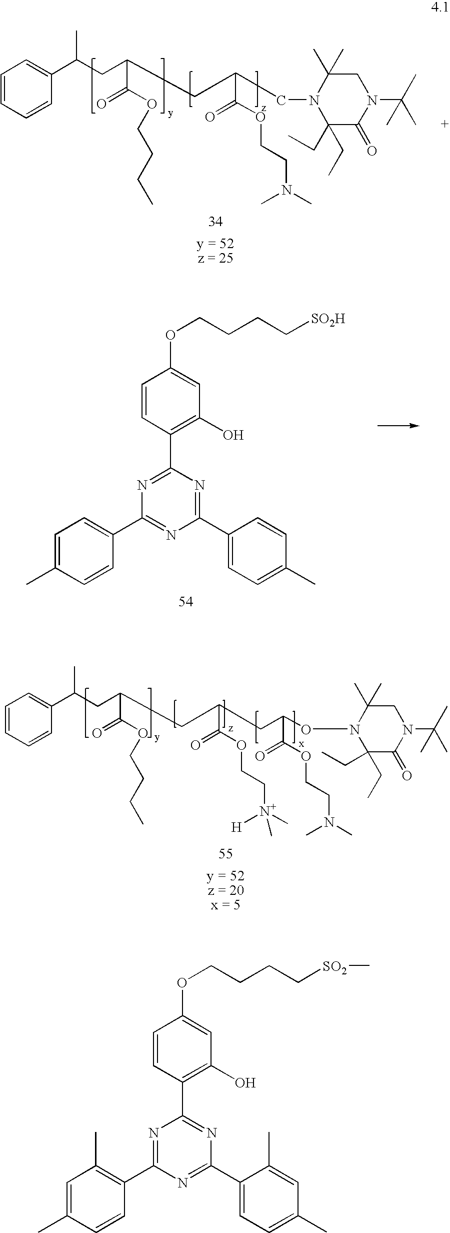

9.88 g (18.52 mmol) 54 are dissolved in 30 ml DOWANOL and heated up to reflux temperature until a clear solution of the sulphonic acid is obtained. 10.0 g (0.92 mmol) 34, dissolved in 15 ml DOWANOL are added slowly to the sulphonic acid solution. The reaction mixture is maintained at a reaction temperature of 100° C. until all of 54 have reacted with polymer 34. After 3 h reaction time the clear solution is filtered and by cooling down the solution containing product 55 is transformed to a stable, pale yellow coloured dispersion.

GPC: Mn: 5820 g/mol, D: 1.58; ¹H-NMR: Dp(BA): 52, Dp (DMAEA-LS): 20; λₘₐₓ(CHCl₃): 291 nm, ε: 21 000 l mol¹ cm¹.
4.2 Preparation of Starting Material

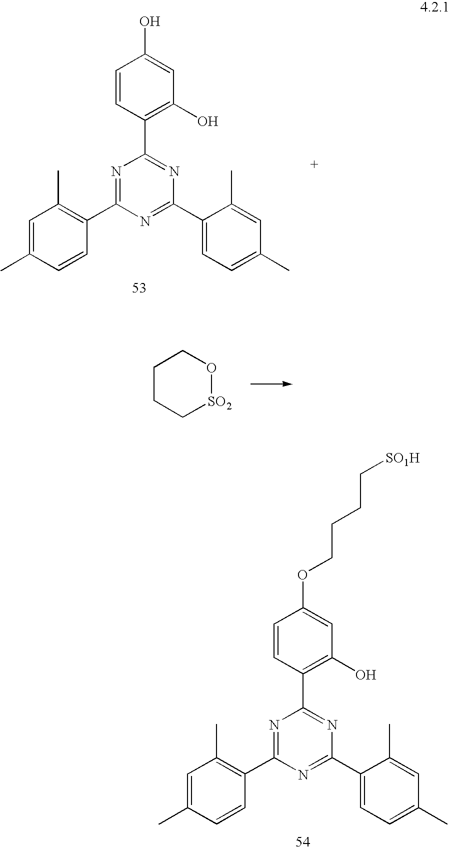

A mixture of 40.0 g (0.1 mol) 53 and 15.3 g (0.11 mol) K₂CO₃ are suspended In 300 ml DMF and heated up to a reaction temperature of 100° C. 15.07 g (0.11 mol)butane sultone dissolved in 50 ml DMF are added slowly over a time period of 1 h to the red solution. After stirring for 2 h the orange coloured suspension is cooled to a temperature of 50° C., and the precipitated potassium salt is filtered from the mother liquor. The solid product is recrystallised from dioxane/water (10:1). The potassium salt is converted into the free acid 54 by filtering the potassium salt dissolved in 500 ml THF/H₂O (1:1) through an Amberlist® 15 ion ex-change resin; mp: 157-161° C.

4.2.2

The starting material 53 is prepared according to the method as described in EP 779280.

### EXAMPLE 5

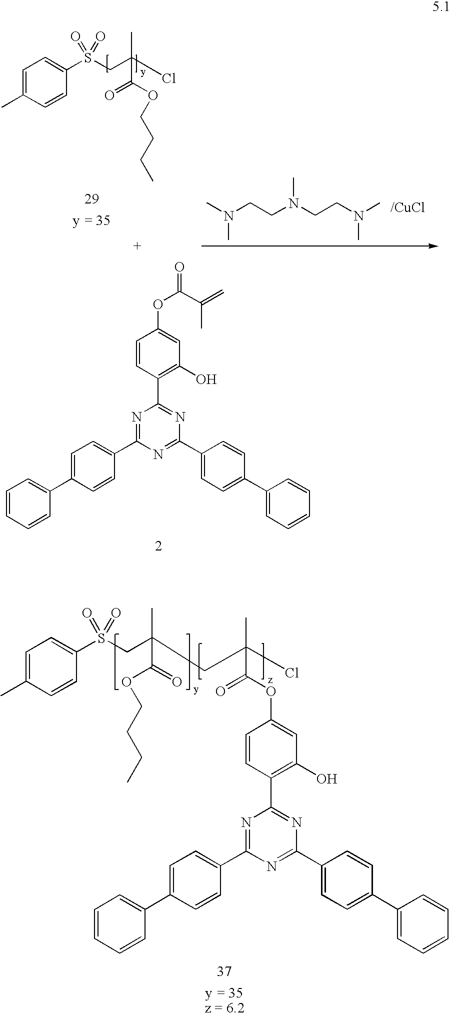

6.3 g (1.23 mmol) 29 and 6.89 g 2 (12.3 mmol) are dissolved in 15 ml dioxane. 121.0 mg (1.23 mmol) CuCl is added to the clear solution, and the reaction mixture is stirred at RT. 233.0 mg PMDETA is added to the green suspension, which turns to a dark green solution, which is slowly heated up to a reaction temperature of 90° C. After 4 h reaction time the viscous mixture is cooled to RT and diluted with 100 ml dioxane. 15.0 g Al₂O₃ is added to the green coloured solution, and the product mixture is stirred for 1 h at RT. The blue coloured Al₂O₃ is filtered off, and the product solution becomes colourless. The procedure is repeated to eliminate all Cu-II-traces left in the reaction mixture. After distilling off the dioxane the functionalised AB-di-block-copolymer 37 is obtained as a slightly yellow coloured solid resin.

GPC: Mn: 11000 g/mol, D: 1.35; ¹H-NMR: Dp (BA): 35, Dp (BBT): 8.2; λₘₐₓ:318 nm, ε: 58300 l mol⁻¹ cm⁻¹.
5.2 Preparation of Starting Material

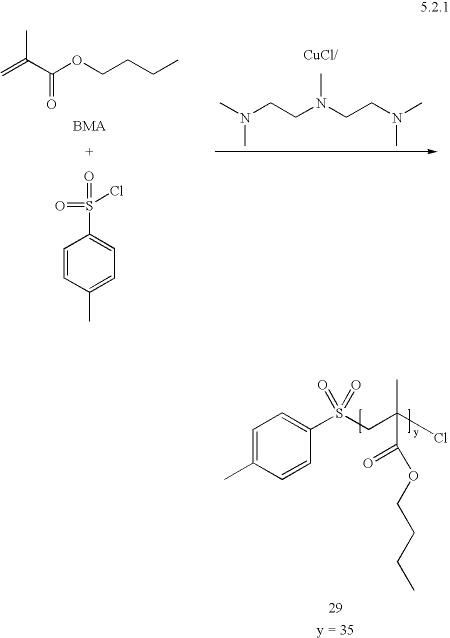

11.14 g (0.11 mol) CuCl are suspended in 1.0 kg (7.03 mol) BMA. After adding 19.5 g (0.11 mol) PMDETA the green coloured suspension turns immediately to a dark green solution. A solution of 35.75 g (0.19 mol) toluene sulphonic acid-chloride dissolved in 100.0 g dioxane is slowly added, while the temperature is maintained at 20-25° C. by cooling with an ice bath. By avoiding an exothermic reaction the reaction mixture is slowly heated up to a reaction temperature of 70-80° C. After 45 min. reaction time the highly viscous mixture is cooled to RT, and additional 500.0 g dioxane is added. 150.0 g Al₂O₃ is added to the green coloured solution, which is stirred for 1 h at RT. The blue coloured Al₂O₃ suspension is filtered off, and the product solution becomes colourless. The procedure is repeated to eliminate all Cu-II-traces left in the reaction mixture. After distilling off the dioxane and the unreacted BMA monomer, the A-block polybutyl acrylate 29 is obtained.

GPC: Mn: 6870 g/mol, D: 1.21; ¹H-NMR: Dp: 35.

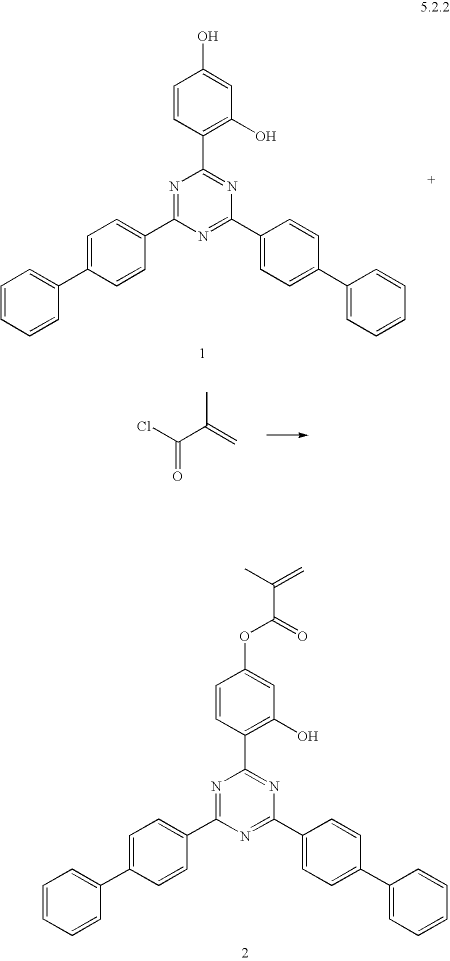

30.0 g (0.061 mol) 1 are dissolved in 450 ml THF and 6.74 g (0.067 mol) triethylamine are added. The reaction mixture is cooled to a reaction temperature of 15° C. 7.0 g (0.069 mol) methacrylic acid chloride is added drop wise during 70 min. The reaction mixture is maintained for additional 1.5 h at a reaction temperature of 10-15° C. and filtered off from the undissolved ammonium salt. The solvent is stripped off from the remaining clear solution, the residue is recrystallised from toluene, and the methacrylic ester 2 is obtained.

mp: 205° C.; λₘₐₓ (DMF): 325 nm, ε: 64 000 l mol⁻¹ cm⁻¹.

### EXAMPLE 6

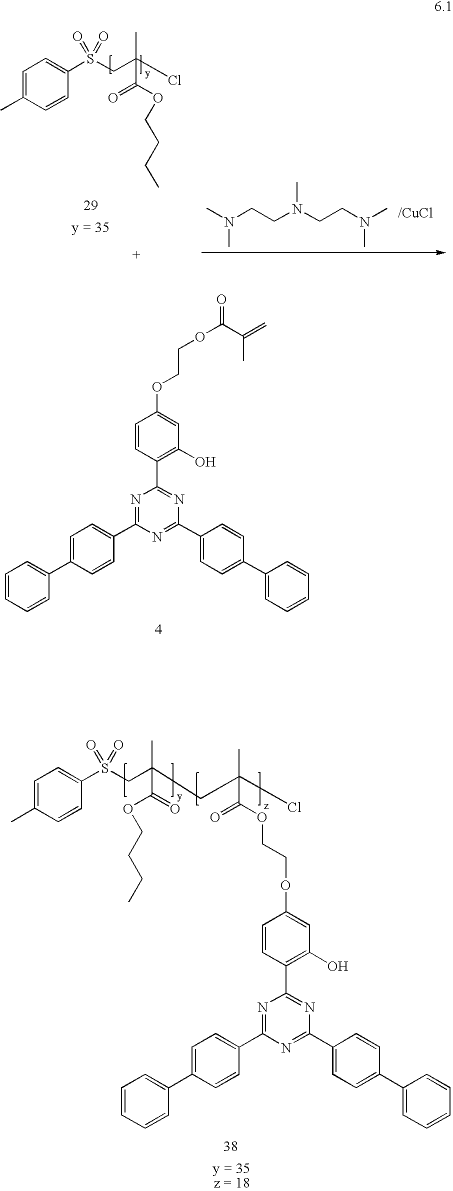

1.99 g (0.38 mmol) 29 and 4.7 g 4 (7.76 mmol) are dissolved in 15 ml dioxane. 38.0 mg (0.38 mmol) CuCl is added to the clear solution, and the reaction mixture is stirred at RT. 67.0 mg PMDETA is added to the clear solution, which turns into a dark green solution, and which is slowly heated up to a reaction temperature of 90° C. After 3 h reaction time the viscous mixture is cooled to RT and diluted with 100 ml dioxane. To the green coloured solution 10.0 g Al₂O₃ is added, and the product mixture is stirred for 1 h at RT. The blue coloured Al₂O₃ is filtered off, and the product solution becomes colourless. The procedure is repeated to eliminate all Cu-II-traces left in the reaction mixture. After distilling off the dioxane, the functionalised AB-diblock-copolymer 38 is obtained as a slightly yellow coloured solid resin.

GPC: Mn: 12 200 g/mol, D: 1.68; ¹H-NMR: Dp(BA): 35, Dp (4): 18; λₘₐₓ(CHCl₃): 315 nm, ε: 60 000 l mol⁻¹ cm⁻¹.
6.2 Preparation of Starting Material

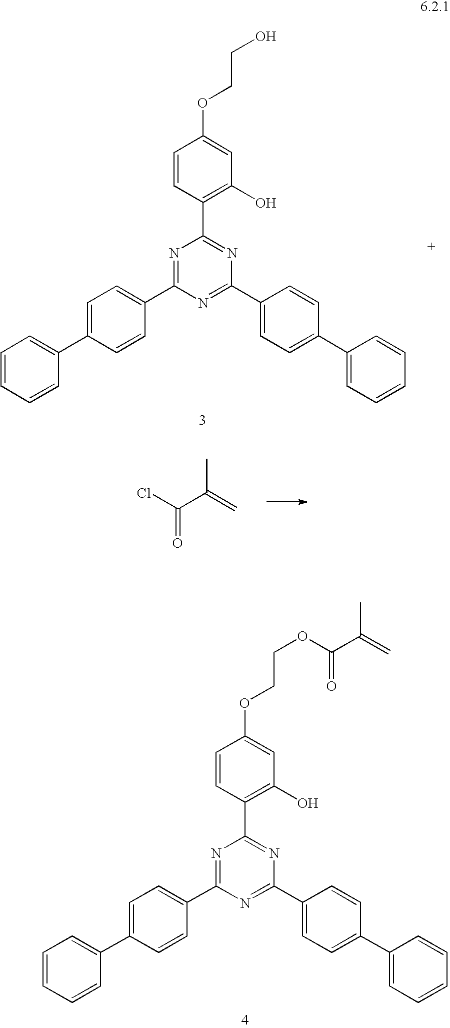

6.5 g (0.012 mol) 3 are dissolved in 100 ml THF, and 3.0 g (0.038 mol) pyridine are added. The reaction mixture is cooled to a reaction temperature of 0° C., and 3.9 g (0.037 mol) methacrylic acid chloride are added during 2 h. The reaction mixture is maintained at this temperature for additional 17 h and then filtered off from undissolved ammonium salt. The solvent is stripped off from the remaining clear solution, and the oily residue is filtered through a silica gel column with toluene as the eluant. The filtrate is recrystallised from ethyl acetate, and the methacrylic ester 4 is obtained.

mp: 186° C.; λₘₐₓ(CHCl₃): 340 nm, ε: 66 000 l mol⁻¹ cm⁻¹.

6.2.2

The starting material 3 is prepared according to the method as described in U.S. Pat. No. 5,869,588.

### EXAMPLE 7

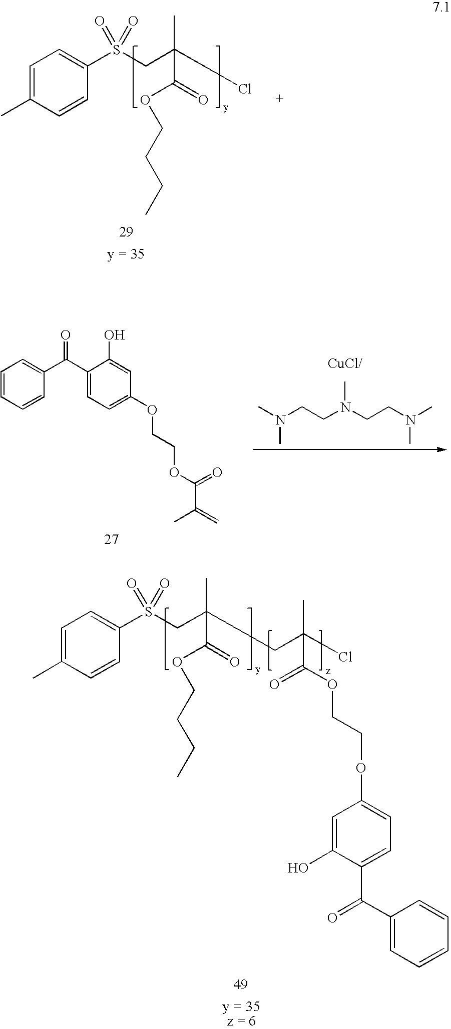

10.0 g (1.95 mmol) 29 and 5.1 g (15.6 mmol) 27 are dissolved in 10 ml dioxane. 198.0 mg (2 mmol) CuCl is added to this mixture, and the suspension is stirred at RT. 0.422 g (2.5 mmol) PMDETA is added to the slightly green coloured suspension. The suspension turns to a dark green solution, which is slowly heated to a reaction temperature of 85° C. and maintained at this temperature over night (15 h). The dark green coloured viscous solution is cooled to RT and diluted with 100 ml dioxane. To the green coloured solution 10.0 g Al₂O₃ is added, and the product mixture is stirred for 1 h at RT. The blue coloured Al₂O₃ is filtered off, and the product solution obtains a slightly yellow colouring. The procedure is repeated to eliminate all Cu-II-traces left in the reaction mixture. After distilling off the dioxane the functionalised AB-diblock-copolymer 49 is obtained as a yellow coloured resin.

GPC: Mn: 8000 g/mol, D: 1.35; ¹H-NMR: Dp (BA): 35, Dp (27): 6; λₘₐₓ(CHCl₃): 327 nm, ε: 8120 l mol⁻¹ cm⁻¹.
7.2 Preparation of Starting Material

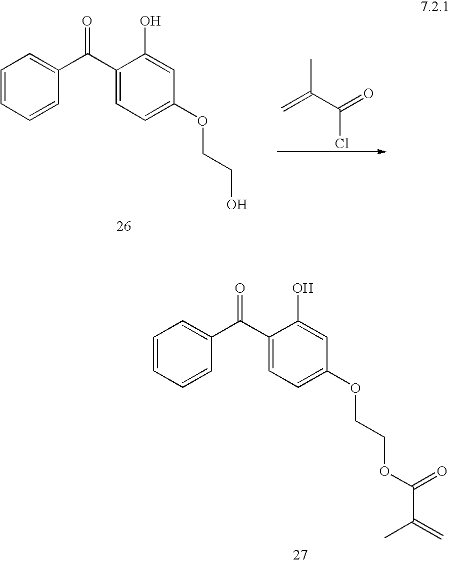

10.0 g (0.04 mol) 26 are dissolved in 70 ml THF at RT, and 5.2 g (0.05 mol) methacrylic acid chloride is added over a time period of 50 min. The reaction mixture is maintained for 24 h at a reaction temperature of 40° C., and additional 4.0 g (0.038 mol) methacrylic acid chloride is added. The reaction is stopped after additional 24 h. The reaction mixture is poured into 200 ml CH₂Cl₂ and washed with 50 ml water. The crude product is dissolved in ethanol and filtrated over an Al₂O₃-column (alkaline properties) in order to remove traces of methacrylic acid formed. The product 27 is obtained as slightly orange coloured viscous oil.

7.2.2

The starting material 26 is prepared according to the method as described in U.S. Pat. No. 3,086,988.

### EXAMPLE 8

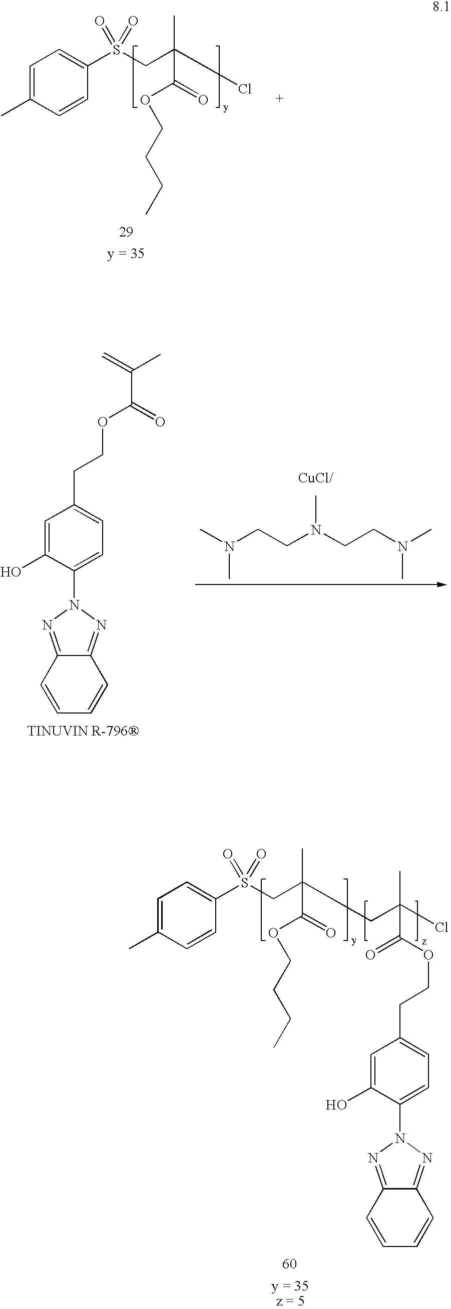

10.0 g (1.95 mmol) 29 and 3.15 g (9.75 mmol) TINUVIN R-796® are dissolved in 10 ml dioxane. 198.0 mg (2 mmol) CuCl is added to this mixture, and the suspension is stirred at RT. 0.422 g (2.5 mmol) PMDETA is added to the slightly green coloured suspension. The suspension turns to a dark green solution, which is slowly heated up to a reaction temperature of 85° C. and maintained at this temperature for 2.5 h. The dark green coloured viscous solution is then cooled to RT and diluted with 100 ml dioxane. To the green coloured solution 10.0 g Al₂O₃ is added, and the product mixture is stirred for 1 h at RT. The blue coloured Al₂O₃ is filtered off, and the product solution obtains a slightly orange colouring. The procedure is repeated to eliminate all Cu-II-traces left in the reaction mixture. After distilling off the dioxane the functionalised AB-diblock-copolymer 50 is obtained as an orange coloured resin.

GPC: Mn: 8740 g/mol, D: 1.57; ¹H-NMR: Dp(BA): 35, Dp (R-796®): 5; λₘₐₓ(CHCl₃): 339 nm, ε: 14 700 l mol⁻¹ cm⁻¹.

### EXAMPLE 9

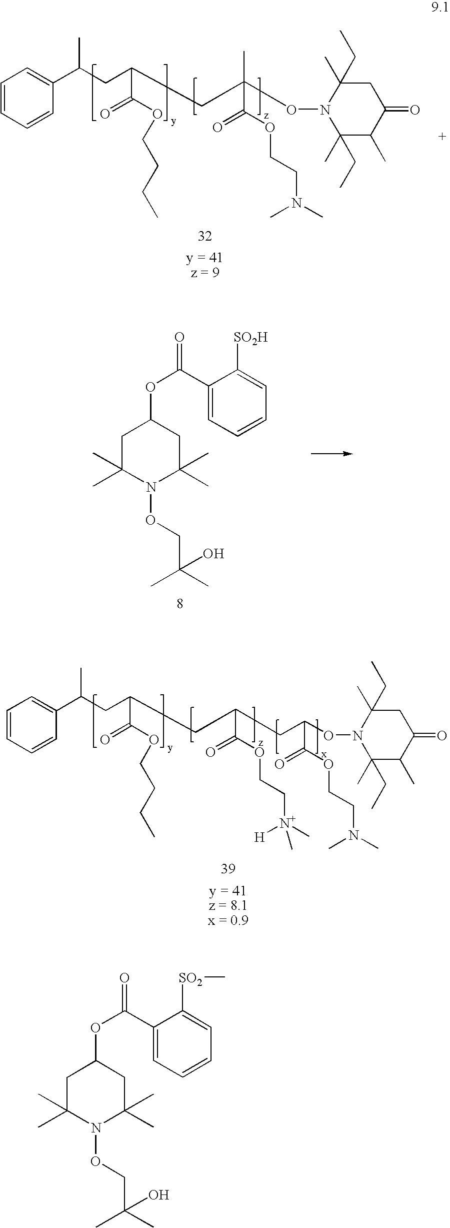

4.3 g (10 mmol) 8 and 9.0 g (1.25 mmol) 32 are added to 31 ml DOWANOL and heated up to a reaction temperature of 80° C., until a clear solution is obtained. The reaction mixture is maintained at a reaction temperature of 80° C. until all of 8 have reacted with the polymer 32. After 3 h reaction time, the clear solution is filtered and the functionalised dispersant 39 is obtained.

GPC: Mn: 5100 g/mol, D: 1.49; ¹H-NMR: Dp (BA): 41, Dp (DMAEA-LS): 8.1.
9.2 Preparation of Starting Material

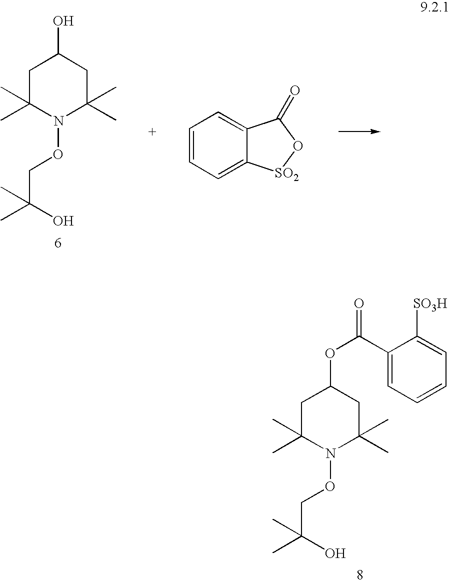

20.0 g (0.081 mol) 6 and 13.65 g (0.074 mol) 2-sulphobenzoic acid anhydride are dissolved in 100 ml dioxane and heated up to a reaction temperature of 70° C. After reacting 3 h at a reaction temperature of 70° C. the resulting suspension is heated up to a reaction temperature of 100° C. and additional 7.0 g (0.038 mol) 2-sulphobenzoic acid anhydride is added. After a total reaction time of 7 h the brown coloured suspension is cooled to RT, and the solid product is filtered from the mother liquor. The solid is partitioned between 200 ml ethyl acetate and 400 ml water, and the resulting suspension is agitated and heated up to a reaction temperature of 80° C. After 30 min. the remaining solid impurities are filtered off from the two-phase mixture, and the water phase is extracted twice with ethyl acetate. The water phase (pH: 1-2), which contains the product, is concentrated and the product crystallises by cooling down. Product 8 is obtained as colourless crystals (decomp: 284° C.).

9.2.2

The starting material 6 is prepared according to the method as described in U.S. Pat. No. 6,392,041.

### EXAMPLE 10

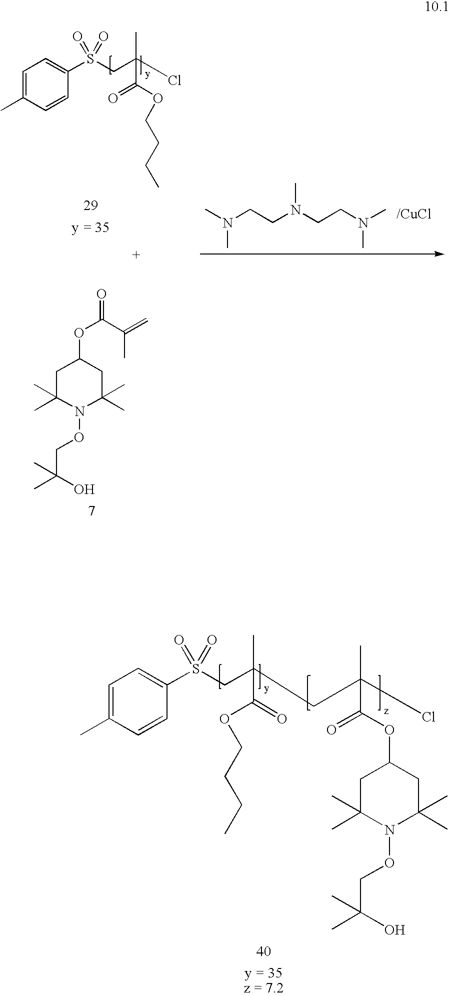

8.0 g (1.56 mmol) 29 and 4.96 g (15.8 mmol) 7 are dissolved in 5 ml dioxane. 150.0 mg (1.55 mmol) CuCl is added to the clear solution, and the reaction mixture is stirred at RT. 270.0 mg PMDETA is added to the green suspension, which turns to a dark green solution, and which is slowly heated up to a reaction temperature of 80° C. After 2.5 h reaction time the dark green coloured viscous mixture is cooled to RT and diluted with 100 ml dioxane. 12.0 g Al₂O₃ is added to the green coloured solution, and the product mixture is stirred for 1 h at RT. The blue coloured Al₂O₃ is filtered off and the product solution becomes colourless. The procedure is repeated to eliminate all Cu-II-traces left in the reaction mixture. After distilling off the dioxane and the residual unreacted monoacrylate 7 the functionalised AB-diblock-copolymer 40 is obtained as a colourless solid resin.

GPC: Mn: 11500 g/mol, D: 1.4, ¹H-NMR: Dp (BA): 35, Dp (7): 7.2.
10.2 Preparation of Starting Material

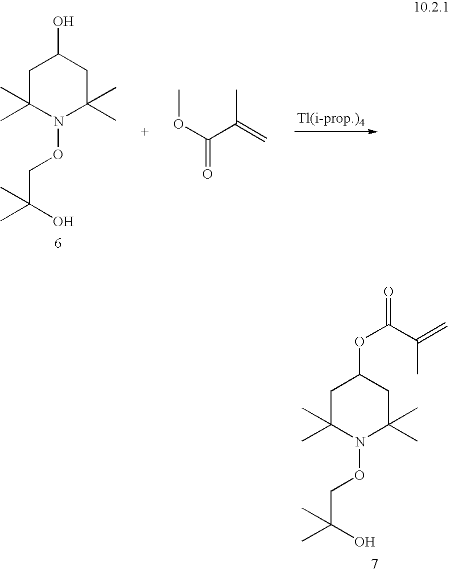

20.0 g (0.081 mol) 6 and 43.3 g (0.43 mol) methacrylic acid methyl ester are suspended in 100 ml heptane. To this suspension 0.98 g esterification catalyst tetraisopropyl-ortho-titanate is added. The colourless suspension is heated up to reflux temperature and methanol is distilled off. After a reaction time of 5 h no more methanol is distilling off, and the reaction mixture is cooled to RT. 150 ml ethyl acetate is added, and the yellow solution is treated with two portions of 15 ml 20% HCl and finally with 20 ml brine solution. After drying with magnesium sulphate the solvent is distilled off, and the resulting slightly yellow oil is eluted over a silica gel column with the solvent mixture hexane/ethyl acetate (ratio 4:1). Product 7 is obtained as slightly yellow oil.

### EXAMPLE 11

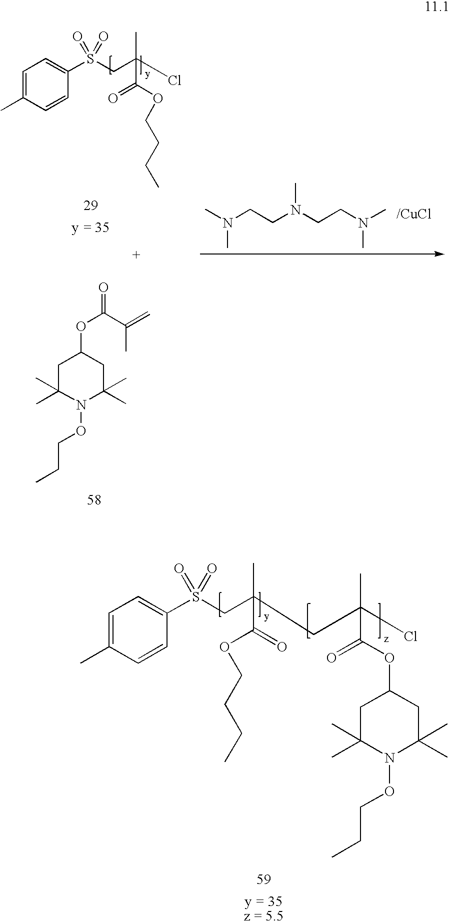

10.0 g (1.95 mmol) 29 and 2.76 g (9.75 mmol) 58 are dissolved in 10 ml DMF. 198.0 mg (2.0 mmol) CuCl is added to the clear solution, and the reaction mixture is stirred at RT. 422.0 mg PMDETA is added to the green suspension, which turns to a dark green solution, and which is slowly heated up to a reaction temperature of 85° C. After 2.5 h reaction time the dark green coloured viscous mixture is cooled to RT and diluted with 100 ml dioxane. 15.0 g Al₇O₃ is added to the green coloured solution, and the product mixture is stirred for 1 h at RT. The blue coloured Al₂O₃ is filtered off and the product solution becomes colourless. The procedure is repeated to eliminate all Cu-II-traces left in the reaction mixture. After distilling off the dioxane and the residual unreacted monoacrylate 58 the functionalised AB-diblock-copolymer 59 is obtained as a slightly yellowish coloured solid resin.

GPC: Mn: 8250 g/mol, D: 1.3, ¹H-NMR: Dp (BA): 35, Dp (58): 5.5.
11.2 Preparation of Starting Material

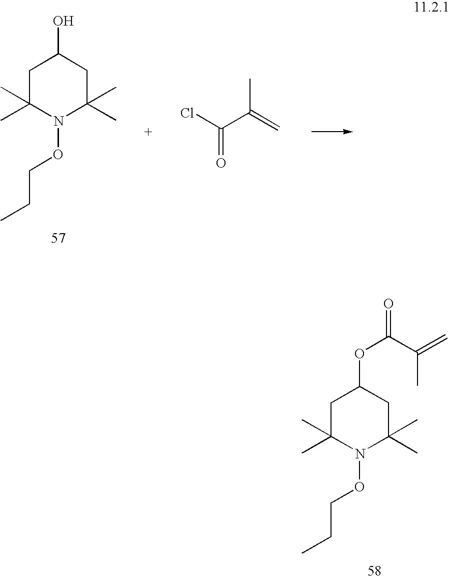

8.90 g (41.3 mmol) 57 is dissolved in 70 ml THF and cooled to a temperature of 0° C. 5.02 g (49.6 mmol) triethylamine is added to this solution. 8.18 g (78 mmol) methacrylic acid chloride is added drop wise to the reaction mixture over a time period of six hours. The reaction mixture is maintained at a temperature of 0° C. over night, warmed to RT and filtered from undissolved ammonium salt The solvent THF is stripped off from the remaining clear solution. The oily residue is dissolved in 100 ml CH₂Cl₂ and washed with water and brine solution. Product 58 is obtained as a slightly yellow coloured oil.

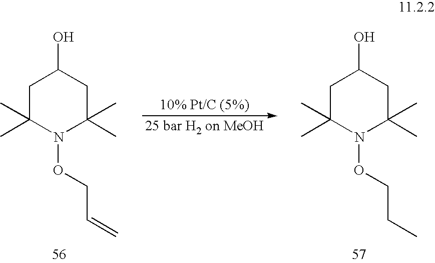

30 g (0.14 mol) 56 are dissolved in 60 ml methanol. 3 g of a hydrogenation catalyst (5% Pt adsorbed on char coal) is added to this solution. The black suspension is transferred into an autoclave reactor and put under 25 bar pressure with hydrogen gas. The reaction is finished after 12 hours at room temperature, the pressure is released and the product is filtered from the hydrogenation catalyst. Product 57 is obtained in quantitative yield in form of an orange coloured solid resin

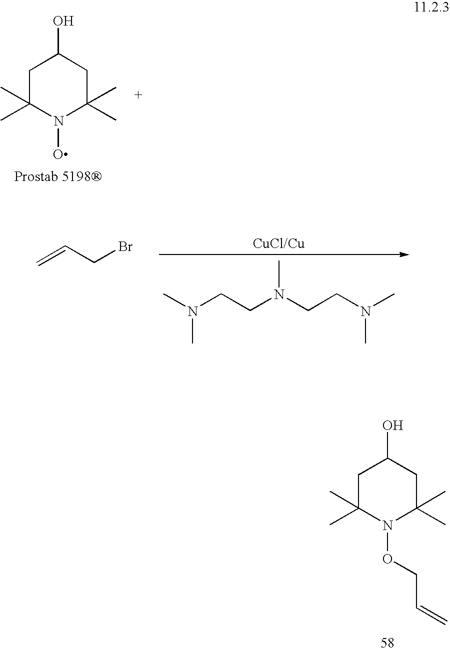

34.45 g (0.2 mol) Prostab 5198® and 20 g (0.2 mol) CuCl and 2.52 g (0.04 mol) powdered copper are dispersed in 200 ml toluene under dry and inert reaction conditions. 41.6 g (0.24 mol) PMDETA is added drop wise to this suspension. 36.3 g (0.3 mol) allyl bromide is added drop wise to the suspension over a time frame of 2 hours. The reaction is finished after 12 hours at room temperature and the reaction mixture is washed with 100 ml water. The copper residues are eliminated by addition of a 1% solution of EDTA® in water. The product is dried over MgSO₄ and 56 is obtained as colourless solid in 95% yield (mp: 63° C.).

### EXAMPLE 12

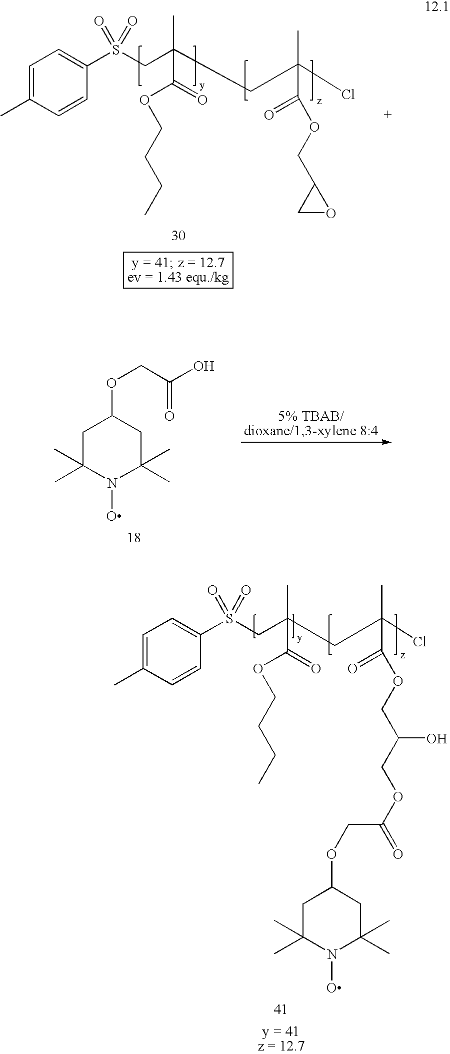

10.08 g (14.3 mmol) 30 are dissolved in 50 ml dioxane and 0.25 g tetrabutylammonium bromide. 3.54 g (14.3 mmol) 18 are added. The reaction mixture is heated up to a reaction temperature of 100° C. The epoxy value of the reaction mixture is monitored until it approaches zero. After finishing the reaction the polymeric product is added to toluene. After washing the organic phase with water, drying over MgSO₄, the solvent is distilled off. The functionalised pigment dispersant 41 is obtained as a red amorphous resin.

GPC: Mn: 10900 g/mol; ¹H-NMR: Dp (BA): 41, Dp (8): 12.7.
12.2 Preparation of Starting Material

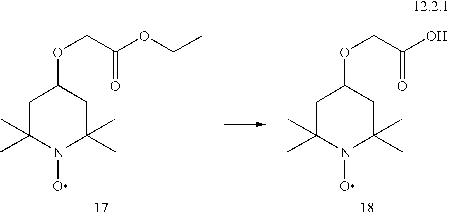

At R_{T} 50.0 g (0.19 mol) 17 are dissolved in a mixture of 700 ml methanol/water (1:1). The reaction mixture is heated up to a reaction temperature of 60° C. After 16 h methanol is distilled off from the reaction mixture and the remaining water phase is washed with ethyl acetate to eliminate impurities. The water phase is acidified with HCl solution (1%) until a pH of 4 is reached. The aqueous phase is extracted again with ethyl acetate, and the product is transferred into the organic phase. After washing the organic phase with water, the solvent is dried over magnesium sulphate and distilled off. Product 18 is obtained as deeply red-coloured oil.

12.2.2

The starting material 17 is prepared according to the method as described in U.S. Pat. No. 6,057,321.

### EXAMPLE 13

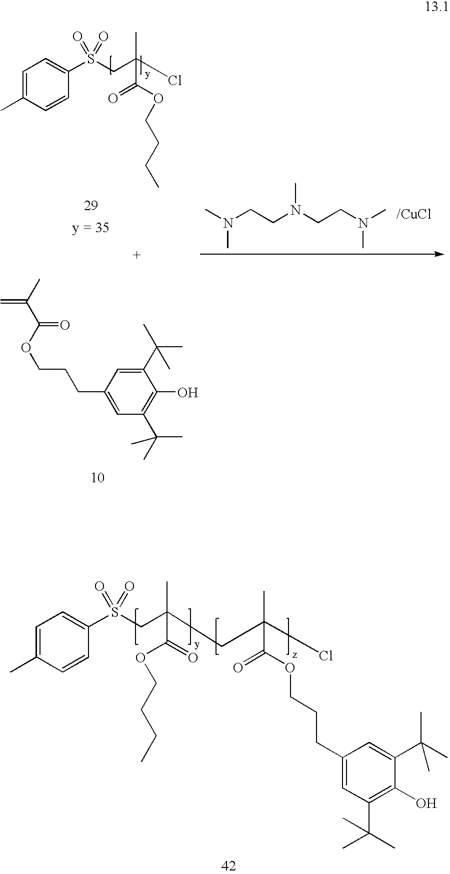 10.0 g (1.95 mmol) 29 and 4.86 g (14.6 mmol) 10 are dissolved in 8 ml dioxane. 0.43 g (2.5 mmol) PMDETA and then 198.0 mg (2 mmol) CuCl are added to the clear solution. The green suspension is stirred at RT and turns to a dark green solution, which is slowly heated up to a reaction temperature of 75° C. After 2 h reaction time the dark green coloured, viscous mixture is cooled to RT and diluted with 100 ml dioxane. 10.0 g Al₂O₃ is added to the green coloured solution, and the product mixture is stirred for 1 h at RT. The blue coloured Al₂O₃ is filtered off, and the product solution becomes colourless. The procedure is repeated to eliminate all Cu-II-traces left in the reaction mixture. After distilling off the dioxane the functionalised AB-diblock-copolymer 42 is obtained as a slightly yellow resin.

GPC: Mn: 9300 g/mol, D: 1.26; ¹H-NMR: Dp (BA): 35, Dp (10): 5.5.
13.2 Preparation of Starting Material

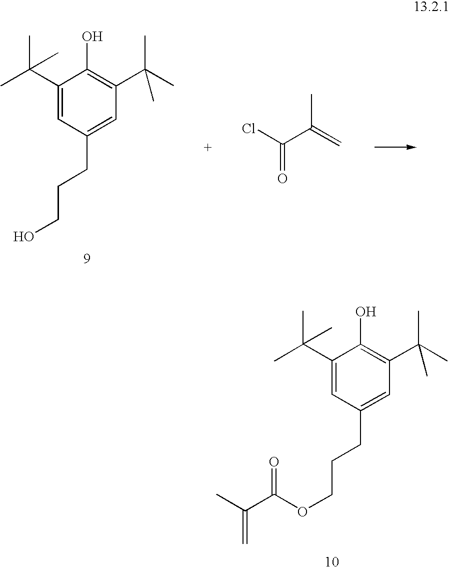

13.22 g (0.05 mol) 3-(3,5-di-tert-butyl-4-hydroxy-phenyl)-propanol 9 is dissolved in 100 ml THF and cooled to a reaction temperature of 0° C. 6.07 g (0.06 mol) triethylamine is added to this solution. 6.27 g (0.06 mol) methacrylic acid chloride is added drop wise to the reaction mixture over a time period of 30 min. The reaction mixture is maintained at a temperature of 0° C. over night, warmed to RT and filtered from undissolved ammonium salt. The THF is stripped off from the remaining clear solution. The oily residue is dissolved in 100 ml CH₂Cl₂ and washed with water and brine solution. Product 10 is obtained as a slightly orange coloured resin, mp: 56° C.

13.2.2

The starting material 9 is prepared according to the method as described in the published British Patent Application 1,355,109.

### EXAMPLE 14

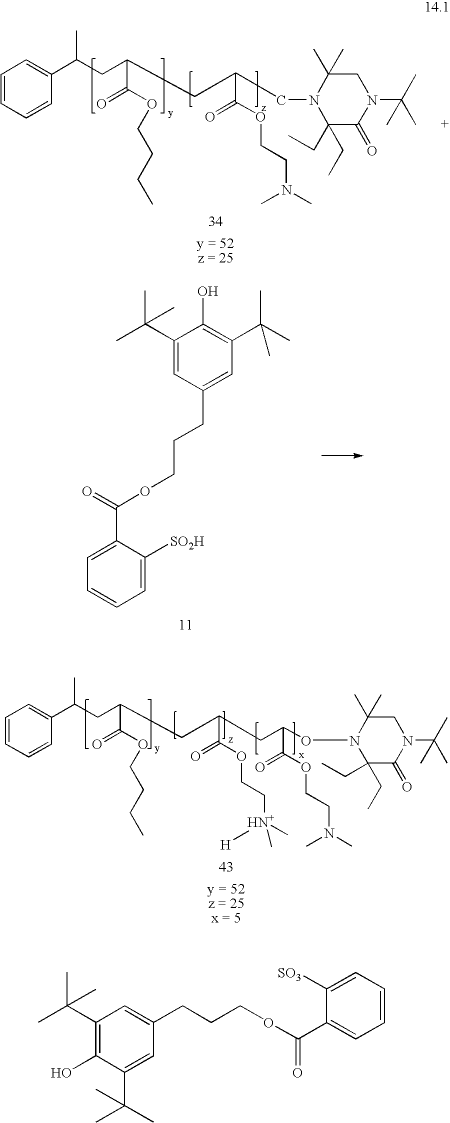

8.31 g (18.5 mmol) 11 are dissolved in 31 ml DOWANOL, and the clear brown solution is heated up to a reaction temperature of 90° C. 10.0 g (0.92 mmol) polymeric dispersant 34 is dissolved in 15.5 ml DOWANOL and added over a time period of 75 min to the reaction mixture, which is maintained at a reaction temperature of 90° C. until all of 11 has reacted with polymer 34. After 3 h reaction time the functionalised pigment dispersant 43 is obtained as a red coloured clear solution.

GPC: Mn: 7300 g/mol, D: 1.41; ¹H-NMR: Dp (BA): 52, Dp (DMAEA-LS): 20.
14.2 Preparation of Starting Material

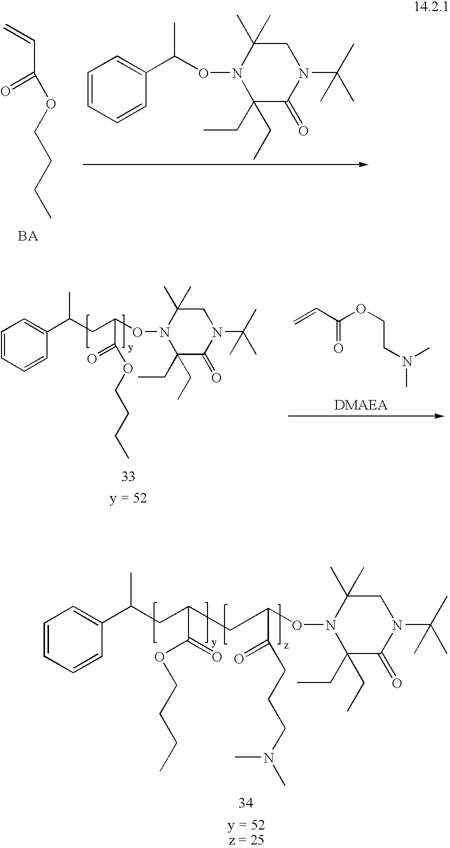

75.71 g (0.21 mol) 4-tert-butyl-2,6-diethyl-2,6-dimethyl-3-oxo-1-(1-phenethoxy)pyrazine, 1.4 mol BA and 5.1 g (0.02 mmol) 4-ter-butyl-2,6-diethyl-2,6-dimethyl-3-oxo-1-pyrazine are mixed at RT. The mixture is degassed three times and then slowly heated up to a reaction temperature of 142° C. The reaction is stopped after a time period of 5.5 h at this temperature. The excess amount of BA is distilled off and 33 is obtained as a slightly yellow coloured liquid.

GPC: (PS-Standard): Mn: 6900 g/mol, Pd: 1.25.

14.2.2

560.0 g (0.08 mol) 33 and 560.0 g (3.91 mol) DMAEA are heated together for a time period of 2 h and 15 min. at a reaction temperature of 145° C. The reaction mixture is cooled to RT, and the excess amount of unreacted DMAEA is removed by distillation at a reaction temperature of 60-95° C. After cooling down 34 is obtained as a viscous, slightly brown coloured oil.

GPC: Mn: 9740 g/mol, D: 1.75; ¹H-NMR: Dp n(BA): 52, Dp m(DMAEA): 25.

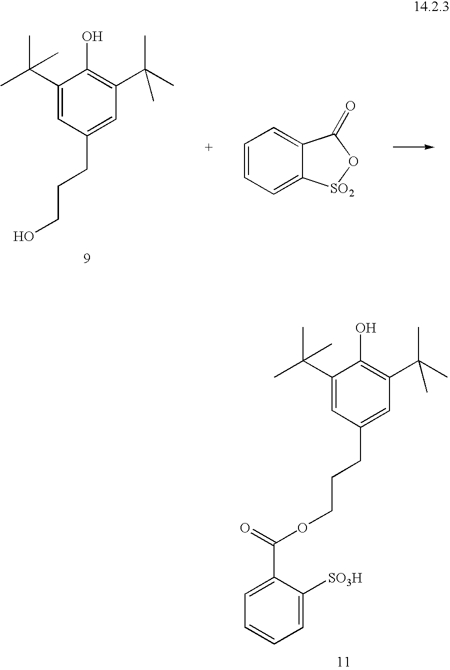

10.57 g (0.04 mol) 3-(3,5-di-tert-butyl-4-hydroxyphenyl)-propanol 2 and 7.07 g (0.04 mol) 2-sulphobenzoic acid anhydride are dissolved in 70 ml dioxane and heated up to reflux temperature. After a total reaction time of 9.5 h the reaction mixture is cooled to RT, and the solvent is stripped off. The brown oil obtained crystallises at RT. The crude brown product is refluxed in 200 ml hexane and the beige coloured solid obtained is filtered off from the mother liquor. Product 11 is obtained, which has a melting point of 90-93° C.

### EXAMPLE 15

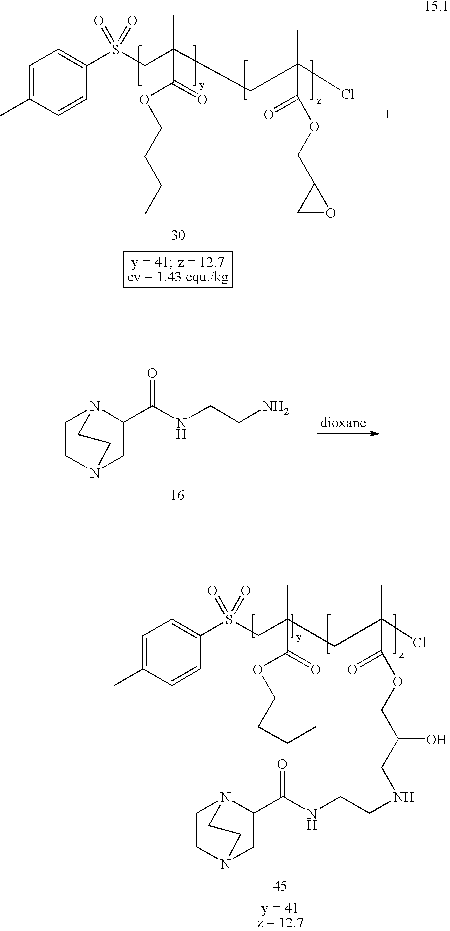

2.825 g (14.3 mmol) 16 is dissolved in 50 ml dioxane and heated up to a reaction temperature of 90° C. 10.08 g (14.3 mmol) 30 dissolved in 10 ml dioxane is added slowly over a time period of 1 h. The epoxy value of the reaction mixture is monitored until it approaches zero. The green coloured solution is diluted with additional 50 ml dioxane. 12.0 g Al₂O₃ is added, and the product mixture is stirred for 1 h at RT. The blue coloured Al₂O₃ is filtered off and the product solution becomes colourless. The procedure is repeated to eliminate all Cu-II-traces left in the reaction mixture. After distilling off the dioxane the functionalised AB-diblock-co-polymer 45 is obtained as a slightly orange coloured solid resin.

GPC: Mn: 5600 g/mol, D: 1.3; ¹H-NMR: Dp(BA): 41, Dp (16): 12.7.
15.2 Preparation of Starting Material

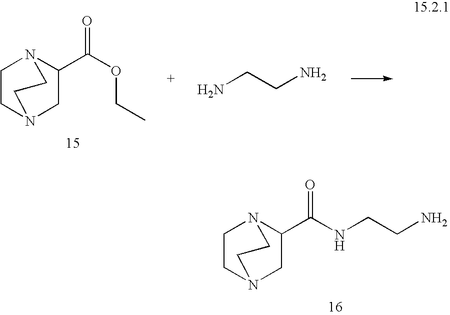

22.0 g (0.12 mol) 15 (dissolved in 5 ml toluene) are slowly added to a solution of 200 ml ethylene diamine at RT over a time period of 2 h. The clear solution obtained is heated up to a reaction temperature of 50° C. and stirred for 24 h. The large excess of ethylene diamine is distilled off at a reaction temperature of 40-50° C. at reduced pressure. The product 16 is obtained as colourless oil.

¹H-NMR (Bruker 400 MHz, CDCl₄, δ (ppm)): 7.38-7.32 (s, broad), 1H (NHCO); 3.35 (t), 1H (CH-DABCO—H); 3.3-3.0 (2m), 3.46-2.63 (2m), 14H (DABCO ring moiety-H (10H)+, α-methylene-H, amidoamine 4H); 1.49 (s, broad), 2H(NH₂); GC-MS: MH+: 199.

15.2.2

The starting material 15 is prepared according to the method as described in U.S. Pat. No. 6,057,321.

### EXAMPLE 16

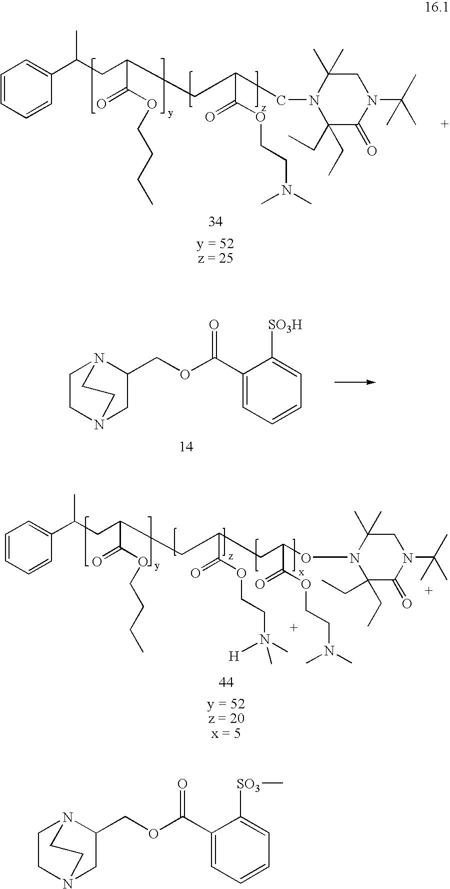

3.02 g (9.26 mmol) 14 is added to a mixture of 15 ml DOWANOL and 15 ml water. The solution is heated to a reaction temperature of 90° C. until 14 is fully dissolved. 5.0 g (0.46 mmol) polymeric dispersant 34 is dissolved in 6.5 ml DOWANOL and added over a time period of 40 min. to the reaction mixture, which is maintained at a reaction temperature of 90° C. until all of 14 have reacted with polymer 34. After 3 h reaction time the functionalised pigment dispersant 44 is obtained as a colourless solution. After distilling off the solvents 44 is obtained as a colourless solid resin.

GPC: Mn: 6600 g/mol, D: 1.44; ¹H-NMR: Dp (BA): 52, Dp (DMAEA-LS): 20.
16.2 Preparation of Starting Material

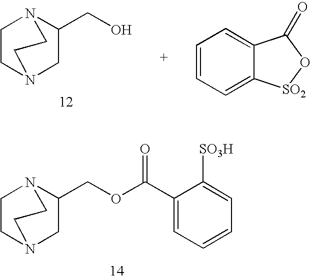

4.6 g (0.032 mol) 12 and 5.41 g (0.03 mol) 2-sulphobenzoic acid anhydride are suspended in 30 ml dioxane and heated up to a reflux temperature of 95° C. After a total reaction time of 2.5 h the reaction mixture is cooled to RT. The product is isolated by filtration, dissolved in H₂O/EtOH and eluted over an ion exchange resin (AMBERLIST 15). The sulphonic acid is washed from the column with a triethylamine/ethanol (1:3) mixture, and the beige coloured solid is recrystallised from H₂O/THF (1:1). Product 14 is isolated as colourless crystals, mp: 310° C. (decomp.).

¹H-NMR (Bruker 400 MHz, DMSO, δ (ppm)): 10.28 (s, broad), 1H(SO₃H); 8.06, 8,04(d), 1H (aromatic-H); 7.8-7.69 (m+d), 4H (aromatic region-H); 4,73, 4.71 (d), 2H (α-methylene-ester-H); 3.99 (m), 1H(CH-DABCO); 3.62-3.14 (m), 10H (DABCO-ring moiety-H). LC-MS (0.17% in H₂O, UV-Detector, 254 nm): t(ret): 4.36 min: M+: 326.

### EXAMPLE 17

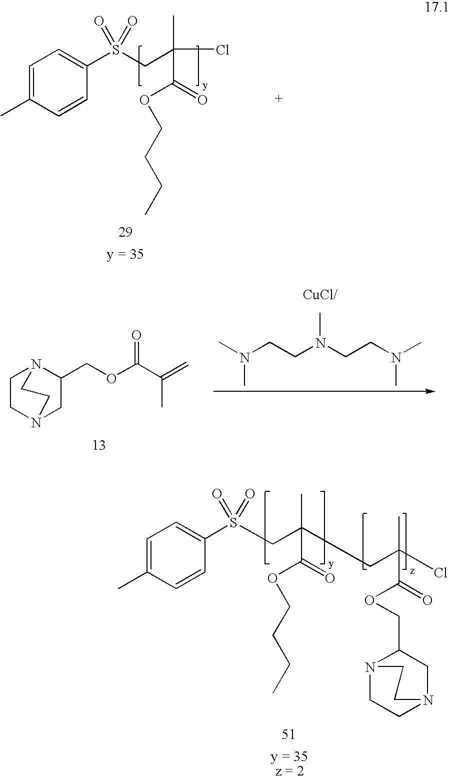

10.0 g (1.95 mmol) 29 and 3.07 g (14.6 mmol) 13 are dissolved in 10 ml DMF. 198.0 mg (2 mmol) CuCl is added to this mixture, and the suspension is stirred at RT. 0.43 g (2.5 mmol) PMDETA is added to the slightly green coloured suspension. The green suspension turns to a dark green solution, which is slowly heated to a reaction temperature of 90° C. and maintained at this temperature over night (15 h). The dark green coloured viscous solution is cooled to RT and diluted with 100 ml dioxane. 10 g Al₂O₃ is added to the green coloured solution, and the product mixture is stirred for 1 h at RT. The blue coloured Al₂O₃ is filtered off, and the product solution becomes slightly yellow coloured. The procedure is repeated to eliminate all Cu-II-traces left in the reaction mixture. After distilling off the excess amount of 13 and DMF, the functionalised AB-diblock-copolymer 51 is obtained as a brown coloured resin.

GPC: Mn: 7000 g/mol, D: 1.35; ¹H-NMR: Dp(BA): 35, Dp (3): 2.

17.2 Preparation of Starting Material

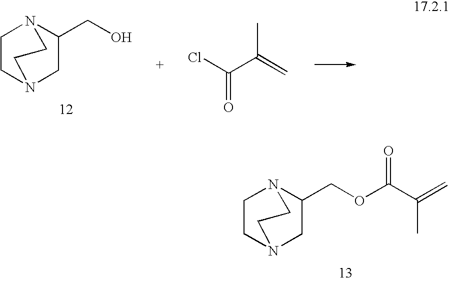

6.9 g (0.048 mol) 12 is dissolved in 50 ml THF and heated to a reaction temperature of 50° C. To the clear solution 24 g triethylamine is added and 6.1 g (0.058 mol) methacrylic acid chloride over a time period of 30 min. The reaction mixture is maintained for 4.5 h at a reaction temperature of 50° C. and then cooled to RT. The reaction mixture is filtered off from the un-dissolved ammonium salt. The solvent is stripped off from the remaining clear solution. The oily residue is distilled over a short Vigreux column at a reduced pressure and a temperature of 120° C. The product 13 is distilled of at the column temperature of 99-100° C. and obtained as colourless oil.

¹H-NMR (Bruker 400 MHz, CDCl₃, δ (ppm)): 6.17 (s), 5.63(s), 2H (olefin-acrylate-H); 4.35 (dd), 4.15 (dd), 2H (α-methylene-acrylate-H); 3.15-2.3 (m): 10H: DABCO-ring moiety-H); 1.95 (s): 3H:CH3-methyl-acrylate-H).

17.2.2

The starting material 12 is prepared according to the method as described in U.S. Pat. No. 6,057,321.

### EXAMPLE 18

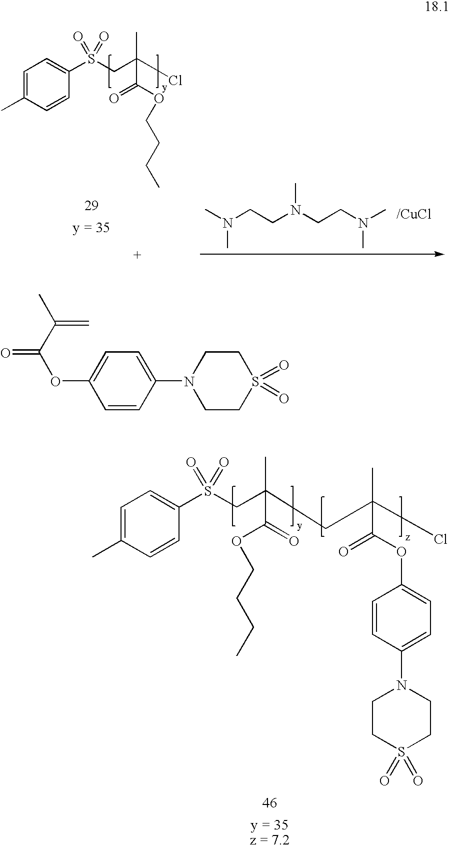 10.0 g (1.95 mmol) 29 is dissolved in 5 ml DMF. 2.88 g (9.75 mmol) 20 dissolved in 8 ml dioxane is added. 198 mg (2 mmol) CuCl is added to the clear and yellow coloured solution, and the reaction mixture is stirred at RT. After adding 0.422 g (2.44 mmol) PMDETA the green suspension turns to a dark green solution, which is slowly heated up to a reaction temperature of 90° C. After 6.5 h reaction time the dark green coloured viscous mixture is cooled to RT and diluted with 100 ml chloroform. To the green coloured solution 10.0 g Al₂O₃ is added, and the product mixture is stirred for 1 h at RT. After filtering off the blue coloured Al₂O₃ the product solution becomes colourless. In order to eliminate all Cu-II-traces the organic phase is washed twice with a solution of EDTA (1% in H₂O). After drying the organic phase over MgSO₄, the solvents are distilled off. The functionalised dispersant 46 is obtained as a slightly yellow coloured resin.

GPC: Mn: 7600 g/mol, D: 1.29; ¹H-NMR: Dp (BA): 35, Dp (20): 7.2.
18.2 Preparation of Starting Material

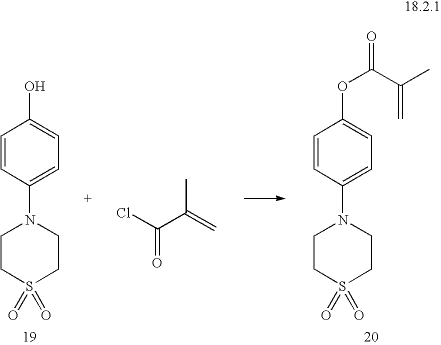

10.0 g (0.044 mol) 19 are dissolved in 70 ml THF at RT and 5.34 g triethyl amine is added. To this brownish coloured clear solution 6.1 g (0.058 mol) methacrylic acid chloride is added over a time period of 30 min. The reaction mixture is maintained at ambient temperature for an additional 6 h, which results in the formation of a beige coloured suspension. The reaction mixture is filtered off from undissolved ammonium salt, and the solvent is stripped from the remaining clear solution. The oily residue is eluted over a silica gel column (eluant:hexane/ethyl acetate 1:1). Product 20 is obtained in form of a beige coloured solid, mp: 102.5-105° C.

18.2.2

The starting material 19 is prepared according to the method as described in U.S. Pat. No. 5,780,625.

### EXAMPLE 19

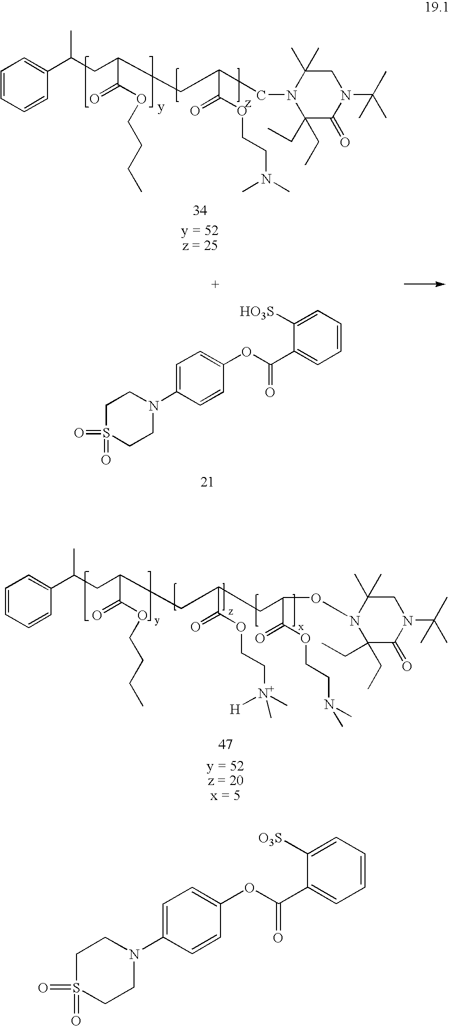

3.81 g (9.26 mmol) 21 and 5.0 g (0.46 mmol) polymeric dispersant 34 are dissolved in 30 ml dimethylacetamide. The reaction mixture is heated to a reaction temperature of 120° C. until 21 is fully dissolved. After 3 h reaction time the functionalised pigment dispersant 47 is obtained as a slightly orange coloured solution. After distilling off the solvent 47 is obtained as an orange coloured solid resin.

GPC: Mn: 8000 g/mol, D: 1.22; ¹H-NMR: Dp (BA): 52, Dp (DMAEA-LS): 20.
19.2 Preparation of Starting Material

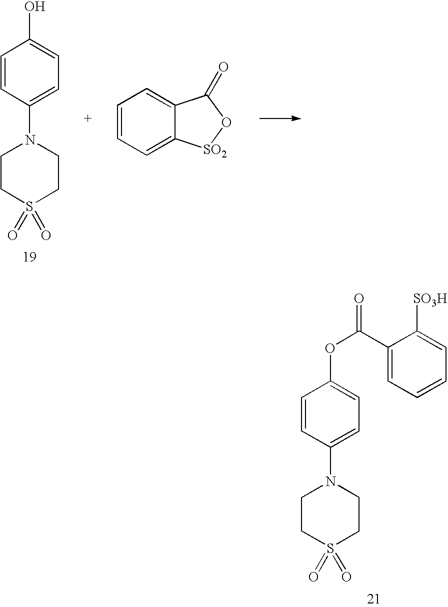

10.0 g (0.044 mol) 19 and 10.4 g (0.056 mol) 2-sulphobenzoic acid anhydride are dissolved in 50 ml dimethylacetamide and heated to a reaction temperature of 100° C. After reacting 15 h at a temperature of 100° C. the suspension obtained is cooled to RT, and the product is filtered off from the brown coloured solution. The solid is dissolved in DMF and eluted over a silica gel column (eluant ethanol/ethyl acetate 1:1). Product 21 is obtained as a beige coloured solid, mp: 275-280° C. (decomposition).

### EXAMPLE 20

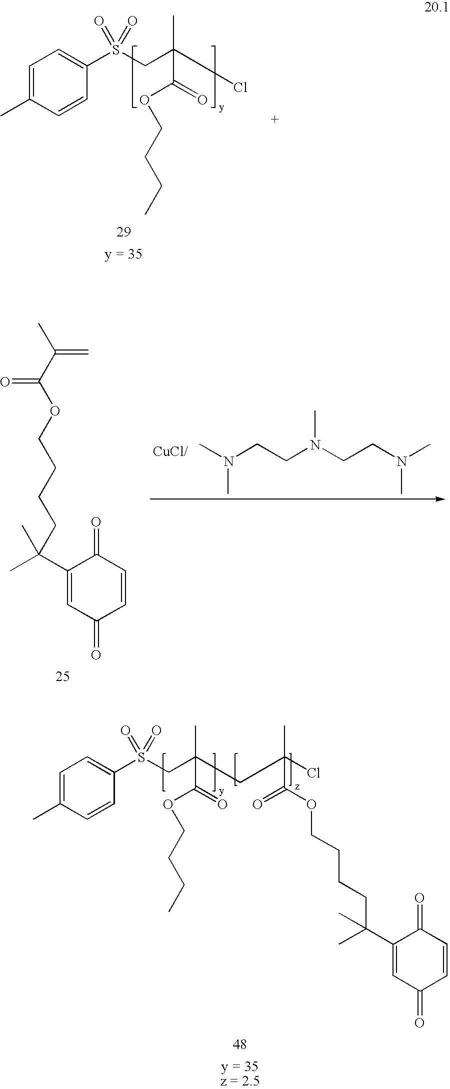

10.0 g (1.95 mmol) 29 is dissolved in 10 ml dioxane. After adding 198.0 mg (2 mmol) CuCl the suspension is stirred at RT. 0.43 g (2.5 mmol) PMDETA is added to the slightly green coloured suspension. The suspension turns to a dark green solution, which is slowly heated to a reaction temperature of 80° C. 4.47 g (14.6 mmol) 25 is added slowly to the reaction mixture over a time period of 4 h. After an additional 15 h reaction time the brownish coloured reaction mixture is cooled to RT and diluted with 100 ml dioxane. 10.0 g Al₂O₃ is added to the green coloured solution, and the product mixture is stirred for 1 h at RT. The blue coloured Al₂O₃ is filtered off, and the product solution becomes dark red coloured. The procedure is repeated to eliminate Cu-II-traces left in the reaction mixture. After distilling off the dioxane the functionalised AB-diblock-copolymer is obtained as a dark red coloured resin an average of 2.5 benzoquinone units per polymer chain, which corresponds to a turnover of 30% of monomer units 25 incorporated.

GPC: Mn: 7300 g/mol, D: 1.35; ¹H-NMR: Dp (BA): 35, Dp (D): 2.5.
20.2 Preparation of Starting Materials

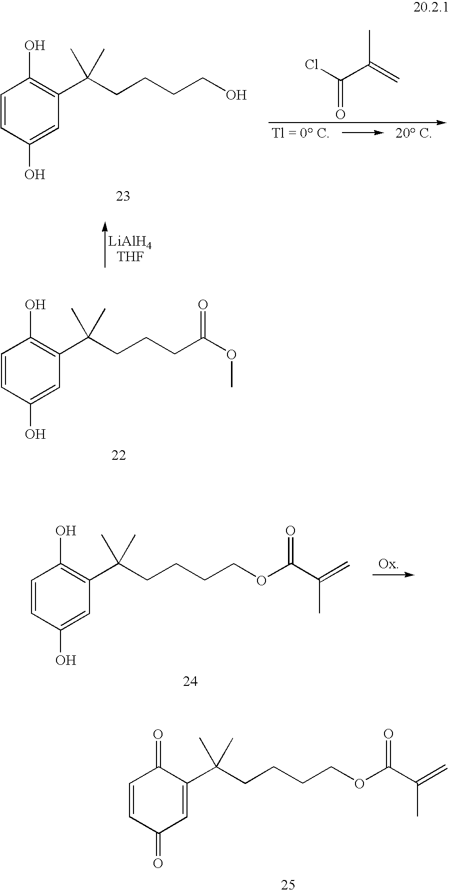

7.55 g LiAlH₄ are suspended in 300 ml THF and cooled to a reaction temperature of 0° C. To this suspension 25.0 g (0.1 mol) 22 dissolved in 150 ml THF are added slowly. After reacting 22 h the reaction mixture is hydrolysed with 10 ml of a 20% aqueous NaOH-solution and subsequently acidified with diluted HCl (15%), until a pH of 1 has been reached. The grey suspension is extracted with CH₂Cl₂, and the intermediate product 23 is obtained in form of a red coloured oil.

20.2.2

15.0 g (0.067 mol) 23 are dissolved in 100 ml anhydrous THF. The reaction mixture is maintained at RT and 8.81 g (0.083 mol) methyl acrylic acid chloride is added drop wise. The reaction mixture is stirred for 24 h and an additional 1.45 g (0.014 mol) methyl acrylic acid chloride is added. The reaction mixture is maintained for an additional 24 h at RT. The solvent is distilled off, and the reaction mixture is added to CH₂Cl₂, washed with 8% aqueous NaHCO₃-solution and water. After drying over MgSO₄ the solvent is distilled off, and the residue is eluted over a silica gel column (Toluene/EtOH 4:1). 24 is obtained as a viscous red oil.

20.2.3

43.0 g (0.13 mol) K₃Fe(CN), is dissolved in 100 ml water and 7.33 g (0.13 mol) KOH is added. To this brown coloured solution 15.28 g (0.052 mol) 24 dissolved in 200 ml CH₂Cl₂ is added. The two-phase system is stirred for 70 min. at RT and then poured into 1 l di-ethyl-ether. The product is isolated in the organic phase. The organic phase is washed twice with 250 ml water, dried over MgSO₄ and after distilling off of the solvent 25 is obtained as a dark red coloured oil.

20.2.4

The starting material 19 is prepared according to the method as described in EP-A-098 241.

### EXAMPLE 21

0.1% Irgalith® Yellow BAW (C.I. Pigment Yellow 13); 0.02% functionalised dispersants (20% on pigment PY 13); on HDPE (mass); 1000 g HDPE (unstabilised); Extrusion in a double screw extruder at 220° C.

| | | Weight Ratio | |
|---|---|---|---|
| UVA/HALS (1:2 mol) | Solid Content | (UVA/HALS) | Aspect |
| Dispersants: 37/40 | 100% | 0.271:0.729 | Solid Resins |
| Dispersants: 36/39 | 30% | 0.316:0.684 | Waxes |
| | in DOWANOL | | |

Results (HDPE, 0.1% Pi (full colour shade PY 13)

| Full | | | | | | | |
|---|---|---|---|---|---|---|---|
| Colour Shade 220° C.) | L* | C* | H | DL* | DC* | DH* | DE* |
| No Additive | 79.1 | 82.3 | 87.3 | Standard | | | |
| Physical Mixture | 79.1 | 83.5 | 87.8 | 0.0 | 1.2 | 0.7 G | 1.4 |
| 37/40 | | | | | | | |
| 60 min. Scandex | 78.9 | 83.1 | 88.0 | −0.2 | 0.9 | 0.9 G | 1.3 |
| 37/40 | | | | | | | |
| Physical mixture | 78.9 | 83.6 | 89.2 | −0.2 | 1.3 | 2.7 G | 3.1 |
| 36/39 | | | | | | | |
| 60 min. Scandex | 77.9 | 82.3 | 88.3 | −1.2 | 0.0 | 1.4 G | 1.8 |
| 36/39 | | | | | | | |

Physical mixture: Physical blend of the pigment dispersant and pigment (PY 13) which is extruded into HDPE at a temperature of 220° C.

Scandex: DIN 532 38-13: (Dispergation step: Pigment PY 13 is dispersed by means of the pigments dispersants 36/39 and 37/40 in MEK; the solvents are stripped off afterwards in high vacuum conditions (p=0.1 mbar at room temperature).

Light stability determined by UVCON—Gray Scale

| 0.1% BP | 100 h | 500 h | 1000 h |
|---|---|---|---|
| No Additive | 5 | 5 | 3-4 |
| Physical mixture 37/40 | 5 | 5 | 4 |
| 60 min. Scandex 37/40 | 5 | 5 | 4 |
| Physical Mixture 36/39 | 5 | 5 | 4-5 |
| 60 min. Scandex 36/39 | 5 | 5 | 4-5 |

UVCON-Gray Scale: DIN EN 20105-A02

### EXAMPLE 22

0.1% CIBA IRGALITH® YELLOW BAW (C.I. Pigment Yellow 13);

0.1% CIBA PIGMENT ORANGE® 16A (C.I. Pigment Orange 73);

0.1% CIBA CROMOPHTAL® RED BRN (C.I. Pigment Red 144);

0.1% CIBA CROMOPHTAL® DPP RED BP (C.I. Pigment Red 254);

0.1% CIBA CROMOPHTAL® DPP FIAME RED FP (C.I. Pigment Red 272);

are each dispersed with 0.02% functionalised dispersant (20% on pigment); on HDPE (mass); 1000 g HDPE (unstabilised); Extrusion in a double screw extruder at 220° C.

Results (HDPE, 0.1% Pi (full colour shade))

| Full Colour | | | | | | | |
|---|---|---|---|---|---|---|---|
| Shade (220° C.) | L* | C* | H | DL* | DC* | DH* | DE* |
| No Additive | 83.2 | 89.5 | 87.3 | Standard C.I. PY 13 | | | |
| 39 | 83.4 | 88.0 | 90.2 | 0.2 | −1.5 | 4.6 G | 4.8 |
| 55 | 83.7 | 88.3 | 90.0 | 0.5 | −1.2 | 4.1 G | 4.4 |
| 59 | 83.5 | 88.8 | 89.9 | 0.3 | −0.7 | 4.1 G | 4.1 |
| No Additive | 65.5 | 69.0 | 44.6 | Standard C.I. PO 73 | | | |
| 52 | 64.0 | 73.6 | 45.9 | −1.4 | 4.6 | 1.7 Y | 5.1 |
| 55 | 63.9 | 73.6 | 45.8 | −1.6 | 4.6 | 1.5 Y | 5.1 |
| 59 | 64.0 | 73.8 | 45.8 | −1.5 | 4.8 | 1.5 Y | 5.3 |
| No Additive | 49.5 | 59.6 | 29.0 | Standard C.I. PR 144 | | | |
| 52 | 48.8 | 59.2 | 29.3 | −0.7 | −0.4 | 0.3 Y | 0.8 |
| No Additive | 50.3 | 68.3 | 31.5 | Standard C.I. PR 254 | | | |
| 50 | 50.3 | 68.2 | 31.2 | 0.0 | −0.1 | 0.4 B | 0.4 |
| 40 | 50.3 | 68.0 | 31.2 | 0.1 | −0.3 | 0.4 B | 0.5 |
| 45 | 50.3 | 68.2 | 31.4 | 0.0 | −0.1 | 0.2 B | 0.3 |
| No Additive | 51.8 | 70.2 | 33.7 | Standard C.I. PR 272 | | | |
| 40 | 51.8 | 69.4 | 33.5 | 0.1 | −0.8 | 0.3 B | 0.8 |
| 38 | 51.9 | 69.5 | 33.7 | 0.2 | −0.7 | 0.0 | 0.7 |

Physical mixture: Physical blend of the pigment dispersant and pigment which is extruded into HDPE at a temperature of 220° C.

Light Stability Determined by CAM 119-1000 Hours WOM. Gray Scale:

| | No Additive | 38 | 39 | 40 | 45 | 50 | 52 | 55 | 59 |
|---|---|---|---|---|---|---|---|---|---|
| 0.1% PY 13 | 1 | — | 2 | — | — | — | — | 2.5 | 3 |
| 0.1% PO 73 | 1.5 | — | — | — | — | — | 3.5 | 3 | 3 |
| 0.1% PR 144 | 2 | — | — | 2.5 | — | — | — | — | — |
| 0.1% PR 254 | 3 | — | — | 3.5 | 3.5 | 4 | — | — | — |
| 0.1% PR 272 | 2 | 2.5 | — | 2.5 | — | — | — | — | — |

CAM-119-Cycle: “CIBA internal WOM-Norm”: Xe 6500W, Boro-S-/Boro-5-filter combination, irradiance: 0.35 W/m²/340 nm, Cycle is 40 min dark, 20 min light and rain, 160 min light, 20 min light and rain;

Gray Scale: DIN EN 20105-A02

### EXAMPLE 23

| | |
|---|---|
| Pigment | IRGALITH Yellow BAW (C.I. Pigment Yellow 13) |
| Binder | 2 pack polyurethane: Macrynal ® SM 510 N/ |
| | Desmodu ® N 75 |
| Dispergation | 60 min. Scandex (DIN 53238-18) with glass beads (100 g) |
| Application | 100 mm wet film drawer onto coil-coating-panel |
| Dry times | 5 min/RT, force drying 30 min/80° C. |
| WOM | CAM-Cycle 7: DIN EN ISO 1134/A |

Full Shade 1% Pigment Coloured

| | 1.4 | 1.5 | 1.7 |
|---|---|---|---|
| Butylglycol acetate | 11.50 | 11.50 | 11.50 |
| Solvesso 100 | 4.70 | 4.70 | 4.70 |
| MIBK*⁾ | 5.68 | 5.68 | 5.68 |
| Dispersant 36 | 0.2 | — | — |
| Dispersant 37 (30% solids) | — | 0.67 | — |
| No dispersant | — | — | — |
| Total | 22.08 | 22.55 | 21.88 |
| IRGALITH Yellow BAW | 1 | 1 | 1 |
| Total | 23.08 | 23.55 | 22.88 |
| Macrynal ® SM 510 N | 54.80 | 54.80 | 54.80 |
| (60%) | | | |
| Byk 300 | 0.15 | 0.15 | 0.15 |
| Total | 78.03 | 78.05 | 77.83 |
| Desmodur N 75 | 21.92 | 21.92 | 21.92 |
| Total | 99.95 | 99.97 | 99.75 |

*⁾Methylisobutylketone

WOM—Series 1758

| | 100 h | | 500 h | | 750 h | | 1000 h | |
|---|---|---|---|---|---|---|---|---|
| CAM 7-WOM | DE* | GM | DE* | GM | DE* | GM | DE* | GM |
| Dispersant 36 | 0.8 | 5 | 3.6 | 4-5 | 5.4 | 4 | 8.7 | 4 |
| Dispersant 37 | 1.5 | 5 | 4.6 | 4 | 7.0 | 3-4 | 13.6 | 3-4 |
| No additive | 1.1 | 5 | 3.9 | 4-5 | 6.4 | 4-5 | 14.4 | 3-4 |

CAM-Cycle 7/WOM): DIN EN ISO 11341A

1. A polymerisate of formula (I): 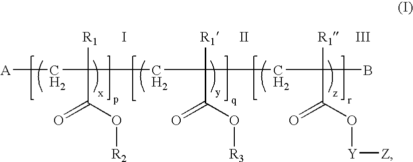
Wherein
A and B represent polymer chain terminal groups;
R₁, R₁′ and R₁″ independently of one another represent hydrogen or C₁-C₄alkyl;
R₂ represents hydrogen or an ester group of higher polarity;
R₃ represents an ester group of lower polarity;
Y represents a direct bond or a bivalent group;
Z represents a functionally effective group of an agent having light protecting properties;
The numerals I, II, III represent individual polymer blocks in any sequential order;
The indices p, q and r represent the number of polymer blocks I, II and III in the polymerisate, wherein one of the indices p and q independently of one another represents zero, one or a numeral greater than one and the other one represents one or a numeral greater than one; and r represents one or a numeral greater than one; and wherein
The indices x, y and z define the number of monomer units present in the individual polymer blocks I, II and III.

2. A polymerisate according to claim 1 of formula (I′): 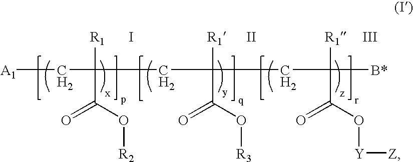
Wherein
A₁ represents the fragment of a polymerisation initiator;
B* represents a polymerisable, ethylenically unsaturated terminal group; and
R₁, R₁′, R₁″, R₂, R₃ Y, Z, the numerals I, II and III and the indices p, q, r, x, y and z are as defined in claim 1.

3. A comb polymer according to claim 1 of formula (I″): 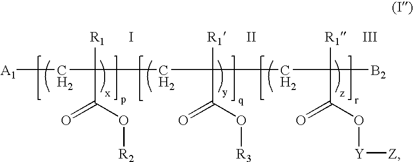
Wherein
A₁ represents the fragment of a polymerisation initiator;
R₁, R₁′, R₁″, R₂, R₃ Y, Z, the numerals I, II and III and the indices p, q, r, x, y and z are as defined in claim 1; and
B₂ represents a polymer group of partial formula (IA): 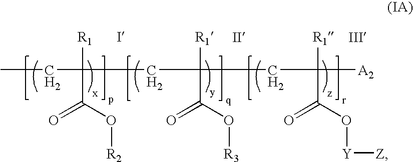
Wherein
A₂ represents a polymer chain terminal group;
R₁, R₁′, R₁″, R₂, R₃ Y and Z are as defined in claim 1;
The numerals I, II and III represent individual polymer blocks in any sequential order;
The indices p, q and r represent the number of polymer blocks I, II and III in the polymerisate, wherein
One of the indices p, q and r independently of one another represents one or a numeral greater than one;
And the other ones represent zero, one or a numeral greater than one; and
The indices x, y and z define the number of monomer units present in the individual polymer blocks I, II and III.

4. A polymerisate (I) according to claim 1, wherein
A and B represent polymer chain terminal groups;
R₁, R₁′ and R₁″ independently of one another represent hydrogen or methyl;
R₂ represents an ester group selected from the group consisting of mono- or dihydroxy-C₂-C₄-alkyl, amino-C₂-C₁₈alkyl, ammonio-C₂-C₁₈alkyl, C₁-C₄alkylamino-C₂-C₁₈alkyl, di-C₁-C₄alkylamino-C₂-C₁₈alkyl, tri-C₁-C₄alkylammonio-C₂-C₁₈alkyl, hydroxy-C₂-C₄alkylamino-C₂-C₁₈alkyl, C₁-C₄alkyl-(hydroxy-C₂-C₄alkyl)amino-C₂-C₁₈alkyl, di-C₁-C₄alkyl-(hydroxy-C₂-C₄alkyl)ammonio-C₂-C₁₈alkyl, and C₁-C₄alkyl substituted by carboxy, sulpho or phosphono.
R₃ represents C₁-C₈alkyl, e.g. methyl, ethyl, isopropyl, n-butyl or 2-ethylhexyl;
Y represents a direct bond or a bivalent group;
Z represents a functionally effective group of an agent having light protecting properties;
The indices p and x represent zero;
And the numerals II and III and the indices q, r, y and z are as defined in claim 1.

5. A polymerisate (I) according to claim 1, wherein
A and B represent polymer chain terminal groups;
R₁, R₁′ and R₁″ independently of one another represent hydrogen or methyl;
R₂ represents C₂-C₄alkyl substituted by amino, ammonio, C₁-C₄alkylamino, di-C₁-C₄alkylamino, tri-C₁-C₄alkylammonio, or di-C₁-C₄alkyl-2-hydroxyethylammonio;
R₃ represents C₁-C₈alkyl;
Y represents a direct bond or a bivalent group;
Z represents a functionally effective group of an agent having light protecting properties;
The indices p and x represent zero;
The indices q and r represent one;
The indices y and z represent numerals greater than one;
And the numerals II and III are as defined in claim 1.

6. A polymerisate (I) according to claim 1, wherein the functionally effective group Z of an agent having light protecting properties is a structural moiety derived from light protecting agents selected from the group consisting of UV-light absorbers, radical scavengers, singlet oxygen quenchers, triplett quenchers, photo-stabilisers and superoxide-anion-quenchers.

7. A polymerisate (I) according to claim 6, wherein the UV-light absorber moiety Z is a substituent derived from UV-absorbers selected from the group consisting of 2-(2-hydroxyphenyl)-1,3,5-triazines (HPT), 2-(2′-hydroxyphenyl)benzotriazoles (HBZ), 2-hydroxybenzophenones (HBP) and oxanilides (OA).

8. A compound of formula (III): 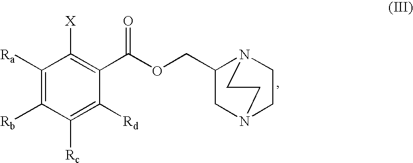
Wherein
X represents carboxy, sulpho or phosphono; and
Rₐ, R_{b}, R_{c} and R_{d} independently of one another represent hydrogen, halogen, C₁-C₄alkyl or C₁-C₄alkoxy.

9. A compound of formula (IV): 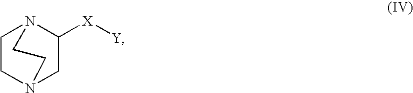
Wherein
X represents a bivalent functional group selected from the group consisting of —C(═O)—NH—, —CH₂—O—, —O—, —NH— and —N(C₁-C₄alkyl)-; and
Y represents C₁-C₄alkyl, hydroxy-C₂-C₄alkyl, amino-C₂-C₄alkyl, acryloyl or methacryloyl.

10. A composition comprising
a) A composition of matter susceptible to degradation induced by light, heat or oxidation; and
b) The polymerisate (I), wherein A, B, R₁, R₁′, R₁″, R₂, R₃, Y, Z, the numerals I, II and III and the indices p, q, r, x, y and z are as defined in claim 1.

11. A pigment composition comprising
a′) 0.1-99.9% by weight dispersible organic or inorganic pigment particles; and
b′) 0.1-99.9% by weight of a polymerisate (I), wherein A, B, R₁, R₁′, R₂″, R₂″, R₃, Y, Z, the numerals I, II and III and the indices p, q, r, x, y and z are as defined in claim 1.

12. A composition according to claim 11, which additionally contains additives selected from the group consisting of surfactants, light stabilisers, UV-absorbers, anti-foaming agents, dispersion stabilisers, dyes, plasticisers, thixotropic agents, drying catalysts, anti-skinning agents and levelling agents.

13. A pigment dispersion comprising
a”) Dispersed organic or inorganic pigment particles; and
b”) A dispersing agent consisting of at least one polymerisate (I), wherein A, B, R₁, R₁′, R₁″, R₂, R₃, Y, Z, the numerals I, II and III and the indices p, q, r, x, y and z are as defined in claim 1;
And a carrier liquid comprising water, organic solvents and mixtures thereof.

14. Ink compositions or colour filters comprising a pigment dispersion according to claim 13.

15. Coating compositions, prints, images, inks, lacquers, pigmented plastics, adhesives, casting resins, filled composites, glass fibre reinforced composites, laminates or cement based construction materials comprising a pigment dispersion according to claim 13.
